(19) United States
(12) Patent Application Publication
(10) Pub. No.: US 2015/0370320 A1
(43) Pub. Date: Dec. 24, 2015

(54) Smart Clothing with Human-to-Computer Textile Interface

(71) Applicant: Robert A. Connor, Forest Lake, MN (US)

(72) Inventor: Robert A. Connor, Forest Lake, MN (US)

(73) Assignee: MEDIBOTICS LLC, Forest Lake, MN (US)

(21) Appl. No.: 14/736,652

(22) Filed: Jun. 11, 2015

Related U.S. Application Data
(63) Continuation-in-part of application No. 14/664,832, filed on Mar. 21, 2015.
(60) Provisional application No. 62/014,747, filed on Jun. 20, 2014.
(60) Provisional application No. 62/100,217, filed on Jan. 6, 2015.

(51) Int. Cl. G06F 3/01

(52) U.S. Cl. CPC G06F 3/011; G06F 3/017

(57) ABSTRACT

This invention is smart clothing with a touch-based and/or gesture-based human-to-computer textile interface which transduces human touch and/or gestures into computer inputs. In an example, this interface can comprise an array or mesh of electroconductive fibers, threads, or yarns which are woven together using a plain weave, a rib weave, a basket weave, a twill weave, a satin weave, a leno weave, or a mock leno weave.

### CROSS-REFERENCE TO RELATED APPLICATIONS

This patent application: (1) is a continuation-in-part of U.S. patent application Ser. No. 14/664,832 entitled “Motion Recognition Clothing™ with Flexible Electromagnetic, Light, or Sonic Energy Pathways” by Robert A. Connor filed on Mar. 21, 2015; (2) also claims the priority benefit of U.S. Provisional Patent Application No. 62/014,747 entitled “Modular Smart Clothing” by Robert A. Connor filed on Jun. 20, 2014; and (3) also claims the priority benefit of U.S. Provisional Patent Application No. 62/100,217 entitled “Forearm Wearable Device with Distal-to-Proximal Flexibly-Connected Display Modules” filed by Robert A. Connor on Jan. 6, 2015. The entire contents of these three related applications are incorporated herein by reference.

### FEDERALLY SPONSORED RESEARCH

Not Applicable

### SEQUENCE LISTING OR PROGRAM

Not Applicable

### BACKGROUND

1. Field of Invention

This invention relates to smart clothing with a human-to-computer textile interface.

2. Introduction

There are advantages to wearing a mobile electronic device (a “wearable” device) rather than carrying one by hand (a “hand-held” device). However, there are also challenges for wearable devices. One challenge for wearables is the size and flexibility of a human-to-computer interface based on touch or gestures. Most hand-held electronic devices currently have touch screens that are too inflexible and large to be worn unobtrusively on a person's body. One solution to this challenge is to create a wearable device with a flexible touch-based and/or gesture-based human-to-computer interface. A touch-based and/or gesture-based human-to-computer textile interface is particularly promising because it can be unobtrusively integrated into smart clothing. This specification provides several examples of smart clothing—including smart clothing with a touch-based and/or gesture-based human-to-computer textile interface. Others have disclosed touch-based and/or gesture-based human-to-computer textile interfaces before, but this specification discloses some novel and advantageous configurations for such interfaces.

1. Review of the Relevant Art

U.S. Pat. No. 8,905,772 (Rogers et al., Dec. 9, 2014, “Stretchable and Foldable Electronic Devices”) discloses a relevant flexible electromagnetic device. The following art appears to disclose electromagnetic textiles and/or fabrics: U.S. Pat. No. 7,781,051 (Burr et al., Aug. 24, 2010, “Perforated Functional Textile Structures”); U.S. Pat. No. 8,263,215 (Burr et al., Sep. 11, 2012, “Perforated Functional Textile Structures”); U.S. Pat. No. 8,308,489 (Lee et al., Nov. 13, 2012, “Electrical Garment and Electrical Garment and Article Assemblies”); and U.S. Pat. No. 9,009,955 (Slade et al., Apr. 21, 2015, “Method of Making an Electronically Active Textile Article”); and U.S. patent application 20120030935 (Slade et al., Feb. 9, 2012, “Electrically Active Textiles, Articles Made Therefrom, and Associated Methods”).

The following art appears to disclose woven electromagnetic textiles and/or fabrics: U.S. Pat. No. 6,381,482 (Jayaraman et al., Apr. 30, 2002, “Fabric or Garment with Integrated Flexible Information Infrastructure”); U.S. Pat. No. 6,687,523 (Jayaramen et al., Feb. 3, 2004, “Fabric or Garment with Integrated Flexible Information Infrastructure for Monitoring Vital Signs of Infants”); U.S. Pat. No. 6,942,496 (Sweetland et al., Sep. 13, 2005, “Woven Multiple-Contact Connector”); U.S. Pat. No. 7,559,768 (Marmaropoulos et al., Jul. 14, 2009, “Modular Wearable Circuit”); and U.S. Pat. No. 8,146,171 (Chung et al., Apr. 3, 2012, “Digital Garment using Digital Band and Fabricating Method Thereof”); and U.S. patent application 20070178716 (Glaser et al., Aug. 2, 2007, “Modular Microelectronic-System for Use in Wearable Electronics”).

The following art appears to disclose woven electromagnetic textiles and/or fabrics with grid arrays of electromagnetic members: U.S. Pat. No. 6,856,715 (Ebbesen et al., Feb. 15, 2005, “Apparatus Comprising Electronic and/or Optoelectronic Circuitry and Method for Realizing Said Circuitry”); U.S. Pat. No. 7,144,830 (Hill et al., Dec. 5, 2006, “Plural Layer Woven Electronic Textile, Article and Method”); U.S. Pat. No. 7,413,802 (Karayianni et al., Aug. 19, 2008, “Energy Active Composite Yarn, Methods for Making the Same, and Articles Incorporating the Same”); U.S. Pat. No. 7,592,276 (Hill et al., Sep. 22, 2009, “Woven Electronic Textile, Yarn and Article”); U.S. Pat. No. 7,665,288 (Karayianni et al., Feb. 23, 2010, “Energy Active Composite Yarn, Methods for Making the Same and Articles Incorporating the Same”); U.S. Pat. No. 7,849,888 (Karayianni et al., Dec. 14, 2010, “Surface Functional Electro-Textile with Functionality Modulation Capability, Methods for Making the Same, and Applications Incorporating the Same”); U.S. Pat. No. 8,393,282 (Fujita et al., Mar. 12, 2013, “Sewn Product and Clothes”); and U.S. Pat. No. 8,536,075 (Leonard, Sep. 17, 2013, “Electronic Systems Incorporated into Textile Threads or Fibres”); and U.S. patent applications 20030211797 (Hill et al., Nov. 13, 2003, “Plural Layer Woven Electronic Textile, Article and Method”); 20040009729 (Hill et al., Jan. 15, 2004, “Woven Electronic Textile, Yarn and Article”); 20060281382 (Karayianni et al., Dec. 14, 2006, “Surface Functional Electro-Textile with Functionality Modulation Capability, Methods for Making the Same, and Applications Incorporating the Same”); 20070049147 (Hill et al., Mar. 1, 2007, “Plural Layer Woven Electronic Textile, Article and Method”); 20090025819 (Douglas, Jan. 29, 2009, “Structure of Fabric and Electronic Components”); 20090159149 (Karayianni et al., Jun. 25, 2009, “Surface Functional Electro-Textile with Functionality Modulation Capability, Methods for Making the Same, and Applications Incorporating the Same”); 20090253325 (Brookstein et al., Oct. 8, 2009, “Plural Layer Woven Electronic Textile, Article and Method”); 20120118427 (Brookstein et al., May 17, 2012, “Electronic Textile, Article and Method”); and 20130176737 (Zhou et al., Jul. 11, 2013, “Electronic Textile and Method of Manufacturing an Electronic Textile”).

U.S. patent application 20060238490 (Stanley et al., Oct. 26, 2006, “Non Contact Human-Computer Interface”) appears to disclose a relevant electromagnetic device comprising a human-to-computer interface which transduces human touch, pressure, and/or motion. The following art appears to disclose flexible electromagnetic devices comprising human-to-computer interfaces which transduce human touch, pressure, and/or motion: U.S. Pat. No. 8,730,177 (Westerman et al., May 20, 2014, “Contact Tracking and Identification Module for Touch Sensing”); U.S. Pat. No. 8,730,192 (Westerman et al., May 20, 2014, “Contact Tracking and Identification Module for Touch Sensing”); and U.S. Pat. No. 8,904,876 (Taylor et al., Dec. 9, 2014, “Flexible Piezocapacitive and Piezoresistive Force and Pressure Sensor”); and U.S. patent application 20110018556 (Le et al., Jan. 27, 2011, “Pressure and Touch Sensors on Flexible Substrates for Toys”).

The following art appears to disclose electromagnetic textiles and/or fabrics comprising human-to-computer interfaces which transduce human touch, pressure, and/or motion: U.S. Pat. No. 6,640,202 (Dietz et al., Oct. 28, 2003, “Elastic Sensor Mesh System for 3-Dimensional Measurement, Mapping and Kinematics Applications”); U.S. Pat. No. 6,957,164 (Dietz et al., Oct. 18, 2005, “Elastic Sensor Mesh System for 3-Dimensional Measurement, Mapping and Kinematics Applications”); U.S. Pat. No. 8,162,857 (Lanfermann et al., Apr. 24, 2012, “Limb Movement Monitoring System”); U.S. Pat. No. 8,334,226 (Nhan et al., Dec. 18, 2012, “Conductive Webs Containing Electrical Pathways and Method for Making Same”); U.S. Pat. No. 8,393,229 (Tao et al., Mar. 12, 2013, “Soft Pressure Sensing Device”); and U.S. Pat. No. 8,704,758 (Figley et al., Apr. 22, 2014, “Resistive Loop Excitation and Readout for Touch Point Detection and Generation of Corresponding Control Signals”); and U.S. patent applications 20090321238 (Nhan et al., Dec. 31, 2009, “Conductive Webs Containing Electrical Pathways and Method for Making Same”); 20130229338 (Sohn et al., Sep. 5, 2013, “Textile Interface Device and Method for Use with Human Body-Worn Band”); and 20130328783 (Martin et al., Dec. 12, 2013, “Transmission of Information to Smart Fabric Output Device”).

The following art appears to disclose woven electromagnetic textiles and/or fabrics comprising human-to-computer interfaces which transduce human touch, pressure, and/or motion: U.S. Pat. No. 6,341,504 (Istook, Jan. 29, 2002, “Composite Elastic and Wire Fabric for Physiological Monitoring Apparel”); U.S. Pat. No. 6,360,615 (Smela, Mar. 26, 2002, “Wearable Effect-Emitting Strain Gauge Device”); U.S. Pat. No. 7,191,803 (Orr et al., Mar. 20, 2007, “Elastic Fabric with Sinusoidally Disposed Wires”); U.S. Pat. No. 8,331,097 (Yang et al., Dec. 11, 2012, “Cloth Comprising Separable Sensitive Areas”); U.S. Pat. No. 8,348,865 (Jeong et al., Jan. 8, 2013, “Non-Intrusive Movement Measuring Apparatus and Method Using Wearable Electro-Conductive Fiber”); U.S. Pat. No. 8,373,079 (Walkington, Feb. 12, 2013, “Woven Manually Operable Input Device”); and U.S. Pat. No. 9,043,004 (Casillas et al., May 26, 2015, “Apparel Having Sensor System”); and U.S. patent applications 20060147678 (Marmaropoulos et al., Jul. 6, 2006, “Touch Sensitive Interface”); 20080050550 (Orth, Feb. 28, 2008, “Contact and Capacitive Touch Sensing Controllers with Electronic Textiles and Kits Therefor”); 20080105527 (Leftly, May 8, 2008, “Switches and Devices for Integrated Soft Component Systems”); and 20100219943 (Ilmari et al., Sep. 2, 2010, “Touch Sensitive Wearable Band Apparatus and Method”); and also WO2005001678 (Marmaropoulos, Jan. 6, 2005, “A Touch Sensitive Interface”).

The following art appears to disclose electromagnetic textiles and/or fabrics with grid arrays of electromagnetic members which comprise human-to-computer interfaces which transduce human touch, pressure, and/or motion: U.S. Pat. No. 8,823,639 (Jackson et al., Sep. 2, 2014, “Elastomeric Input Device”); U.S. Pat. No. 8,929,085 (Franklin et al., Jan. 6, 2015, “Flexible Electronic Devices”); and U.S. Pat. No. 9,001,082 (Rosenberg et al., Apr. 7, 2015, “Touch Sensor Detector System and Method”); U.S. patent applications 20150091820 (Rosenberg et al., Apr. 2, 2015, “Touch Sensor Detector System and Method”); 20150091857 (Rosenberg et al., Apr. 2, 2015, “Touch Sensor Detector System and Method”); 20150091859 (Rosenberg et al., Apr. 2, 2015, “Capacitive Touch Sensor System and Method”); and 20150116920 (Franklin et al., Apr. 30, 2015, “Flexible Electronic Devices”); and also WO2014001843 (Maggiali et al., Jan. 3, 2014, “Tactile Control Arrangement for Electrical or Electronic Devices Integrated in a Textile Support”).

The following art appears to disclose woven electromagnetic textiles and/or fabrics with grid arrays of electromagnetic members which comprise human-to-computer interfaces which transduce human touch, pressure, and/or motion: U.S. Pat. No. 6,210,771 (Post et al., Apr. 3, 2001, “Electrically Active Textiles and Articles Made Therefrom”); U.S. Pat. No. 6,543,299 (Taylor, Apr. 8, 2003, “Pressure Measurement Sensor With Piezoresistive Thread Lattice”); U.S. Pat. No. 6,809,462 (Pelrine et al., Oct. 26, 2004, “Electroactive Polymer Sensors”); U.S. Pat. No. 6,826,968 (Manaresi et al., Dec. 7, 2004, “Textile-Like Capacitive Pressure Sensor and Method of Mapping the Pressure Exerted at Points of a Surface of a Flexible and Pliable Object, Particularly of a Sail”); U.S. Pat. No. 7,230,610 (Jung et al., Jun. 12, 2007, “Keypad in Textiles with Capacitive Read-Out Circuit”); U.S. Pat. No. 7,365,031 (Swallow et al., Apr. 29, 2008, “Conductive Pressure Sensitive Textile”); U.S. Pat. No. 7,468,332 (Avloni, Dec. 23, 2008, “Electroconductive Woven and Non-Woven Fabric”); U.S. Pat. No. 7,770,473 (Von Lilienfeld-Toal et al., Aug. 10, 2010, “Pressure Sensor”); U.S. Pat. No. 8,161,826 (Taylor, Apr. 24, 2012, “Elastically Stretchable Fabric Force Sensor Arrays and Methods of Making”); U.S. Pat. No. 8,298,968 (Swallow et al., Oct. 30, 2012, “Electrical Components and Circuits Constructed as Textiles”); U.S. Pat. No. 8,362,882 (Heubel et al., Jan. 29, 2013, “Method and Apparatus for Providing Haptic Feedback from Haptic Textile”); U.S. Pat. No. 8,661,915 (Taylor, Mar. 4, 2014, “Elastically Stretchable Fabric Force Sensor Arrays and Methods of Making”); U.S. Pat. No. 8,669,195 (Swallow et al., Mar. 11, 2014, “Electrical Components and Circuits Constructed as Textiles”); U.S. Pat. No. 8,784,342 (Hyde et al., Jul. 22, 2014, “Shape Sensing Clothes to Inform the Wearer of a Condition”); U.S. Pat. No. 8,800,386 (Taylor, Aug. 12, 2014, “Force Sensing Sheet”); U.S. Pat. No. 8,945,328 (Longinotti-Buitoni et al., Feb. 3, 2015, “Methods of Making Garments Having Stretchable and Conductive Ink”); and U.S. Pat. No. 8,948,839 (Longinotti-Buitoni et al., Feb. 3, 2015, “Compression Garments Having Stretchable and Conductive Ink”); and also U.S. patent applications 20050069695 (Jung et al., Mar. 31, 2005, “Keypad in Textiles with Capacitive Read-Out Circuit”); 20060157334 (Marmaropoulos et al., Jul. 20, 2006, “Pressure Activated Interface”); 20070202765 (Krans et al., Aug. 30, 2007, “Textile Form Touch Sensor”); 20070248799 (DeAngelis et al., Oct. 25, 2007, “Flexible Capacitive Sensor”); 20120234105 (Taylor, Sep. 20, 2012, “Elastically Stretchable Fabric Force Sensor Arrays and Methods of Making”); 20120313854 (Senanayake et al., Dec. 13, 2012, “Adaptable Input/Output Device”); 20120323501 (Sarrafzadeh et al., Dec. 20, 2012, “Fabric-Based Pressure Sensor Arrays and Methods for Data Analysis”); 20140070957 (Longinotti-Buitoni et al., Mar. 13, 2014, “Wearable Communication Platform”); 20140088764 (Naidu et al., Mar. 27, 2014, “Tactile Array Sensor”); 20140170919 (Manipatruni et al., Jun. 19, 2014, “Flexible Embedded Interconnects”); 20140318699 (Longinotti-Buitoni et al., Oct. 30, 2014, “Methods of Making Garments Having Stretchable and Conductive Ink”); and 20150040282 (Longinotti-Buitoni et al., Feb. 12, 2015, “Compression Garments Having Stretchable and Conductive Ink”).

### SUMMARY OF THIS INVENTION

This invention is a touch-based and/or gesture-based human-to-computer textile interface comprising: an article of clothing or clothing accessory; and an array or mesh of electromagnetic sensors, wherein these electromagnetic sensors are woven or otherwise integrated into the fabric of the article of clothing or clothing accessory, and wherein these electromagnetic sensors transduce human touch and/or gestures into computer inputs. In an example, an electromagnetic sensor can comprise an array or mesh of electroconductive fibers, threads, or yarns which are woven together using a plain weave, a rib weave, a basket weave, a twill weave, a satin weave, a leno weave, or a mock leno weave.

In an example, an electromagnetic sensor and/or electromagnetic energy pathway can collect data concerning the voltage, conductivity, resistance, capacitance and/or impedance of electromagnetic energy that is transmitted through a portion of an article of clothing. In an example, a touch-based and/or gesture-based human-to-computer textile interface can detect human motion comprising the touch of a human finger on its surface. In an example, a touch-based and/or gesture-based human-to-computer textile interface can detect human motion comprising movement of a human finger in proximity to its surface.

More generally, the following figures also show several examples of a system of modular smart clothing (or clothing accessory) comprising an article of clothing (or clothing accessory) worn by a person, an energy-transducing member, and an attachment mechanism. In an example, such a system can have a first configuration wherein an energy-transducing member is not attached to the clothing (or accessory) and a second configuration wherein the energy-transducing member is removably attached by the person to the clothing (or accessory).

### BRIEF INTRODUCTION TO THE FIGURES

FIG. 1 shows smart clothing with electromagnetic energy transmitting member for motion capture.

FIG. 2 shows smart clothing with electromagnetic energy generating member for motion capture.

FIG. 3 shows smart clothing with an accelerometer for motion capture.

FIG. 4 shows smart clothing with multiple modular accelerometers for motion capture.

FIG. 5 shows smart clothing with finger ring accelerometers for motion capture.

FIG. 6 shows smart clothing with longitudinally-spanning pressure tubes for motion capture.

FIG. 7 shows smart clothing with a motion-controlled light.

FIG. 8 shows smart clothing with an electromagnetic blood pressure sensor.

FIG. 9 shows smart clothing with an optical blood pressure sensor sensor.

FIG. 10 shows smart clothing with a pressured-based blood pressure.

FIG. 11 shows smart clothing with an electromagnetic heart rate/pulse sensor.

FIG. 12 shows smart clothing with a sound-based heart rate/pulse sensor.

FIG. 13 shows smart clothing with a pressured-based heart rate/pulse sensor.

FIG. 14 shows smart clothing with an ECG/EKG sensor/monitor.

FIG. 15 shows smart clothing with an electromagnetic glucose monitor.

FIG. 16 shows smart clothing with an optical glucose monitor.

FIG. 17 shows smart clothing with a glucose-level tactile feedback device.

FIG. 18 shows smart clothing with an optical oxygen saturation sensor.

FIG. 19 shows smart clothing with a motion-based food consumption detector.

FIG. 20 shows smart clothing with a communication device to send and receive messages.

FIG. 21 shows smart clothing with a “black box” for humans.

FIG. 22 shows smart clothing with a display attached to a clothing surface.

FIG. 23 shows smart clothing with an optical textile for changing images on the clothing surface.

FIG. 24 shows smart clothing with a fiber-optic clothing display matrix.

FIG. 25 shows smart clothing with a display beneath a fabric layer.

FIG. 26 shows smart clothing with a touch-based and/or gesture-based human-to-computer textile interface.

FIG. 27 shows smart clothing with an electromagnetic-textile pulmonary/respiratory monitor.

FIG. 28 shows smart clothing with an accelerometer-based pulmonary/respiratory monitor.

FIG. 29 shows smart clothing with an electromagnetic brain activity monitor.

FIG. 30 shows smart clothing with an EMG-based sensor for motion capture.

FIG. 31 shows smart clothing with a muscle activity sensing textile for motion capture.

FIG. 32 shows smart clothing with multiple modular wearable sensors.

FIG. 33 shows smart clothing with a cyclical power transducer.

FIG. 34 shows smart clothing with a modular power source.

FIG. 35 shows smart clothing with a neural electromagnetic emission sensor for motion capture.

FIG. 36 shows smart clothing with a light pathway for motion capture.

FIG. 37 shows smart clothing with a light-based ankle stride monitor.

FIG. 38 shows smart clothing with a sound-triggering motion sensor.

FIG. 39 shows smart clothing with a finger tip accelerometer for motion capture.

FIG. 40 shows smart clothing with a magnet-attached accelerometer.

FIG. 41 shows smart clothing with variable contraction.

FIG. 42 shows smart clothing with GPS-accelerometer coordination.

FIG. 43 shows smart clothing with GPS, motion sensor, and altimeter.

FIG. 44 shows smart clothing with an eye-tracking camera.

FIG. 45 shows smart clothing with modular eye-tracking augmented reality eyewear.

FIG. 46 shows smart clothing with a two-stage biochemical glucose monitor.

FIG. 47 shows smart clothing with an ambient-air analyzing sensor.

FIG. 48 shows smart clothing with an electromagnetic food consumption monitor.

FIG. 49 shows smart clothing with a tissue-optical-spectrum food consumption monitor.

FIG. 50 shows smart clothing with a proximal food spectrometer.

FIG. 51 shows smart clothing with an image-based food consumption monitor.

FIG. 52 shows smart clothing with communication filtered based on EEG.

FIG. 53 shows smart clothing with communication initiated based on EEG pattern.

FIG. 54 shows smart clothing with communication filtered based on EMG electromagnetic motion.

FIG. 55 shows smart clothing with communication filtered based on accelerometer motion.

FIG. 56 shows smart clothing with interface mode/level based on EMG motion level.

FIG. 57 shows smart clothing with interface mode/level based on accelerometer motion.

FIG. 58 shows smart clothing with interface mode/level based on EEG.

FIG. 59 shows smart clothing with communication notification mode/level based on EEG.

FIG. 60 shows smart clothing with communication notification mode/level based on EMG.

FIG. 61 shows smart clothing with communication notification mode/level based on ambient light.

FIG. 62 shows smart clothing with communication response based on ambient light or sound.

FIG. 63 shows smart clothing with interface mode/level based on ambient light level.

FIG. 64 shows smart clothing with communication notification mode/level based on ambient sound.

FIG. 65 shows smart clothing with interface mode/level based on ambient sound level.

FIG. 66 shows smart clothing with a clothing-based voice/speech recognition unit.

FIG. 67 shows smart clothing with a clothing-based sound masking/cancellation.

FIG. 68 shows smart clothing with sound-based communication with a mobile device.

FIG. 69 shows smart clothing with a tactile-based interface.

FIG. 70 shows smart clothing with a coherent-light image projector.

FIG. 71 shows smart clothing with modular lights.

FIG. 72 shows smart clothing with sound-based food consumption detection.

FIG. 73 shows smart clothing with variable-porosity.

FIG. 74 shows smart clothing with variable water-resistance.

FIG. 75 shows smart clothing with variable puncture resistance.

FIG. 76 shows smart clothing for bioidentification.

FIG. 77 shows smart clothing for home HVAC control.

FIG. 78 shows smart clothing with an optical pulmonary function sensor.

FIG. 79 shows smart clothing with a sonic pulmonary function sensor.

FIG. 80 shows smart clothing with a clothing-based microphone.

FIG. 81 shows smart clothing with wearable air pressure/flow sensors.

FIG. 82 shows smart clothing with wearable external-chest pressure sensors.

FIG. 83 shows smart clothing with an EEG headband.

FIG. 84 shows smart clothing with an optical brain activity monitor.

FIG. 85 shows smart clothing with a brain camera.

FIG. 86 shows smart clothing with brain lights.

FIG. 87 shows smart clothing for gesture-based financial transactions.

FIG. 88 shows smart clothing with electromagnetic-sensitive rings to measure gestures.

FIG. 89 shows smart clothing with external electromagnetic gastrointestinal stimulation.

FIG. 90 shows smart clothing for telerobotic control.

### DETAILED DESCRIPTION OF THE FIGURES

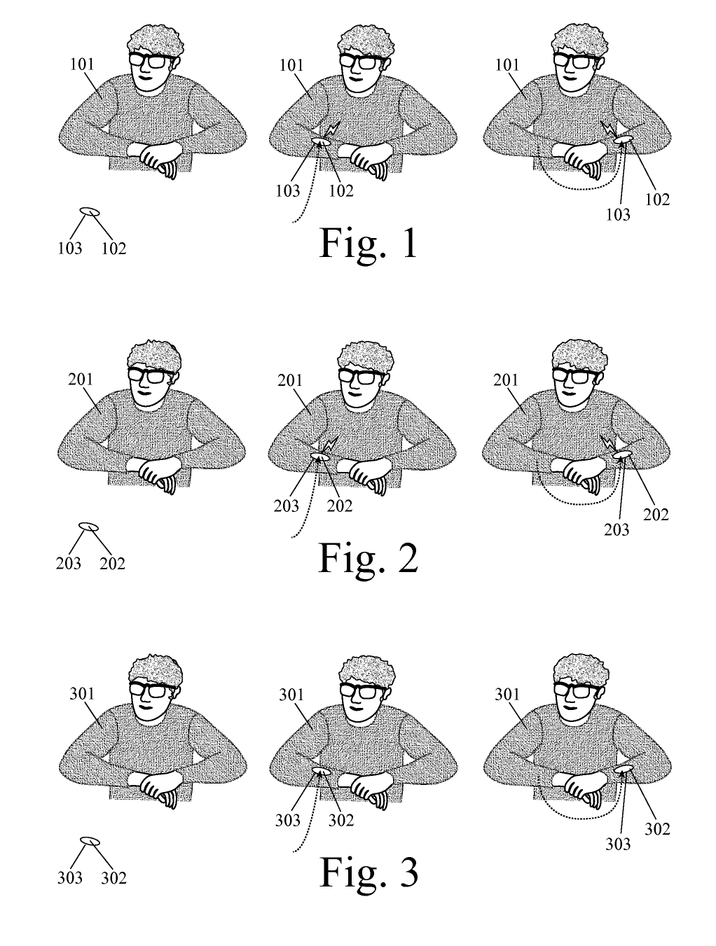

FIGS. 1 through 90 show several examples of how this invention can be embodied, but they do not limit the full generalizability of the claims. FIG. 26 in particular shows how this invention can be embodied in a touch-based and/or gesture-based human-to-computer textile interface comprising: an article of clothing or clothing accessory; and an array or mesh of electromagnetic sensors, wherein these electromagnetic sensors are woven or otherwise integrated into the fabric of the article of clothing or clothing accessory, and wherein these electromagnetic sensors transduce human touch and/or gestures into computer inputs.

More generally, FIGS. 1 through 90 show several examples of how this invention can be embodied in a system of smart clothing (or a clothing accessory) comprising: an article of clothing (or clothing accessory) worn by a person; an energy-transducing member; and an attachment mechanism. This system can have a first configuration wherein the energy-transducing member is not attached to the clothing (or accessory) and a second configuration wherein the energy-transducing member is removably attached by the person to the clothing (or accessory) via the attachment mechanism. A system can also have a third configuration wherein the modular energy-transducing member can be alternatively attached by the person to a different location on the clothing (or accessory). In these figures, the left side shows the first configuration, the middle portion shows the second configuration, and the right side shows the third configuration. In these figures, an article of clothing (or a wearable clothing accessory) can be selected from the group consisting of below-defined “Set A,” a modular energy-transducing member can be selected from the group consisting of below-defined “Set B,” and an attachment mechanism or method can be selected from the group consisting of below-defined “Set C.”

Set “A” comprises articles of clothing and wearable clothing accessories. Set “A” is defined herein to comprise the group consisting of: shirt, T-shirt, blouse, sweatshirt, sweater, neck tie, collar, cuff, jacket, vest, other upper-body garment, pants, shorts, jeans, slacks, sweatpants, briefs, skirt, other lower-body garment, underwear, underpants, panties, pantyhose, jockstrap, undershirt, bra, brassier, girdle, bathrobe, pajamas, hat, cap, skullcap, headband, hoodie, poncho, other garment with hood, sock, shoe, sneaker, sandal, other footwear, suit, coat, dress, jump suit, one-piece garment, union suit, swimsuit, bikini, other full-body garment, and glove.

Set “A” further comprises: wrist band, wrist watch, smart watch, bracelet, bangle, strap, other wrist-worn band, eyewear, eyeglasses, contact lens, virtual reality glasses or visor, augmented reality glasses or visor, monocle, goggles, sunglasses, eye mask, visor, electronically-functional eyewear, necklace, neck chain, neck band, collar, dog tags, pendant, beads, medallion, brooch, pin, button, cuff link, tie clasp, finger ring, artificial finger nail, finger nail attachment, finger tube, head band, hair band, wig, headphones, helmet, ear ring, ear plug, ear bud, hearing aid, ear muff, other ear attachment, respiratory mask, face mask, nasal mask, nose ring, nasal pillow, arm bracelet, bangle, amulet, strap, or band, ankle bracelet, bangle, amulet, strap, or band, artificial tooth, dental implant, dental appliance, dentures, dental bridge, braces, upper palate attachment or insert, tongue ring, band, chain, electronic tattoo, adhesive patch, bandage, belt, waist band, suspenders, chest band, abdominal brace, elbow brace, knee brace, shoulder brace, shoulder pad, ankle brace, pocketbook, purse, key chain, and wallet.

Set “B” comprises modular energy-transducing members which can be attached to, or otherwise integrated with, members of Set “A”. Set “B” is defined herein to comprise the group consisting of: motion sensor, inertial sensor, single axis, biaxial, or multi-axial accelerometer, kinematic sensor, gyroscope, tilt sensor, inclinometer, vibration sensor, motion-based user interface, gesture-based user interface, bend sensor, goniometer, strain gauge, stretch sensor, pressure sensor, force sensor, flow sensor, air pressure sensor, airflow sensor, altimeter, barometer, blood flow monitor, blood pressure monitor, microcantilever sensor, microfluidic sensor, manometer, peak flow meter, actuator, microscale motor, micro electromechanical system (MEMS) actuator, pneumatic actuator, piezoelectric actuator, microfluidic pump, tactile-sensation-creating member, tactile user interface, inflatable member, nanotube sensor, nanotube actuator, variable-contraction textile member, touch screen, touch-based human-to-computer textile interface, touchpad, virtual projected keypad, and gesture recognition sensor, global positioning system (GPS) module, and compass.

Set “B” further comprises: electromagnetic energy sensor, electromagnetic conductivity sensor, skin conductance sensor, electromagnetic resistance sensor, variable resistance sensor, electromagnetic impedance sensor, variable impedance sensor, skin impedance sensor, amp meter, voltmeter, magnetometer, magnetic field sensor, compass, radio frequency (RF) sensor, Hall-effect sensor, piezocapacitive sensor, piezoelectric sensor, electrogoniometer, electroconductive fiber, electrochemical sensor, electromagnetic electrode, electroosmotic sensor, electrophoresis sensor, electroporation sensor, neural impulse monitor and/or sensor, neurosensor, action potential sensor, electrocardiography (ECG) or EKG sensor and/or monitor, electroencephalography (EEG) sensor and/or monitor, electromagnetic brain activity sensor and/or monitor, electrogastrography (EGG) sensor and/or monitor, electromyography (EMG) sensor and/or monitor, electromagnetic muscle activity sensor, electrooculography (EOG) sensor and/or monitor, galvanic skin response (GSR) sensor and/or monitor, hemoencephalography (HEG) monitor, micro electromechanical system (MEMS) sensor, cardiac function monitor, cardiotachometer, cardiovascular monitor, heart rate monitor, heart sensor, pulse monitor, pulmonary function and/or respiratory function monitor, respiration rate monitor, tidal volume sensor, spirometry monitor, pneumography sensor, breathing monitor, and nebulizer.

Set “B” further comprises: electromagnetic energy emitter, external electromagnetic energy emitter, power source, energy harvesting and releasing member, kinetic energy harvesting module, thermal energy harvesting module, battery, myostimulator, neurostimulator, gastric electric stimulator (GES), potentiometer, electromagnetic actuator, electric motor, DC motor, stepper motor, induction motor, micro electromechanical system (MEMS) actuator, piezoelectric actuator, electroconductive member, electronically-functional bandage, button, cap, contact lens, eyewear, finger ring, respiratory mask, skin patch, tattoo, or textile interface, appliance control module, augmented reality module, bioidentification sensor, incoming communication filtration member, computer-to-human interface, continuously-recording device, home appliance control module, home security control module, home environmental control module, human-to-computer interface, keyboard or keypad, phone or other mobile communication device, virtual reality module, data memory, data processor, data storage module, wireless data transmitter, and wireless data receiver.

Set “B” further comprises: light energy sensor, light-based user interface, ambient light sensor, electro-optical sensor, infrared sensor, laser sensor, light intensity sensor, optical sensor, optoelectronic sensor, photochemical sensor, photoelectric sensor, photometer, ultraviolet light sensor, thermoluminescence sensor, variable-translucence sensor, photoplethysmography (PPG) sensor, chemiluminescence sensor, fluorescence sensor, wearable imaging device, image recorder, camera, video recorder, spectroscopic sensor, light-spectrum-analyzing sensor, color sensor, spectral analysis sensor, spectrometry sensor, spectrophotometric sensor, spectroscopy sensor, near-infrared, infrared, ultraviolet, or white light spectroscopy sensor, mass spectrometry sensor, Raman spectroscopy sensor, ion mobility spectroscopic sensor, backscattering spectrometry sensor, chromatography sensor, optical glucose sensor, gas chromatography sensor, and analytical chromatography sensor.

Set “B” further comprises: light-emitting member, infrared light emitter, laser, light emitting diode (LED), light-emitting optical fiber, optical emitter, optochemical sensor, birefringent material, crystal, cylindrical prism, eye-tracking sensor, fiber optic bend sensor, fiber optic member, lens, light-conducting fiber, light-conducting members, metamaterial light channel, mirror, mirror array, optical fiber, optoelectronic lens, variable-focal-length lens, display screen, image display member, imaging device, light-emitting member array or matrix, light display array or matrix, light emitting diode (LED) array or matrix, liquid crystal display (LCD), textile-based light display, camouflaged wearable image-display, fiber optic display array or matrix, microlens array, micro-mirror array, image projector, non-coherent-light image projector, infrared projector, holoprojector, and coherent light image projector.

Set “B” further comprises: sound sensor, sound-based user interface, sonic energy sensor, microphone, speech and/or voice recognition interface, breathing sound monitor, chewing and/or swallowing monitor, ambient sound sensor or monitor, ultrasound sensor, Doppler ultrasound sensor, audiometer, tympanometer, analog stethoscope, digital stethoscope, sound-emitting member, speaker, audio speaker, sound masking or cancelling member, white or pink noise emitter, ultrasound emitter, and textile-based sound-conducting member.

Set “B” further comprises: temperature and/or thermal energy sensor, thermistor, thermometer, thermopile, body temperature sensor, skin temperature sensor, ambient temperature sensor, heat pump, variable R-value fabric, biochemical sensor, ambient air monitor, amino acid sensor, antibody receptor, artificial olfactory sensor, blood glucose monitor, blood oximeter, body fat sensor, caloric expenditure monitor, caloric intake monitor, capnography sensor, carbon dioxide sensor, carbon monoxide sensor, cerebral oximetry monitor, chemical sensor, chemiresistor sensor, chemoreceptor sensor, cholesterol sensor, cutaneous oxygen monitor, ear oximeter, food composition analyzer, food identification sensor, food consumption monitor, caloric intake monitor, gas composition sensor, glucometer, glucose monitor, humidity sensor, hydration sensor, laboratory-on-a-chip, microbial sensor, moisture sensor, osmolality sensor, oximeter, oximetry sensor, oxygen consumption monitor, oxygen level monitor or sensor, oxygen saturation monitor, pH level sensor, porosity sensor, pulse oximeter, skin moisture sensor, sodium sensor, tissue oximetry sensor, and tissue saturation oximeter.

Set “C” comprises mechanisms and methods for attaching modular energy-transducing members to articles of clothing and/or a person's body. Set “C” is defined herein to comprise the group consisting of: band, wrist band, arm band, elastic member, loop, mesh, strap, necklace, chain, clip, clasp, snap, buckle, clamp, button, hook, pin, knob, plug, hook-and-eye mechanism, pocket, pouch, fabric pocket, fabric channel, adhesive/adhesion, tape, gluing, melting, electronic and/or electromagnetic connector, electronic plug, magnetic connector, screw, threaded rotation, tension, knitting, weaving, sewing, strand, fiber, thread, suture, knob, and zipper.

FIG. 1 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle portion shows the second configuration, and the right side shows the third configuration.

In FIG. 1, the clothing can be selected from the group consisting of “Set A.” In this figure, article of clothing 101 is a shirt. In FIG. 1, the energy-transducing member can be selected from the group consisting of “Set B.” In this figure, energy-transducing member 102 is a modular electromagnetic energy sensor which collects data concerning the transmission of electromagnetic energy through the article of clothing, wherein this data is used to measure the person's body motion, configuration, posture, and/or gestures. In FIG. 1, attachment mechanism 103 can be selected from the group consisting of “Set C.”

In an example, a modular electromagnetic energy sensor can be used in combination with a modular electromagnetic energy emitter. In an example, a modular electromagnetic energy sensor can collect data concerning the voltage, conductivity, resistance, capacitance and/or impedance of electromagnetic energy from an electromagnetic energy emitter that is transmitted through a portion of an article of clothing. In an example, electromagnetic energy can be transmitted through one or more energy pathways in the clothing. In an example, an energy pathway can further comprise electroconductive fibers, threads, or other members which are woven or otherwise integrated into an article of clothing.

In an example, electroconductive fibers, threads, or other members can be elastic, sinusoidal, and/or curved. In an example, these fibers, threads, or other members can span body joints and changes in the person's body configuration cause changes in the shapes of these fibers, threads, or other members. These shape changes, in turn, change the transmission of electromagnetic energy through these fibers, threads, or other members. These changes in electromagnetic energy transmission are measured by one or more modular electromagnetic energy sensors. These measurements are then used to model the underlying changes in body motion. In an example, this invention can comprise a set of smart clothing (e.g. including a shirt and pants) for full-body motion capture. In an example, a person can select the locations to which a plurality of modular electromagnetic energy emitters and modular electromagnetic energy sensors are attached in order to create a customized set of smart clothing for individualized full-body motion capture.

FIG. 2 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be attached by the person to a different location on the clothing (or accessory). The left side of this figure shows the first configuration, the middle shows the second configuration, and the right side shows the third configuration.

In FIG. 2, clothing (or an accessory) can be selected from the group consisting of “Set A.” In this figure, article of clothing 201 is a shirt. In FIG. 2, the energy-transducing member can be selected from the group consisting of “Set B.” In this figure, energy-transducing member 202 is a modular electromagnetic energy sensor which collects data concerning the generation of electromagnetic energy in order to measure body motion, configuration, posture, and/or gestures. In FIG. 2, attachment mechanism 203 can be selected from the group consisting of “Set C.”

In an example, a modular electromagnetic energy sensor can measure electromagnetic energy which is generated by piezoelectric members in an article of clothing as a person moves. In an example, changes in the shape of a piezoelectric fiber or textile layer generate electromagnetic energy. In example, piezoelectric fibers, layers, or other members can be woven or otherwise incorporated into the fabric or textile of an article of clothing. In an example, patterns of electricity generation from different portions of an article of clothing as a person moves can provide data that can be used for large-scale motion capture.

FIG. 3 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 3, clothing (or an accessory) can be selected from the group consisting of “Set A.” In this figure, article of clothing 301 is a shirt. In FIG. 3, the energy-transducing member can be selected from the group consisting of “Set B.” In this figure, energy-transducing member 302 is a modular motion sensor whose data is used to measure the person's body motion, configuration, posture, and/or gestures. In FIG. 3, attachment mechanism 303 can be selected from the group consisting of “Set C.”

In an example, a modular motion sensor can be an accelerometer, gyroscope, or inclinometer. In an example, a person can removably attach a modular motion sensor to one of a selected group of locations on an article of clothing. In an example, a person can removably attach a modular motion sensor virtually anywhere on an article of clothing. In an example, a person can removably attach a plurality of motion sensors to different locations on one or more articles of clothing in order to create customized set of smart clothing for large-scale motion capture.

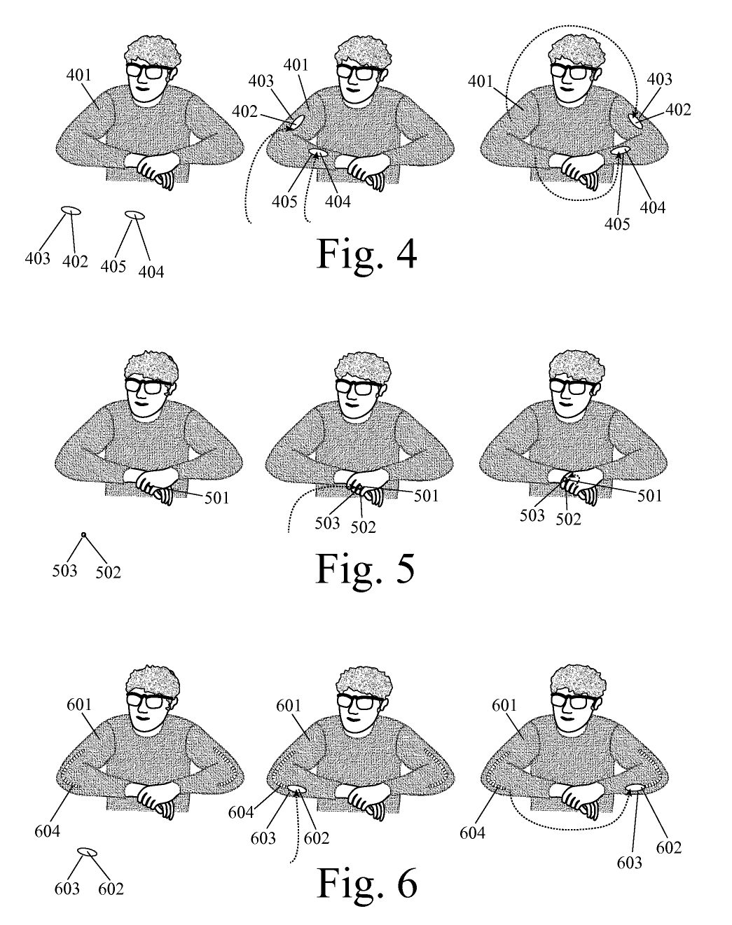

FIG. 4 shows an example of how this invention can be embodied in a system of modular smart clothing (or a modular clothing accessory) for motion capture comprising: an article of clothing (or clothing accessory) worn by a person; a plurality of modular energy-transducing members; and attachment mechanisms. This system has a first configuration in which the plurality of modular energy-transducing members is not attached to the article of clothing (or clothing accessory) and a second configuration in which the plurality of energy-transducing members is attached by the person to the clothing (or accessory) via the attachment mechanisms. This system can also have a third configuration wherein the plurality of modular energy-transducing members can be alternatively attached by the person to different locations on the article of clothing (or clothing accessory). The left side of this figure shows the first configuration, the middle shows the second configuration, and the right side shows the third configuration.

In FIG. 4, clothing (or an accessory) can be selected from the group consisting of “Set A.” In this figure, article of clothing 401 is a shirt. In FIG. 4, a plurality of energy-transducing members is selected from the group consisting of “Set B.” In this figure, the plurality of modular energy-transducing members 402 and 404 comprises modular motion sensors whose data are used to measure the person's body motion, configuration, posture, and/or gestures. In an example, modular motion sensors can be accelerometers, gyroscopes, or inclinometers. In FIG. 4, attachment mechanisms 403 and 405 can be selected from the group consisting of “Set C.”

In an example, a person can removably attach a plurality of modular motion sensors to a subset of a pre-determined set of locations on an article of clothing. In an example, a person can removably attach a plurality of modular motion sensors virtually anywhere on an article of clothing. In an example, a person can removably attach a plurality of motion sensors to different locations on one or more articles of clothing in order to create customized set of smart clothing for large-scale motion capture. In an example, combined analysis of data from a plurality of modular motion sensors can substantially measure a person's full-body motion, configuration, posture, and/or gestures.

FIG. 5 shows an example of how this invention can be embodied in a modular clothing accessory comprising: a clothing accessory worn by a person; an energy-transducing member; and an attachment mechanism. This system has a first configuration wherein the energy-transducing member is not attached to the clothing accessory and a second configuration wherein the energy-transducing member is removably attached by the person to the clothing accessory via the attachment mechanism. This system can also have a third configuration wherein the energy-transducing member can be alternatively attached by the person to a different location on the clothing accessory.

In FIG. 5, the clothing accessory is selected from the group consisting of “Set A.” In this figure, clothing accessory 501 comprises a finger ring. In FIG. 5, the energy-transducing member can be selected from the group consisting of “Set B.” In this figure, energy-transducing member 502 is a modular motion sensor. In FIG. 5, attachment mechanism 503 can be selected from the group consisting of “Set C.”

In an example, a removable motion sensor can be attached to a finger ring to collect data which is used to measure a person's hand gestures, body motion, and/or body configuration. In an example, the motion sensor can be an accelerometer, gyroscope, or inclinometer. In an example, this system can comprise multiple finger rings (e.g. one ring on each finger and the thumb), wherein each of these rings has a motion sensor and wherein data from these multiple finger rings are analyzed collectively to identify a person's hand gestures.

FIG. 6 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 6, clothing can be selected from the group consisting of “Set A.” In this figure, article of clothing 601 is a shirt. In FIG. 6, the energy-transducing member can be selected from the group consisting of “Set B.” In this figure, energy-transducing member 602 is a modular pressure sensor whose data is used to measure body motion, configuration, posture, and/or gestures. In FIG. 6, attachment mechanism 603 can be selected from the group consisting of “Set C.”

In an example, modular pressure sensor 602 can measure the pressure within a tube or channel 604 which longitudinally spans a body joint. In an example, a longitudinal tube or channel can be filled with a gas, liquid, or gel. In an example, a pressure sensor can be in fluid or gaseous communication with the gas, liquid, or gel inside a tube or channel. In an example, changes in joint angle can be estimated based on pressure changes in a tube or channel which spans the body joint. In an example, combined analysis of pressure data from multiple longitudinal tubes or channels spanning the same body joint can provide more accurate estimation of joint angle than analysis of data from any one of the tubes or channels alone.

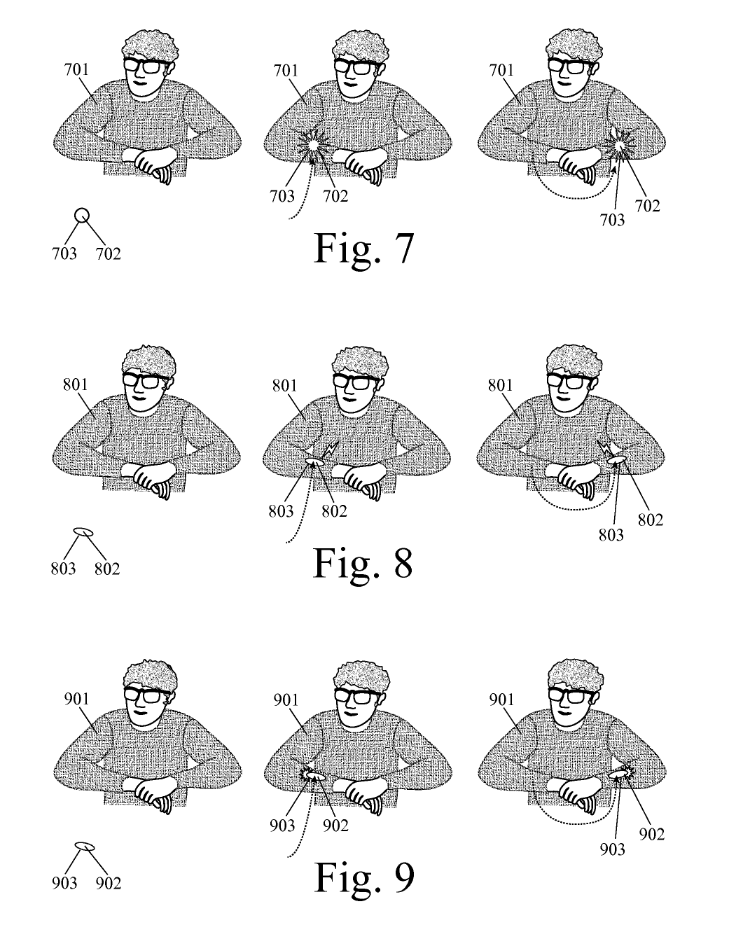

FIG. 7 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 7, clothing (or an accessory) can be selected from the group consisting of “Set A.” In this figure, article of clothing 701 is a shirt. In an alternative example, this article of clothing (or clothing accessory) can comprise a dress, pair of pants, set of finger rings, set of artificial finger nails, and/or other set of accessories attached to fingers. In FIG. 7, the energy-transducing member can be selected from the group consisting of “Set B.” In this figure, energy-transducing member 702 is a modular light-emitting member whose light activation, intensity, color, sequence, and/or spectrum is modified by the person's body motion. In FIG. 7, attachment mechanism 703 can be selected from the group consisting of “Set C.”

In an example, a modular light-emitting member can be a Light-Emitting Diode (LED). In an example, changes in light activation, intensity, color, sequence, and/or spectrum can be based on changes in of body member location in three-dimensional space. In an example, changes in light activation, intensity, color, sequence, and/or spectrum can be based on acceleration. In an example, Fourier transformation methods can be used to better synchronize cyclical changes in light patterns to cyclical changes in body motion. In an example, changes in the activation, intensity, color, sequence, and/or spectrum of one or more light-emitting members based on body motion can be used for entertainment, performance, fashion, gaming, sports, and/or communication purposes.

FIG. 8 shows an example of how this invention can be embodied in a system of modular smart clothing (or a modular clothing accessory) for monitoring blood pressure comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 8, clothing (or an accessory) can be selected from the group consisting of “Set A.” In this figure, article of clothing 801 is a shirt. In FIG. 8, the energy-transducing member can be selected from the group consisting of “Set B.” In this figure, energy-transducing member 802 is a modular electromagnetic energy sensor whose data is used to measure the person's blood pressure. In FIG. 8, attachment mechanism 803 can be selected from the group consisting of “Set C.”

In an example, this modular electromagnetic energy sensor can measure changes in the voltage, conductivity, resistance, capacitance and/or impedance of electromagnetic energy that is emitted from, or transmitted through, body fluid and/or tissue. In an example, changes in blood pressure cause changes in the manner in which electromagnetic energy is emitted from, or transmitted through, body fluid and/or tissue. In an example, changes in the transmission of electromagnetic energy can include changes in voltage, conductivity, resistance, and/or impedance. In an example, Fourier transformation methods can be used to differentiate changes in electromagnetic energy due to (cyclical) changes in blood pressure versus changes in electromagnetic energy from other causes. In an example, data from multiple electromagnetic energy sensors at different locations can be combined to get a more accurate measurement of blood pressure than is possible with a single electromagnetic energy sensor at a single location.

FIG. 9 shows an example of how this invention can be embodied in a system of modular smart clothing (or a modular clothing accessory) for monitoring blood pressure comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 9, clothing (or an accessory) can be selected from the group consisting of “Set A.” In this figure, article of clothing 901 is a shirt. In FIG. 9, the energy-transducing member can be selected from the group consisting of “Set B.” In this figure, energy-transducing member 902 is a modular light energy sensor whose data is used to measure the person's blood pressure. In FIG. 9, attachment mechanism 903 can be selected from the group consisting of “Set C.”

In an example, a modular light energy sensor can measure changes in the intensity, color, phase, and/or spectrum of light energy which is reflected from, or transmitted through, body fluid and/or tissue in order to measure a person's blood pressure. In an example, a modular light energy sensor can be a spectroscopy sensor. In an example, this light energy can be visible light, infrared light, or ultraviolet light. In an example, this light energy can be coherent, such as light from a laser. In an example, a light energy sensor can be used in combination with a light energy emitter. In an example, Fourier analysis can be used to differentiate cyclical changes in reflected or absorbed light energy due to changes in blood pressure versus other changes in blood fluid and/or tissue.

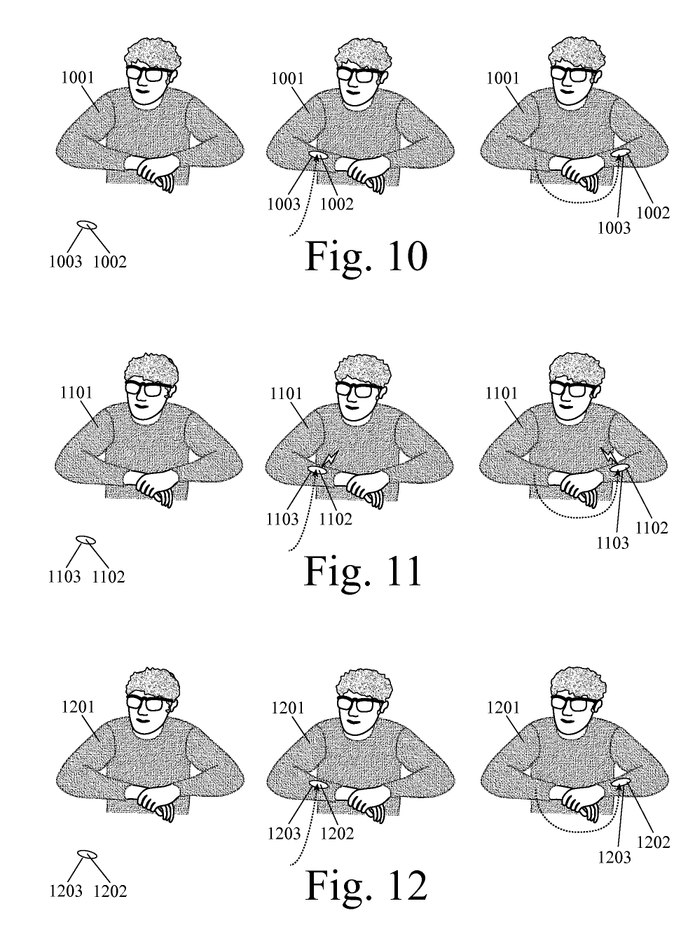

FIG. 10 shows an example of how this invention can be embodied in a system of modular smart clothing (or a modular clothing accessory) for monitoring blood pressure comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 10, clothing (or an accessory) can be selected from the group consisting of “Set A.” In this figure, article of clothing 1001 is a shirt. In FIG. 10, the energy-transducing member can be selected from the group consisting of “Set B.” In this figure, energy-transducing member 1002 is a modular pressure sensor whose data is used to measure blood pressure. In FIG. 10, attachment mechanism 1003 can be selected from the group consisting of “Set C.” In an example, a modular pressure sensor can be a piezoelectric sensor which is in contact with the surface of the person's body. In an example, Fourier analysis can be used to differentiate cyclical changes in sensor pressure due to changes in blood pressure versus other changes in blood fluid and/or tissue.

FIG. 11 shows an example of how this invention can be embodied in a system of modular smart clothing (or a modular clothing accessory) for monitoring heart rate comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 11, clothing can be selected from the group consisting of “Set A.” In this figure, article of clothing 1101 is a shirt. In FIG. 11, the energy-transducing member can be selected from the group consisting of “Set B.” In this figure, energy-transducing member 1102 is a modular electromagnetic energy sensor whose data is used to measure the person's heart rate and/or pulse rate. In FIG. 11, attachment mechanism 1103 can be selected from the group consisting of “Set C.”

In an example, a modular electromagnetic energy sensor can be used in combination with a modular electromagnetic energy emitter. In an example, a modular electromagnetic energy sensor can collect data concerning the voltage, conductivity, resistance, or impedance of electromagnetic energy that is transmitted through body fluid and/or tissue. In an example, this data can, in turn, be used to estimate the person's heart rate and/or pulse rate. In an alternative example, a modular energy-transducing member can measure data concerning electromagnetic energy that is naturally emitted from body fluid or tissue. In an alternative example, a modular energy-transducing member can measure the voltage, conductivity, resistance, or impedance of electromagnetic energy transmitted through a pathway in the article of clothing (or clothing accessory) which is induced by natural electromagnetic energy emissions or transmissions.

In an example, a person can removably attach multiple modular energy-emitting members and energy-sensing members to different locations on one or more articles of clothing to obtain more accurate measurement of heart rate than is possible at a single location. In an example, analysis of data from multiple locations can help to control for electromagnetic energy changes which are not due to the beating of the heart and/or pulsation of blood through the vasculature. In an example, Fourier transformation methods can be used to differentiate cyclical changes in electromagnetic energy due to the beating of the heart from non-cyclical changes in electromagnetic energy due to other causes. In an example, a person can removably attach multiple modular energy-emitting members and energy-sensing members to different locations on one or more articles of clothing in order to create a customized set of smart clothing for optimally measuring their heart rate.

FIG. 12 shows an example of how this invention can be embodied in a system of modular smart clothing (or a modular clothing accessory) for monitoring heart rate comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 12, clothing can be selected from the group consisting of “Set A.” In this figure, article of clothing 1201 is a shirt. In FIG. 12, the energy-transducing member can be selected from the group consisting of “Set B.” In this figure, energy-transducing member 1202 is a modular sonic energy sensor whose data is used to measure heart rate and/or pulse rate. In FIG. 12, attachment mechanism 1203 can be selected from the group consisting of “Set C.”

In an example, a modular sonic energy sensor can be a microphone. In an example, a modular sonic energy sensor can be used in combination with a modular sonic energy emitter. In an example, this sonic energy can be in an audible range. In an example, this sonic energy can be ultrasonic. In an example, a sonic energy sensor can be combined with an ultrasonic energy emitter and the sonic energy sensor can measure ultrasonic energy. In an example, Fourier transformation methods can be used to differentiate cyclical sounds from a beating heart versus other sounds. In an example, data from modular sonic energy sensors at different locations on an article of clothing can be combined to obtain a more accurate measurement of heart rate than is possible with a single sonic energy sensor at a single location.

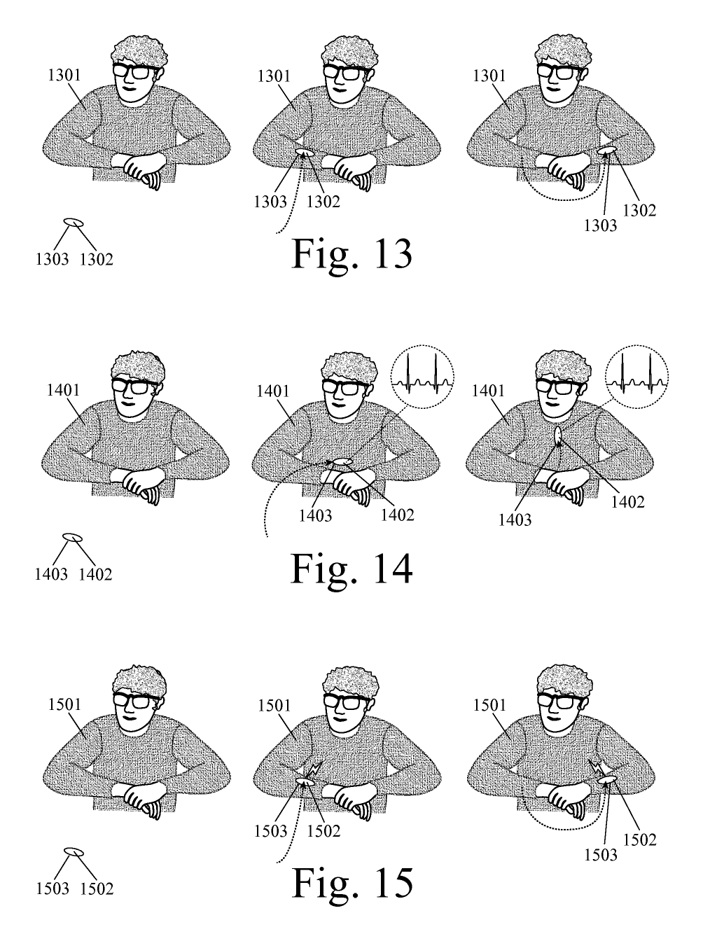

FIG. 13 shows an example of how this invention can be embodied in a system of modular smart clothing (or a modular clothing accessory) for monitoring heart rate comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 13, clothing can be selected from the group consisting of “Set A.” In this figure, article of clothing 1301 is a shirt. In FIG. 13, the energy-transducing member can be selected from the group consisting of “Set B.” In this figure, energy-transducing member 1302 is a modular pressure sensor whose data is used to measure the person's heart rate and/or pulse rate. In FIG. 13, attachment mechanism 1303 can be selected from the group consisting of “Set C.” In an example, a modular pressure sensor can be a piezoelectric pressure sensor which collects data that is used to measure a person's heart rate and/or pulse rate. In an example, data from pressure sensors at different locations can be combined to obtain a more accurate measurement of heart rate than is possible with a single pressure sensor at a single location.

FIG. 14 shows an example of how this invention can be embodied in a system of modular smart clothing (or a modular clothing accessory) for monitoring cardiac function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 14, clothing can be selected from the group consisting of “Set A.” In this figure, article of clothing 1401 is a shirt. In other examples, article of clothing (or accessory) 1401 can be another type of chest-worn garment or accessory. In FIG. 14, the energy-transducing member can be selected from the group consisting of “Set B.” In this figure, energy-transducing member 1402 is a modular electromagnetic energy sensor whose data is used to measure cardiac and/or cardiovascular activity. In FIG. 14, attachment mechanism 1403 can be selected from the group consisting of “Set C.”

In an example, a modular electromagnetic energy sensor can be an ElectroCardioGram (ECG) [or EKG] sensor. In an example, a modular electromagnetic energy sensor can measure patterns of electromagnetic energy which are naturally generated by the heart and/or surrounding tissue. In an example, a modular electromagnetic energy sensor can be used in combination with a modular electromagnetic energy emitter. In an example, a modular electromagnetic energy sensor can measure changes in the voltage, conductivity, resistance, capacitance and/or impedance of electromagnetic energy transmitted from an energy emitter through a person's heart and/or surrounding tissue. In an example, an electromagnetic energy sensor can measure changes in electromagnetic energy which are induced in an article of clothing that is in proximity to a person's heart.

FIG. 15 shows an example of how this invention can be embodied in a system of modular smart clothing (or a modular clothing accessory) for monitoring glucose comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 15, clothing can be selected from the group consisting of “Set A.” In this figure, article of clothing 1501 is a shirt. In FIG. 15, the energy-transducing member can be selected from the group consisting of “Set B.” In this figure, energy-transducing member 1502 is a modular electromagnetic energy sensor whose data is used to measure the glucose level of body fluid and/or tissue. In FIG. 15, attachment mechanism 1503 can be selected from the group consisting of “Set C.”

In an example, a modular electromagnetic energy sensor can be used in combination with a modular electromagnetic energy emitter. In an example, a modular electromagnetic energy sensor can measure changes in the voltage, conductivity, resistance, capacitance and/or impedance of electromagnetic energy from an energy emitter which is transmitted through body fluid and/or tissue. In an example, body fluids and/or tissues with different levels of glucose have different patterns of electromagnetic energy transmission. In an example, data concerning these changes in voltage, conductivity, resistance, capacitance and/or impedance can be analyzed to measure the glucose level of body fluid and/or tissue. In an example, data from multiple modular electromagnetic energy sensors at different locations on an article of clothing can be jointly analyzed to provide more accurate measurement of glucose level than is possible with data from a single sensor at a single location.

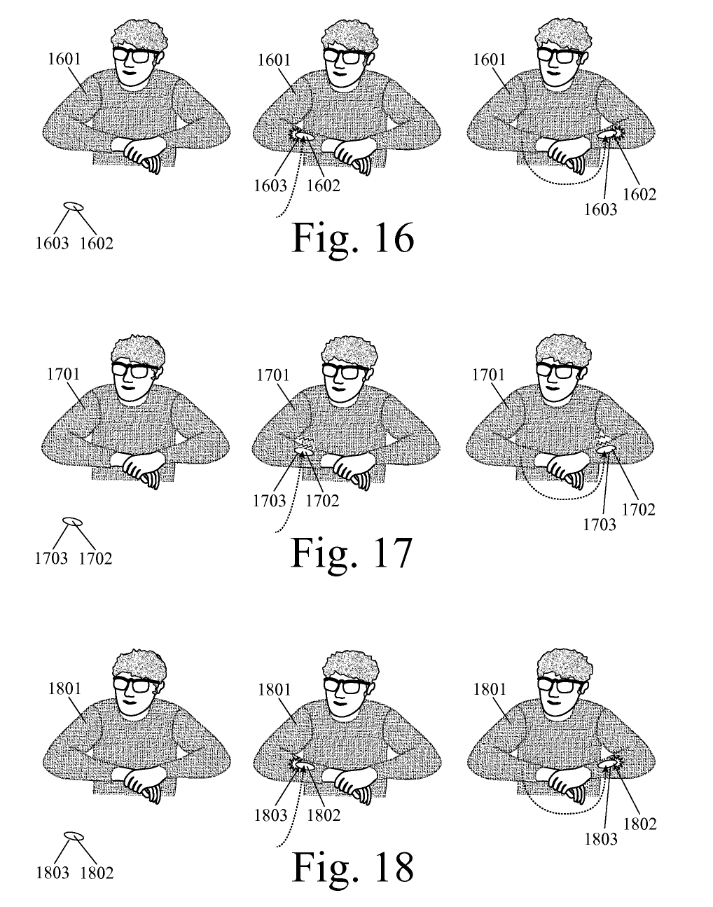

FIG. 16 shows an example of how this invention can be embodied in a system of modular smart clothing (or a modular clothing accessory) for monitoring glucose comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 16, clothing (or an accessory) can be selected from the group consisting of “Set A.” In this figure, article of clothing 1601 is a shirt. In other examples, this component can be a wrist band, a finger ring, or an ear ring. In FIG. 16, energy-transducing member 1602 is selected from the group consisting of “Set B.” In this figure, energy-transducing member 1602 is a modular light energy sensor whose data is used to measure the glucose level of body fluid and/or tissue. In FIG. 16, attachment mechanism 1603 can be selected from the group consisting of “Set C.”

In an example, a modular light energy sensor can collect data concerning changes in the intensity, color, spectrum, polarity, and/or phase of light energy which is reflected from, or transmitted through, body fluid and/or tissue. In an example, this data can be used to measure the level or concentration of glucose in body fluid and/or tissue. In an example, a modular light energy sensor can be used in combination with a modular light energy emitter. In an example, the light energy can be visible light, infrared light, and/or ultraviolet light. In an example, this light energy can be coherent light from a laser.

In an example, a modular light energy sensor can be a non-invasive optical glucose monitor. In an example, a modular light energy sensor can be a spectroscopic non-invasive optical glucose monitor. In an example, a modular light energy sensor can be selected from the group consisting of: light-spectrum-analyzing sensor, spectral analysis sensor, spectrometry sensor, spectrophotometer sensor, spectroscopic sensor, spectroscopy sensor, mass spectrometry sensor, Raman spectroscopy sensor, white light spectroscopy sensor, near-infrared spectroscopy sensor, infrared spectroscopy sensor, ultraviolet spectroscopy sensor, backscattering spectrometry sensor, ion mobility spectroscopic sensor, infrared light sensor, laser sensor, ultraviolet light sensor, fluorescence sensor, chemiluminescence sensor, color sensor, chromatography sensor, analytical chromatography sensor, gas chromatography sensor, optoelectronic sensor, photoelectric sensor, light polarity sensor, and light intensity sensor.

In an example, joint analysis of data from multiple light energy sensors at different locations on an article of clothing can provide more accurate measurement of glucose level than data from a single light energy sensor at a single location. In an example, a person can removably attach multiple modular light energy emitters and multiple modular light energy sensors at different locations on one or more articles of clothing in order to create a customized set of smart clothing which optimally measures the person's glucose level.

FIG. 17 shows an example of how this invention can be embodied in a system of modular smart clothing (or a modular clothing accessory) for monitoring glucose comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 17, clothing can be selected from the group consisting of “Set A.” In this figure, article of clothing 1701 is a shirt. In FIG. 17, the energy-transducing member can be selected from the group consisting of “Set B.” In this figure, energy-transducing member 1702 is a modular tactile-sensation-creating member that creates a tactile sensation in response to detection of a selected glucose level in body fluid and/or tissue. In FIG. 17, attachment mechanism 1703 can be selected from the group consisting of “Set C.”

In an example, a modular tactile-sensation-creating member is in contact with a person's skin and creates a tactile sensation by vibrating. In an example, a modular tactile-sensation-creating member can be piezoelectric. In an example, a modular tactile-sensation-creating member can comprise one or more microscale actuators. In an example, a modular tactile-sensation-creating member comprises one or more cyclically-moving protrusions which are in contact with a person's skin and create a tactile sensation by moving in a rotational, up-and-down, or back-and-forth manner. In an example, the intensity, frequency, or pattern of movement depends on the level of glucose detected in body fluid and/or tissue. In an example, a tactile sensation can prompt a person to modify their food consumption in real time.

FIG. 18 shows an example of how this invention can be embodied in a system of modular smart clothing (or a modular clothing accessory) for monitoring oxygen level comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 18, clothing (or an accessory) can be selected from the group consisting of “Set A.” In this figure, article of clothing 1801 is a shirt. In an example, this component can comprise a wrist band, finger ring or finger attachment, or ear ring or other ear attachment. In FIG. 18, the energy-transducing member can be selected from the group consisting of “Set B.” In this figure, energy-transducing member 1802 is a modular light energy sensor whose data is used to measure the oxygen level of body fluid and/or tissue. In FIG. 18, attachment mechanism 1803 can be selected from the group consisting of “Set C.”

In an example, a modular light energy sensor can be used in combination with a modular light energy emitter. In an example, a modular light energy sensor can measure changes in the intensity, color, spectrum, polarity, or phase of light energy passing through, or reflected from, body fluid and/or tissue. In an example, a modular light energy sensor can measure changes in light energy emitted by a light energy sensor which passes through, or is reflected from, body fluid and/or tissue. In an example, this light energy can be visible light, infrared light, or ultraviolet light. In an example, this light energy can be coherent light from a laser.

In an example, changes in the glucose level of body fluid and/or tissue cause changes in the manner in which light is transmitted through the body fluid and/or tissue. The changes in light transmission can be measured by a modular light energy sensor and used to determine glucose level. In an example, a modular light energy sensor can be selected from the group consisting of: optical oximeter, oxygen saturation sensor, blood oximeter, pulse oximeter, oximetry sensor, cutaneous oxygen (PCO2) monitor, optical sensor, optoelectronic sensor, photoelectric sensor, light intensity sensor, light-spectrum-analyzing sensor, spectral analysis sensor, spectrometry sensor, spectrophotometer sensor, spectroscopic sensor, spectroscopy sensor, mass spectrometry sensor, Raman spectroscopy sensor, white light spectroscopy sensor, near-infrared spectroscopy sensor, infrared spectroscopy sensor, ultraviolet spectroscopy sensor, backscattering spectrometry sensor, ion mobility spectroscopic sensor, infrared light sensor, laser sensor, ultraviolet light sensor, fluorescence sensor, chemiluminescence sensor, color sensor, chromatography sensor, analytical chromatography sensor, and gas chromatography sensor.

In an example, joint analysis of data from modular light sensors at different locations on an article of clothing can provide more accurate estimation of systemic glucose level than data from a sensor at a single location. In an example, a person can removably attach multiple pairs of modular light emitters and modular light sensors to different locations on one or more articles of clothing in order to create a customized set of smart clothing for optimal measurement of glucose level in body fluid and/or tissue.

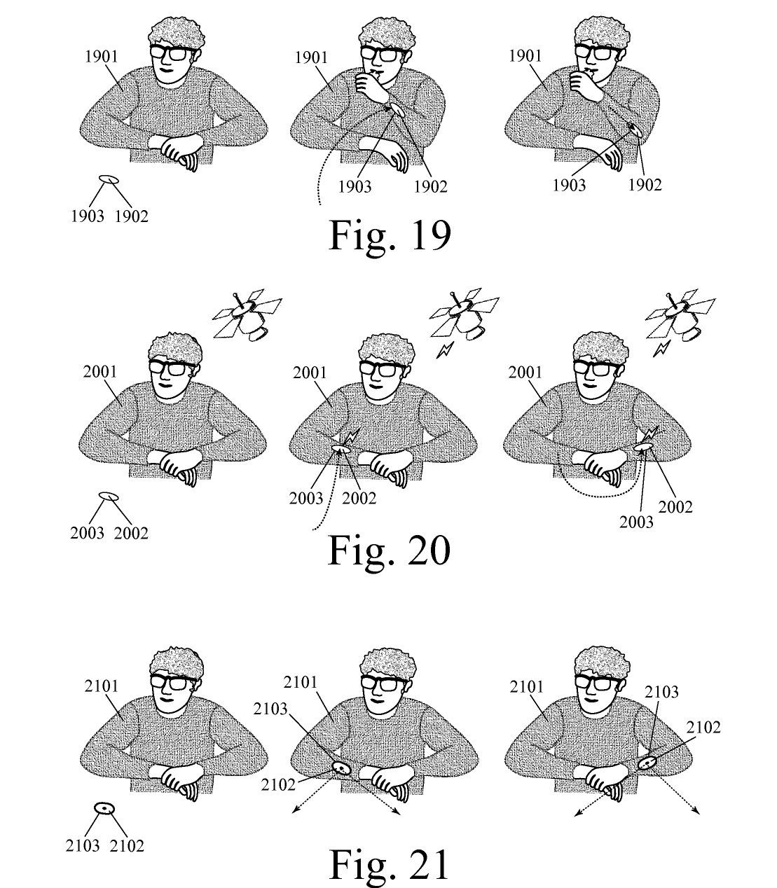

FIG. 19 shows an example of how this invention can be embodied in a system of modular smart clothing (or a modular clothing accessory) for monitoring food consumption comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 19, clothing (or an accessory) can be selected from the group consisting of “Set A.” In this figure, article of clothing 1901 is a shirt. In another example, this component can comprise a wrist band, arm band, or necklace. In FIG. 19, the energy-transducing member can be selected from the group consisting of “Set B.” In this figure, energy-transducing member 1902 is a modular motion sensor whose data is used to detect, monitor, and/or measure a person's consumption of different types and quantities of food, ingredients, and/or nutrients. In FIG. 19, attachment mechanism 1903 can be selected from the group consisting of “Set C.”

In an example, a modular motion sensor can be an accelerometer, gyroscope, or inclinometer. In an example, a specific pattern of hand and/or arm motions indicates that the person is probably eating. In an example, a specific pattern of mouth motions indicates that the person is probably eating. In an example, consumption of different types of food causes different patterns of hand, arm, and/or mouth motions which can be detected by a modular motion sensor. In an example, detection of a pattern of body motion which indicates probable food consumption can trigger activation of a different type of sensor to better measure specific types of food, ingredients, and/or nutrients. In an example, detection of a pattern of body motion which indicates probable food consumption can trigger the system to query the person to collect more data concerning specific types and quantities of food consumed.

In an example, a modular motion sensor can be part of a system to detect and/measure consumption of one or more selected types of food, ingredients, and/or nutrients. In an example, the one or more selected types of food, ingredients, and/or nutrients can be selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds; high-carbohydrate food, high-sugar food, high-fat food, fried food, high-cholesterol food, high-protein food, high-fiber food, and high-sodium food.

FIG. 20 shows an example of how this invention can be embodied in a system of modular smart clothing (or a modular clothing accessory) for wireless communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 20, clothing can be selected from the group consisting of “Set A.” In this figure, article of clothing 2001 is a shirt. In FIG. 20, the energy-transducing member can be selected from the group consisting of “Set B.” In this figure, energy-transducing member 2002 is a modular wireless communication device. In FIG. 20, attachment mechanism 2003 can be selected from the group consisting of “Set C.”

In an example, a modular wireless communication device can independently send and/or receive phone calls, text messages, video streams, or other forms of interpersonal communication. In an example, a modular wireless communication device can relay incoming phone calls, text messages, video streams, or other forms of interpersonal communication from a separate wireless communication device. In an example, a modular wireless communication device can provide notifications of messages received by a separate communication device.

In an example, a modular wireless communication device can be in wireless communication with one or more other devices selected from the group consisting of: a communication tower or satellite; an internet server; a home appliance or home environmental control system; a laptop or desktop computer; a smart phone or other mobile communication device; a cardiac monitor; an electromagnetic brain activity monitor; a pulmonary activity monitor; a CPAP device; an implantable medical device; electronically-functional eyewear; and a smart watch. In an example, a modular wireless communication device can have a visual, sound-based, or tactile user interface. In an example, a modular wireless communication device can have a textile-based user interface which is integrated into an article of clothing.

FIG. 21 shows an example of how this invention can be embodied in a system of modular smart clothing (or a modular clothing accessory) for documenting events comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 21, clothing can be selected from the group consisting of “Set A.” In this figure, article of clothing 2101 is a shirt. In FIG. 21, the energy-transducing member can be selected from the group consisting of “Set B.” In this figure, energy-transducing member 2102 is a modular continuously-recording short-term-memory device. In FIG. 21, attachment mechanism 2103 can be selected from the group consisting of “Set C.”

In an example, a modular continuously-recording short-term-memory device can continuously record images and/or sounds in short-term memory, but these images and/or sounds are automatically erased after a period of time unless a selected event occurs which triggers their retention in long-term memory. In an example, the time interval for short-term memory can be less than an hour. In an example, the time interval for short-term memory can be less than a day. In an example, a modular continuously-recording short-term-memory device can continuously record video images and/or sounds in short-term memory for a selected time interval before these images and sounds are automatically erased, unless a selected event occurs which triggers the retention of these images and sounds in long-term memory. In an example, a recording device can be a wearable video camera and/or a wearable microphone.

In an example, this system can serve a purpose which is similar to a “black box” recorder in an aircraft or a “video loop” in a security camera. In an example, this system can provide information on what happened before a selected event occurred. In an example, a selected event can be something negative, such as an adverse health event, accident, or crime. In an example, a selected event can be something positive or interesting, such as an interesting interaction with a person or object in the environment. In an example, only the person wearing the device or someone else to whom this person has directly granted access is able to access the recorded images and/or sounds.

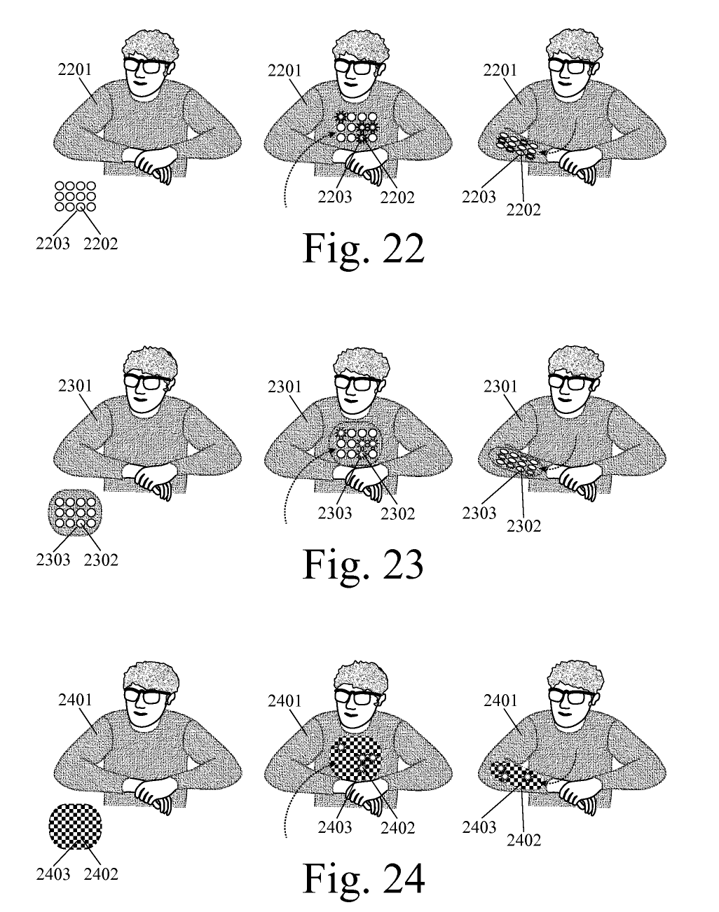

FIG. 22 shows an example of how this invention can be embodied in a system of modular smart clothing (or a modular clothing accessory) for displaying images comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 22, clothing can be selected from the group consisting of “Set A.” In this figure, article of clothing 2201 is a shirt. In FIG. 22, the energy-transducing member can be selected from the group consisting of “Set B.” In this figure, energy-transducing member is a modular image-displaying plurality of light-emitting members including 2202 whose light activations, light intensities, and/or light colors are changed to collectively display changing images. In FIG. 22, attachment mechanisms including 2203 can be selected from the group consisting of “Set C.”

In an example, a modular image-displaying plurality of light-emitting members can comprise an array or matrix of LEDs. In an example, a modular image-displaying plurality of light-emitting members can comprise an array or matrix of fiber optic members which are woven or otherwise integrated into an article of clothing. In an example, light activations, light intensities, and/or light colors of the members of such an array or matrix can be changed to collectively display changing images. In an example, a plurality of modular light-emitting members can function as a pixel array or matrix. In an example, a modular image-displaying plurality of light-emitting members can comprise a wearable computer display screen. In an example, this display screen can be curved and/or flexible. In an example, this display screen can be touch sensitive. In an example, a person can removably attach a plurality of modular light-emitting members to one or more locations on an article of clothing in order to create customized smart clothing for displaying changing images.

FIG. 23 shows an example of how this invention can be embodied in a system of modular smart clothing (or a modular clothing accessory) for displaying images comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 23, clothing can be selected from the group consisting of “Set A.” In this figure, article of clothing 2301 is a shirt. In FIG. 23, the energy-transducing member can be selected from the group consisting of “Set B.” In this figure, energy-transducing member is a modular, flexible, textile-based image-displaying plurality of light-emitting members including 2302 whose activations, light intensities, and/or light colors are changed to collectively display changing images. In FIG. 23, attachment mechanisms including 2303 can be selected from the group consisting of “Set C.”

In an example, a modular, flexible, textile-based image-displaying plurality of light-emitting members can be woven or otherwise integrated into the fabric of an article of clothing. In an example, changes in the intensity and/or color of light from these light-emitting members can create changing images on the surface of the article of clothing. In an example, a modular, flexible, textile-based image-displaying plurality of light-emitting members can comprise a wearable visual user interface. In an example, this user interface can also be touch sensitive. In an example, light-emitting members can be LEDs. In an example, light-emitting members can be optical fibers.

FIG. 24 shows an example of how this invention can be embodied in a system of modular smart clothing (or a modular clothing accessory) for displaying images comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 24, clothing can be selected from the group consisting of “Set A.” In this figure, article of clothing 2401 is a shirt. In FIG. 24, the energy-transducing member can be selected from the group consisting of “Set B.” In this figure, energy-transducing member 2402 is a modular flexible textile-based plurality of fiber optic members whose activations, light intensities, and/or light colors are changed to collectively display changing images. In FIG. 24, attachment mechanism 2403 can be selected from the group consisting of “Set C.”

In an example, a modular flexible textile-based plurality of fiber optic members can be woven or otherwise integrated into the fabric of an article of clothing. In an example, changes in the activation, light intensity, and/or light color of these members create changing visual images. In an example, this system comprises a wearable, textile-based visual user interface. In an example, fiber optic members can be elastic. In an example, the ends of optical fibers can display an array of pixels of light on the surface of an article of clothing. In an example, this surface can also be touch sensitive. In an example this sensitivity to touch can be based on the occlusion and/or reflection of light energy by a person's finger and/or hand.

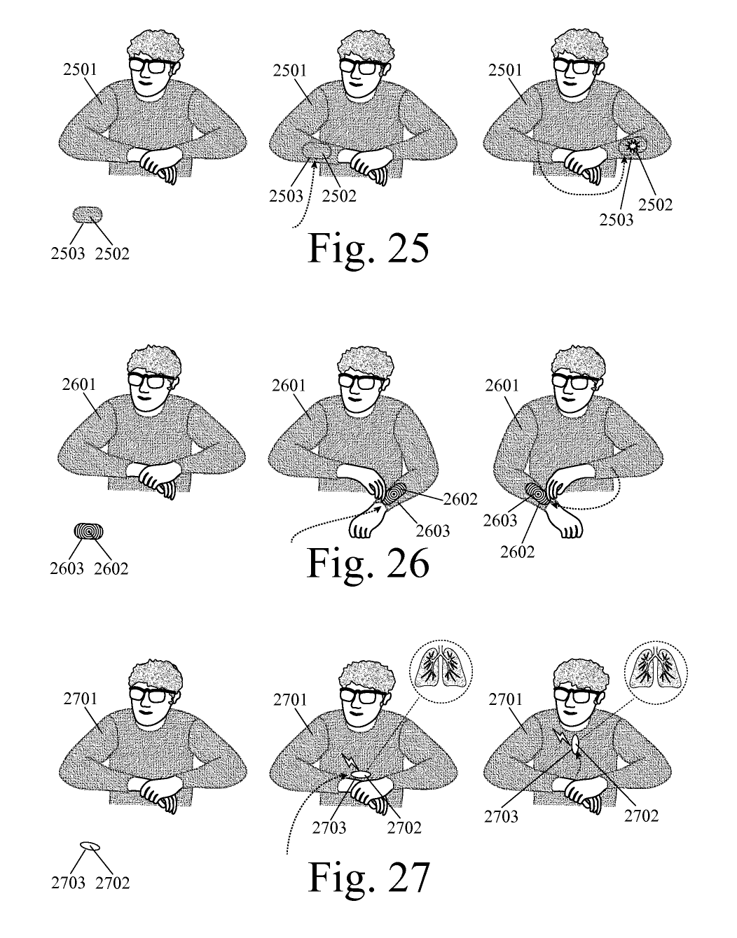

FIG. 25 shows an example of how this invention can be embodied in a system of modular smart clothing (or a modular clothing accessory) for displaying images comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 25, clothing can be selected from the group consisting of “Set A.” In this figure, article of clothing 2501 is a shirt. In FIG. 25, the energy-transducing member can be selected from the group consisting of “Set B.” In this figure, energy-transducing member 2502 is a modular camouflaged wearable image-display device, wherein this device is not visually differentiated from the rest of the surface of an article of clothing until the device is activated to display an image. In FIG. 25, attachment mechanism 2503 can be selected from the group consisting of “Set C.”

In an example, a modular camouflaged wearable image-display device can have a default surface appearance which blends in with the fabric of the article of clothing such that it is not visually differentiated from the rest of the clothing surface until the device is activated to display an image. In an example, a modular camouflaged wearable image-display device can be covered with a fabric layer which becomes transparent when the device is activated to display an image. In an example, a modular camouflaged wearable image-display device can be covered with a fabric layer which is sufficiently translucent that an image from the device shines through the fabric when the device is activated to display an image.

FIG. 26 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 26, clothing can be selected from the group consisting of “Set A.” In this figure, article of clothing 2601 is a shirt. In FIG. 26, the energy-transducing member can be selected from the group consisting of “Set B.” In this figure, energy-transducing member 2602 is a modular touch-based and/or gesture-based human-to-computer textile interface. In FIG. 26, attachment mechanism 2603 can be selected from the group consisting of “Set C.”

In an example, a modular touch-based and/or gesture-based human-to-computer textile interface can detect the pressure of a human finger on its surface via an array of pressure sensors. In an example, a modular touch-based and/or gesture-based human-to-computer textile interface can detect the touch of a human finger on its surface via an array of electromagnetic energy sensors. In an example, a modular touch-based and/or gesture-based human-to-computer textile interface can detect the movement of a human finger on its surface or in proximity to its surface via an array of light energy emitters and sensors. In an example, this array of light energy emitters and sensors uses infrared light.

In an example, a modular touch-based and/or gesture-based human-to-computer textile interface can comprise an array or mesh of pressure sensors, electromagnetic sensors, or optical sensors which are woven or otherwise integrated into the fabric of an article of clothing to transduce human movement into computer inputs. In an example, a modular human-to-computer textile interface can be configured to flexibly conform to a portion of the circumference of a person's arm, hand, leg, or torso.

FIG. 27 shows an example of how this invention can be embodied in a system of modular smart clothing (or a modular clothing accessory) for monitoring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 27, clothing can be selected from the group consisting of “Set A.” In this figure, article of clothing 2701 is a shirt. In FIG. 27, the energy-transducing member can be selected from the group consisting of “Set B.” In this figure, energy-transducing member 2702 is a modular electromagnetic energy sensor whose data is used to monitor and/or measure pulmonary and/or respiratory function. In FIG. 27, attachment mechanism 2703 can be selected from the group consisting of “Set C.”

In an example, a modular electromagnetic energy sensor can measure the voltage, conductivity, resistance, capacitance and/or impedance of electromagnetic energy transmitted through a portion of an article of clothing in proximity to a person's chest. In an example, the expansion and contraction of a person's chest during respiration changes the shape of electroconductive fibers or layers in an article of clothing. These changes in shape of electroconductive fibers or layers change the transmission of electromagnetic energy through these fibers or layers. Changes in the transmission of electromagnetic energy through these fibers or layers can then be used to collect data concerning the person's pulmonary and/or respiratory function. In an example, these fibers or layers can be piezoelectric fibers or layers. In an example, a modular electromagnetic energy sensor can measure electromagnetic energy which is generated by piezoelectric members in an article of clothing, wherein these piezoelectric members generate electromagnetic energy when they are moved by pulmonary and/or respiratory function.

In an example, a modular electromagnetic energy sensor can measure electromagnetic energy which is naturally generated by body tissue in connection with pulmonary and/or respiratory function. In an example, an electromagnetic energy sensor can measure electromagnetic energy which is naturally generated by the muscles and/or efferent nerves involved in respiration. In an example, an electromagnetic energy sensor can be used in combination with an electromagnetic energy emitter. In an example, a modular electromagnetic energy sensor can measure the voltage, conductivity, resistance, capacitance and/or impedance of electromagnetic energy which is transmitted from an energy emitter through body fluid and/or tissue.

In an example, data from an electromagnetic energy sensor can be used to measure parameters of the person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

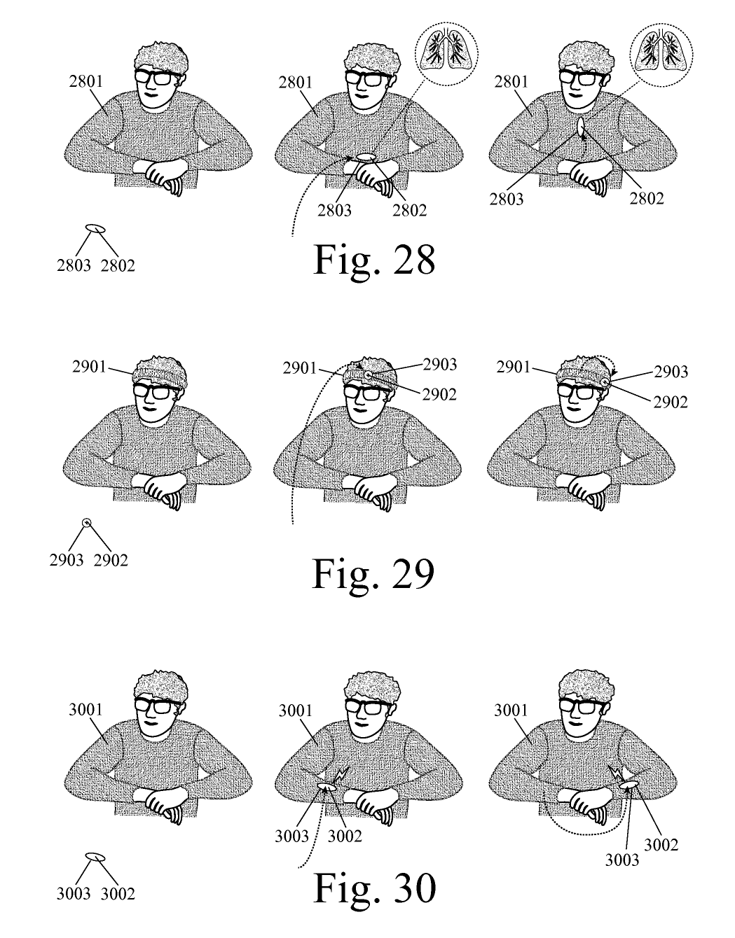

FIG. 28 shows an example of how this invention can be embodied in a system of modular smart clothing (or a modular clothing accessory) for monitoring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 28, clothing can be selected from the group consisting of “Set A.” In this figure, article of clothing 2801 is a shirt. In FIG. 28, the energy-transducing member can be selected from the group consisting of “Set B.” In this figure, energy-transducing member 2802 is a modular motion sensor whose data is used to measure pulmonary and/or respiratory function. FIG. 28, attachment mechanism 2803 can be selected from the group consisting of “Set C.”

In an example, a modular motion sensor can be an accelerometer, gyroscope, or inclinometer. In an example, a modular motion sensor can be attached to a portion of an article of clothing that is moved by a person's respiration. In an example, the motion sensor can measure cyclical chest motion caused by respiration. In an example, Fourier transformation methods can be used to isolate cyclical chest motion associated with respiration versus other causes of chest motion. In an example, a person can removably attach a plurality of motion sensors to different places on a an upper-body article of clothing in order to create customized smart clothing that optimally measures their respiratory function.

In an example, data from a modular motion sensor can be used to measure parameters of the person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

FIG. 29 shows an example of how this invention can be embodied in a system of modular smart clothing (or a modular clothing accessory) for monitoring brain activity comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 29, clothing (or an accessory) can be selected from the group consisting of “Set A.” In this figure, article of clothing (or clothing accessory) 2901 is an electronically-functional headband. In another example, this component can comprise electronically-functional eyewear. In another example, this component can comprise an electronically-functional hat or cap. In FIG. 29, the energy-transducing member can be selected from the group consisting of “Set B.” In this figure, energy-transducing member 2902 is a modular electromagnetic energy sensor whose data is used to measure electromagnetic brain activity. In FIG. 29, attachment mechanism 2903 can be selected from the group consisting of “Set C.”

In an example, a modular electromagnetic energy sensor can measure changes in the voltage, conductivity, resistance, capacitance and/or impedance of electromagnetic energy that is transmitted from an electromagnetic energy emitter through a portion of a person's head. In an example, a modular electromagnetic energy sensor can be an ElectroEncephaloGraphy (EEG) sensor and/or monitor. In an example, a modular electromagnetic energy sensor can be a dry electrode. In an example, a modular electromagnetic energy sensor can measure electromagnetic energy patterns that are naturally generated by brain activity. In an example, electromagnetic energy that is naturally generated by brain activity can cause electromagnetic currents in a head-worn device by induction and these currents can be measured by an electromagnetic energy sensor.

In an example, data from a modular electromagnetic energy sensor on a person's head can be analyzed using Fourier transformation to identify repeating energy patterns in clinical frequency bands—such as the Delta, Theta, Alpha, Beta, and Gamma bands. In an example, the relative and combinatorial power levels of energy in different clinical frequency bands can be analyzed. In an example, a person can receive feedback based on analysis of this data concerning their electromagnetic brain activity. In an example, a person can control a computer or other device by changing their patterns of electromagnetic brain activity. In an example, a person's cerebral oximetry can be monitored based on this data.

In an example, data from multiple modular electromagnetic energy sensors can provide more comprehensive and/or accurate data concerning a person's electromagnetic brain activity than data from a single electromagnetic energy sensor. In an example, a person can removably attach a plurality of modular electromagnetic energy sensors to different places on a headband or electronically-functional eyewear in order to create a customized device to optimally measure their electromagnetic brain activity. In an example, multiple modular electromagnetic energy sensors can be configured to be a located at sites selected from the group consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2.

FIG. 30 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 30, clothing can be selected from the group consisting of “Set A.” In this figure, article of clothing 3001 is a shirt. In FIG. 30, the energy-transducing member can be selected from the group consisting of “Set B.” In this figure, energy-transducing member 3002 is a modular electromagnetic energy sensor which measures natural electromagnetic energy emissions from muscles and/or efferent nerves during body motion. In FIG. 30, attachment mechanism 3003 can be selected from the group consisting of “Set C.”

In an example, a modular electromagnetic energy sensor can be an EMG sensor. In an example, a modular electromagnetic energy sensor can measure electromagnetic energy which is naturally generated and/or transmitted by muscles and/or efferent nerves during muscle activation. In an example, this electromagnetic energy can be measured directly by contact with a person's body. In an example, this electromagnetic energy can be measured indirectly by measuring electromagnetic currents which are created in an article of clothing by induction. In an example, a modular electromagnetic energy sensor can measure changes in the voltage, conductivity, resistance, capacitance and/or impedance of electromagnetic energy which is transmitted through body tissue, wherein these changes are due to muscle activation. In an example, a modular electromagnetic energy sensor can be a neural impulse sensor. In an example, data from a modular electromagnetic energy sensor can be analyzed to measure body motion, configuration, posture, and/or gestures.

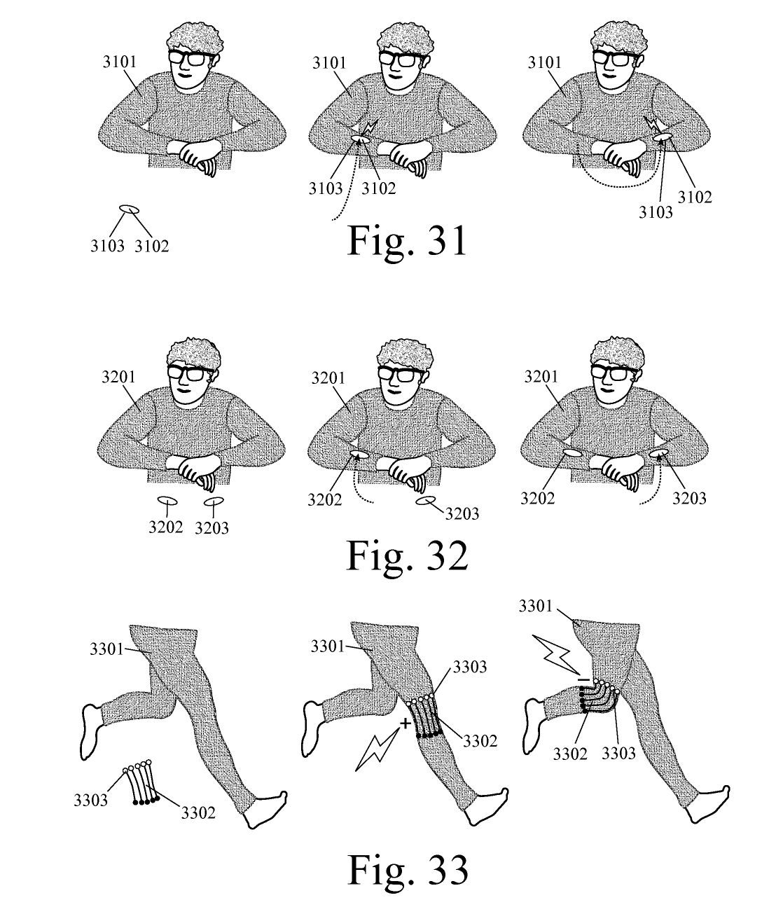

FIG. 31 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 31, clothing can be selected from the group consisting of “Set A.” In this figure, article of clothing 3101 is a shirt. In FIG. 31, the energy-transducing member can be selected from the group consisting of “Set B.” In this figure, energy-transducing member 3102 is a modular electromagnetic energy sensor which measures electromagnetic energy in an article of clothing which is generated by induction when the person moves. In FIG. 31, attachment mechanism 3103 can be selected from the group consisting of “Set C.”

In an example, muscles and/or efferent nerves in a person's body naturally generates electromagnetic signals when muscles are activated. In an example, these electromagnetic signals can induce electromagnetic patterns in energy pathways in clothing which are worn near the muscles and/or efferent nerves. In an example, a modular electromagnetic energy sensor can measure these electromagnetic patterns in clothing which are caused by induction when a person moves. In an example, these electromagnetic patterns can be used to model a person's body motion, configuration, posture, and/or gestures. In an example, a person can removably attach a plurality of modular electromagnetic energy sensors to different places on an article of clothing in order to create customized smart clothing for individualized motion capture.

FIG. 32 shows an example of how this invention can be embodied in a system of modular smart clothing (or a modular clothing accessory) comprising: an article of clothing (or clothing accessory) worn by a person; a first type of modular energy-transducing member; and a second type of modular energy-transducing member, wherein this system has a first configuration in which neither the first type nor the second type of modular energy-transducing member is attached to the article of clothing (or clothing accessory), a second configuration in which only the first type of modular energy-transducing member is removably attached by the person to the clothing (or clothing accessory), a third configuration in which only the second type of modular energy-transducing member is removably attached by the person to the clothing (or clothing accessory), and a fourth configuration in which both the first and second types of modular energy-transducing members are removably attached by the person to the clothing (or clothing accessory). The left side of this figure shows the first configuration, the middle shows the second configuration, and the right side shows the fourth configuration.

In FIG. 32, clothing can be selected from the group consisting of “Set A.” In this figure, article of clothing 3201 is a shirt. In FIG. 32, both the first energy-transducing member 3202 and the second energy-transducing member 3203 are selected from the group consisting of “Set B.” In this example, the first type and the second type are different types of energy-transducing members which are selected from “Set B.”

FIG. 33 shows an example of how this invention can be embodied in a system of modular smart clothing (or a modular clothing accessory) for transducing power comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory).

In FIG. 33, clothing can be selected from the group consisting of “Set A.” In this figure, article of clothing 3301 is a pair of pants. In FIG. 33, the energy-transducing member can be selected from the group consisting of “Set B.” In this figure, energy-transducing member 3302 is a modular, wearable, cyclical, kinetic energy harvesting and releasing member. In FIG. 33, attachment mechanism 3303 can be selected from the group consisting of “Set C.”

In an example, a modular, wearable, cyclical, kinetic energy harvesting and releasing member harvests kinetic energy during a first phase of a cyclical body motion and releases kinetic energy during a second phase of this cyclical body motion. In an example, this member transduces kinetic energy into a non-kinetic energy during a first phase of this cyclical body motion and then transduces this non-kinetic energy back into kinetic energy during a second phase of a cyclical body motion. In an example, the non-kinetic form of energy can be selected from the group consisting of: electromagnetic energy; pneumatic energy; hydraulic energy; compression of a compressible member; expansion of an expandable member; and biochemical energy.

In an example, a modular, wearable, cyclical, kinetic energy harvesting and releasing member can harvest kinetic energy during a first phase of walking (or running) and can release kinetic energy during a second phase of walking (or running) In an example, there can be two such members, one on each of a person's legs or feet. In an example, the first phase occurs when a person's leg or foot is in front of their body centroid and the second phase occurs when the person's leg or foot is behind their body centroid. In an example, the first phase occurs when the person's leg or foot is offering resistance to forward motion and the second phase occurs when the person's leg or foot is providing force to propel forward motion. In an example, kinetic energy can be transduced into electromagnetic, pneumatic, or hydraulic energy during a first phase of a cyclical body motion and then this energy is transduced back into kinetic energy during a second phase of the cyclical body motion.

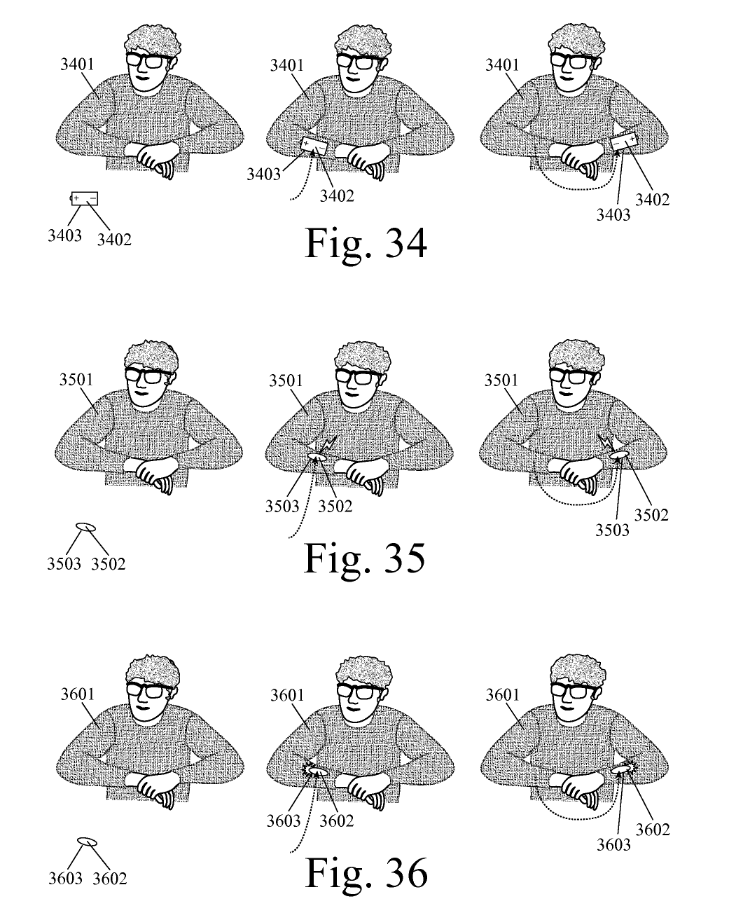

FIG. 34 shows an example of how this invention can be embodied in a system of modular smart clothing (or a modular clothing accessory) for supplying energy comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 34, clothing can be selected from the group consisting of “Set A.” In this figure, article of clothing 3401 is a shirt. In FIG. 34, the energy-transducing member can be selected from the group consisting of “Set B.” In this figure, energy-transducing member 3402 is a modular power source. In an example, this power source is a battery that provides electrical energy. In an example, this power source transduces kinetic energy, thermal energy, ambient light energy, biochemical energy, and/or ambient electromagnetic energy into electrical power. In an example, this power source and/or energy transducer is piezoelectric. In an example, this power source and/or energy transducer is hydraulic. In an example, an energy transducer comprises generation of electrical power from hydraulic flow, wherein this hydraulic flow is caused by body motion. In FIG. 34, attachment mechanism 3403 can be selected from the group consisting of “Set C.”

FIG. 35 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 35, clothing can be selected from the group consisting of “Set A.” In this figure, article of clothing 3501 is a shirt. In FIG. 35, the energy-transducing member can be selected from the group consisting of “Set B.” In this figure, energy-transducing member 3502 is a modular neural impulse sensor which collects data concerning electromagnetic energy patterns emitted by the efferent nervous system in order to identify body motion, configuration, posture, and/or gestures. In FIG. 35, attachment mechanism 3503 can be selected from the group consisting of “Set C.”

In an example, a modular neural impulse sensor is in contact with a person's skin in order to measure electromagnetic energy patterns from efferent nerves during muscle activation. In an example, these electromagnetic energy patterns can be used to measure changes in body configuration and/or gestures. In an example, these electromagnetic energy patterns can be used for ambulatory, full-body motion capture. In an example, neural impulses can induce electromagnetic patterns in electroconductive fibers in nearby portions of clothing and these electromagnetic patterns can be used to measure changes in body configuration and/or gestures.

FIG. 36 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 36, clothing can be selected from the group consisting of “Set A.” In this figure, article of clothing 3601 is a shirt. In FIG. 36, the energy-transducing member can be selected from the group consisting of “Set B.” In this figure, energy-transducing member 3602 is a modular light-energy sensor whose data is used to measure body motion, configuration, posture, and/or gestures. In FIG. 36, attachment mechanism 3603 can be selected from the group consisting of “Set C.”

In an example, a modular light-energy sensor can be used in combination with a modular light-emitting member. In an example, a modular light-energy sensor can measure changes in the transmission of light energy through optical fibers and/or channels which are woven or otherwise integrated into an article of clothing, wherein these changes are caused by the person's movement. In an example, changes in a person's body configuration, posture, and/or gestures change the intensity, amplitude, frequency, spectrum, polarity, phase, and/or waveform of light transmitted through optical fibers and/or channels in an article of clothing (or clothing accessory). In an example, an optical fiber or channel can be a variable-translucence light guide. In an example, an optical fiber or channel can be comprised of nanoscale/microscale metamaterials. In an example, a modular light energy sensor can be used in combination with a light-transmitting textile or fabric. In an example, the light energy can be visible light, infrared light, and/or ultraviolet light. In an example, the light energy can be coherent light from a laser.

In an example, a modular light-energy sensor can be selected from the group consisting of: optical sensor, optoelectronic sensor, photoelectric sensor, light intensity sensor, light-spectrum-analyzing sensor, spectral analysis sensor, spectrometry sensor, spectrophotometer sensor, spectroscopic sensor, spectroscopy sensor, mass spectrometry sensor, Raman spectroscopy sensor, white light spectroscopy sensor, near-infrared spectroscopy sensor, infrared spectroscopy sensor, ultraviolet spectroscopy sensor, ion mobility spectroscopic sensor, infrared light sensor, laser sensor, ultraviolet light sensor, fluorescence sensor, chemiluminescence sensor, color sensor, chromatography sensor, analytical chromatography sensor, and variable-translucence sensor.

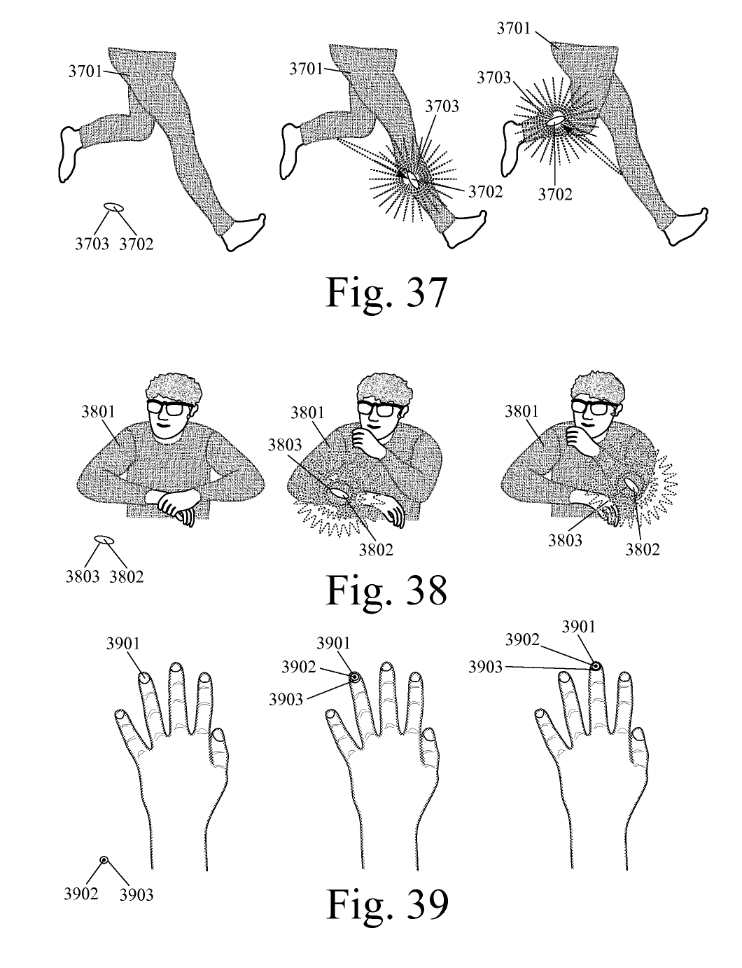

FIG. 37 shows an example of how this invention can be embodied in a system of modular smart clothing (or a modular clothing accessory) for measuring stride distance comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 37, clothing (or an accessory) can be selected from the group consisting of “Set A.” In this figure, article of clothing 3701 is a pair of pants. In another example, this component can comprise a sock, shoe, or other footwear. In FIG. 37, the energy-transducing member can be selected from the group consisting of “Set B.” In this figure, energy-transducing member 3702 is a modular light-sensing member that measures changes in the distance between a person's legs or feet in order to estimate the person's stride distance. In FIG. 37, attachment mechanism 3703 can be selected from the group consisting of “Set C.”

In an example, a modular light-sensing member on a person's leg, ankle, or foot can measure the distance between the person's legs, ankles, or feet in order to measure their stride distance and/or pace. In an example, a modular light-sensing member on a person's leg, ankle, or foot can be used in combination with a modular light-emitting member on the person's leg, ankle, or foot to measure the distance between the person's legs, ankles, or feet in order to measure their stride distance or pace. In an example, a light sensing member and a light emitting member can both be on the same leg, ankle, or foot. In an example, a light sensing member and a light emitting member can be on different legs, ankles, or feet. In an example, the light energy can be infrared, visible, or ultraviolet. In an example, the light energy can be coherent.

FIG. 38 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 38, clothing can be selected from the group consisting of “Set A.” In this figure, article of clothing 3801 is a shirt. In FIG. 38, the energy-transducing member can be selected from the group consisting of “Set B.” In this figure, energy-transducing member 3802 is a modular sound-emitting member whose actuation, intensity, frequency, and/or pattern of sound emissions is based on the person's body motion, configuration, posture, and/or gestures. In FIG. 38, attachment mechanism 3803 can be selected from the group consisting of “Set C.”

In an example, a modular sound-emitting member can comprise a speaker and/or sound generator. In an example, a modular sound-emitting member can be used in combination with a wearable motion sensor. In an example, selected patterns of body motion, configuration, posture, and/or gestures which are detected by the motion sensor can trigger selected sound patterns from the modular sound-emitting member. In an example, specific body motions can trigger specific tones or changes in sound frequency. In an example, specific body motions can trigger specific songs or musical segments. In an example, movement of different body members can trigger different types of sounds. In an example, movement of different body members can trigger sounds with different tones and/or samples from different musical instruments.

In an example, a modular sound-emitting member can be used for entertainment and/or art applications, such as creating sound patterns or musical segments from motion patterns such as dancing. In an example, a modular sound-emitting member can be used for sports training purposes, guiding the wearer to more effective motion patterns for sports training by variation in sound volume, frequency, and/or waveform. In an example, changes in sound volume, frequency, and/or waveform can guide a person to perform a desired 3D sequence of body motion, configuration, and/or posture for sports or other applications. In an example, when a person moves their body in accordance with a desired 3D motion sequence, then a first set of (affirming) sounds is emitted, but when the person moves their body out of accordance with the desired 3D motion sequence, then a second set of (non-affirming) sounds is emitted. In an example, performance of the proper 3D motion sequence can trigger virtual applause and performance of the improper 3D motion sequence can trigger virtual hissing.

FIG. 39 shows an example of how this invention can be embodied in a system of modular smart clothing (or a modular clothing accessory) for gesture capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 39, clothing (or an accessory) can be selected from the group consisting of “Set A.” In this figure, clothing accessory 3901 comprises an artificial finger nail or other finger tip attachment. In another example, this component can comprise a finger ring. In FIG. 39, the energy-transducing member can be selected from the group consisting of “Set B.” In this figure, energy-transducing member 3902 is a modular motion sensor whose data is used to identify hand gestures. In FIG. 39, attachment mechanism 3903 can be selected from the group consisting of “Set C.”

In an example, a modular motion sensor can be an accelerometer, gyroscope, or inclinometer which is attached to a finger ring, artificial finger nail, or other finger-attached accessory. In an example, data from a plurality of motion sensors attached to a plurality of finger rings or finger nails can be used in combination to identify hand gestures. In an example, these hand gestures can be used to control a computer or other device. In an example, these hand gestures can be used for communication. In an example, these hand gestures can constitute sign language. In an example, this sign language can be translated into speech for real-time audio communication.

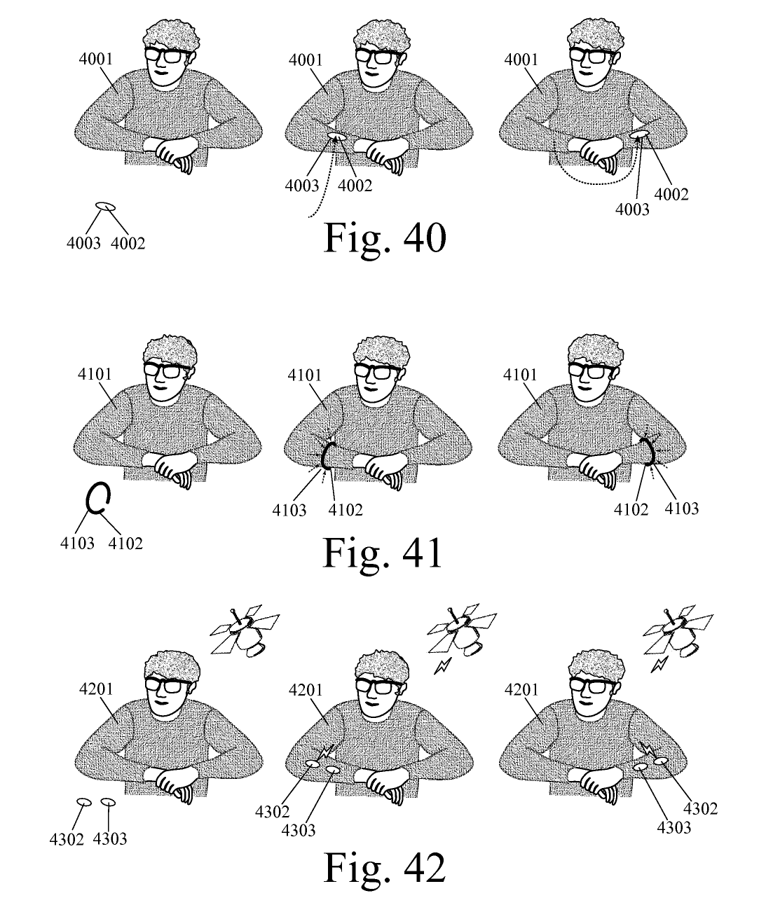

FIG. 40 shows an example of how this invention can be embodied in a system of modular smart clothing (or a modular clothing accessory) for motion capture comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 40, clothing can be selected from the group consisting of “Set A.” In this figure, article of clothing 4001 is a shirt. In FIG. 40, the energy-transducing member can be selected from the group consisting of “Set B.” In this figure, energy-transducing member 4002 is a modular motion sensor that can be removably attached by the person virtually anywhere on an article of clothing. In FIG. 40, attachment mechanism 4003 can be selected from the group consisting of “Set C.”

In an example, a modular motion sensor can be an accelerometer, gyroscope, or inclinometer. In an example, a modular motion sensor can be used to measure a person's body motion, configuration, posture, and/or gestures. In an example, a modular motion sensor can be attached to virtually any location on an article of clothing using a magnet, clip, snap, electronic connector, or hook-and-eye mechanism. In an example, a plurality of modular motion sensors can be used to measure substantially full-body three-dimensional motion, configuration, posture, and/or gestures. In an example, attachment of one or more modular motion sensors to an article of clothing can turn virtually any article of clothing into “smart clothing” for the purposes of motion capture. In an example, a person can removably attach multiple modular motion sensors to different locations on an article of clothing to create customized smart clothing with individualized motion capture capability.

FIG. 41 shows an example of how this invention can be embodied in a system of modular smart clothing (or a modular clothing accessory) with custom fitting comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 41, clothing can be selected from the group consisting of “Set A.” In this figure, article of clothing 4101 is a shirt. In FIG. 41, the energy-transducing member can be selected from the group consisting of “Set B.” In this figure, energy-transducing member 4102 is a modular variable-contraction textile member. In FIG. 41, attachment mechanism 4103 can be selected from the group consisting of “Set C.”

In an example, a modular variable-contraction textile member can have a first (expanded) configuration or a second (contracted) configuration, or vice versa. In an example, a modular variable-contraction textile member can be changed from the first configuration to the second configuration, or vice versa, by application of electromagnetic energy. In an example, a person can put on an article of clothing with one or more variable-contraction textile members when these members are in a first (expanded) configuration and can change the one or more variable-contraction textile members to a second (contracted) configuration after the article of clothing is on the person. In an example, a variable-contraction textile member can span a body member (such as a person's arm, torso, or leg) in a circumferential manner such that it fits more tightly around the body member in the second configuration than in the first configuration.

In an example, a modular variable-contraction textile member can be piezoelectric. In an example, a modular variable-contraction textile member can be hydraulic or pneumatic. In an example, a variable-contraction textile member can comprise a plurality of microscale actuators. In an example, a plurality of modular variable-contraction textile members can be automatically changed from a first (expanded) configuration to a second (contracted) configuration while a person wearing clothing engages in different activities. In an example, this invention can comprise smart, adjustable-fitting, clothing which can be more form-fitting and/or comfortable than normal clothing. Such smart clothing can have multiple advantages for fashion, comfort, sports, medical, and motion capture purposes. In an example, a person can removably attach multiple variable-contraction textile members to an article of clothing in order to create customized clothing that is specifically (and automatically) tailored for that person's body.

FIG. 42 shows an example of how this invention can be embodied in a system of modular smart clothing (or a modular clothing accessory) comprising: an article of clothing (or clothing accessory) worn by a person; a GPS module; and a motion sensor. The left side of FIG. 42 shows this example in a first configuration in which neither the GPS module nor the motion sensor are attached to clothing. The middle portion of FIG. 42 shows this example in a second configuration in which both the GPS module and the motion sensor are attached to clothing. In an example, this second configuration can be used for calibration purposes. The right side of FIG. 42 shows this example in a third configuration in which only the motion sensor is attached to clothing.

In FIG. 42, clothing can be selected from the group consisting of “Set A.” In this figure, article of clothing 4201 is a shirt. In this example, GPS module 4202 and motion sensor 4203 can be removably attached to the shirt by the person who is wearing the shirt. In an example, a motion sensor can be an accelerometer, gyroscope, or inclinometer. In an example, data concerning changes in a person's location (as measured by a GPS module) and data concerning the number of steps that the person takes (as measured by a motion sensor) can be analyzed together in order to measure the person's stride distance better than is possible with separate analysis of either type of data alone. In an example, this data can be analyzed using Fourier transformation methods to isolate cyclical stride motion versus other types of motion.

In an example, the combination of data concerning GPS-measured changes in location and motion-sensor-measured steps can be used to calculate a person's average stride distance. In an example, this combined data can be used to calculate a person's stride distance as a function of the person's speed, geographic location, and/or change in elevation. In an example, this combined data can be collected during a calibration period and then used for subsequent estimation of distance traveled as a function of steps taken. In an example, data concerning changes in a person's location (as measured by a GPS module) and the number of steps taken (as measured by a motion sensor) can be analyzed together in order to calculate the person's caloric expenditure more accurately than is possible with either GPS data or motion data alone.

In an example, a plurality of motion sensors attached to different places on an article of clothing can differentiate a person's walking or running motion versus other types of motion affecting the motion sensors. In an example, a person can removably attach a plurality of modular motion sensors to different locations on one or more articles of clothing in order to create a customized set of smart clothing for individualized motion capture.

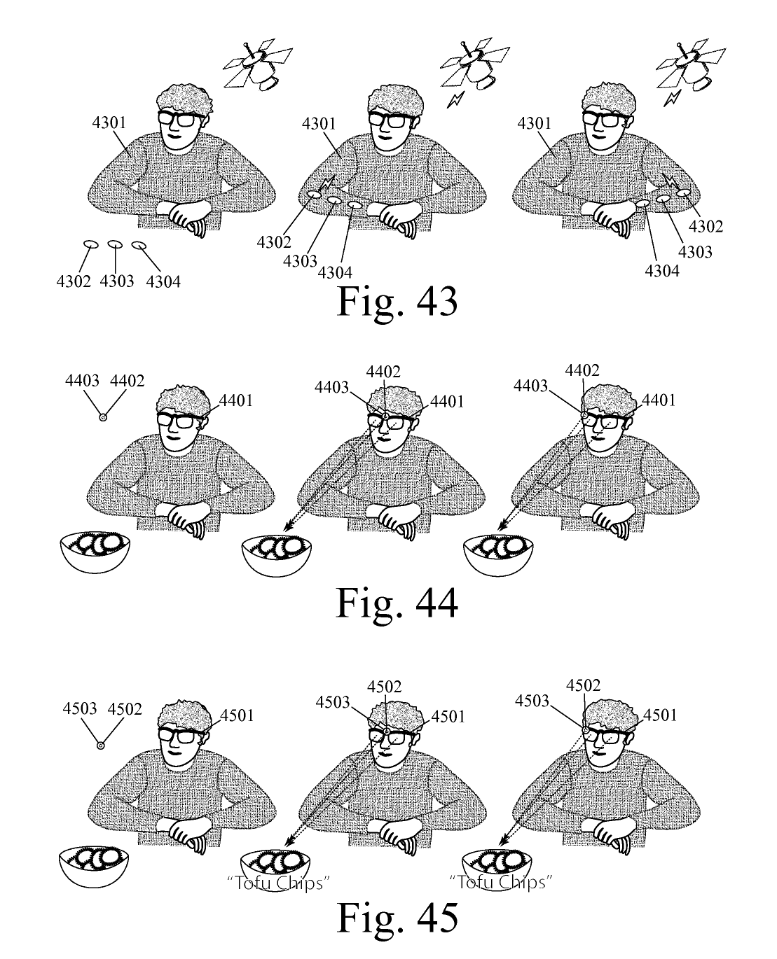

FIG. 43 shows an example of how this invention can be embodied in a system of modular smart clothing (or a modular clothing accessory) comprising: an article of clothing (or clothing accessory) worn by a person; a GPS module; a motion sensor module; and an altimeter module. In FIG. 43, clothing (or an accessory) can be selected from the group consisting of “Set A.” In this figure, article of clothing 4301 is a shirt. In this example, GPS module 4302, motion sensor module 4303, and altimeter module 4304 can be removably attached to the shirt. In an example, the motion sensor can be an accelerometer, gyroscope, or inclinometer.

In an example, data concerning changes in the person's location (as measured by a GPS module), data concerning the number of steps that a person takes (as measured by a motion sensor), and data concerning changes in a person's elevation (as measured by an altimeter) can be analyzed together in order to measure the person's stride distance better than is possible from individual analysis of any of these types of data alone. In an example, data from these three modules can be analyzed using Fourier transformation methods in order to differentiate cyclical walking or running motions from other types of (non-cyclical) motions. In an example, combined data from these three modules can be used to calculate a person's stride distance as a function of the person's geographic location, speed, and/or changes in elevation. In an example, combined data from these three modules can provide more accurate estimation of the person's caloric expenditure than data from any one of these modules by itself.

In an example, a plurality of motion sensors attached to different places on an article of clothing can differentiate a person's walking or running motion versus other types of motion affecting the motion sensors. In an example, a person can removably attach a plurality of modular motion sensors to different locations on one or more articles of clothing in order to create a customized set of smart clothing for individualized motion capture.

FIG. 44 shows an example of how this invention can be embodied in a system of modular smart clothing (or a modular clothing accessory) with a gaze-controlled camera comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 44, a clothing accessory can be selected from the group consisting of “Set A.” In this figure, clothing accessory 4401 is electronically-functional eyewear. In FIG. 44, the energy-transducing member can be selected from the group consisting of “Set B.” In this figure, energy-transducing member 4402 is a modular eye-tracking sensor which is used to control the focal direction and/or focal distance of a wearable camera based on the focal direction and/or distance of the person's gaze. In FIG. 44, attachment mechanism 4403 can be selected from the group consisting of “Set C.”

In an example, a modular eye-tracking sensor can track the focal direction and/or focal distance of a person's eyes in order to determine the place in three-dimensional space at which the person is looking. In an example, the focal direction and/or focal distance of a wearable camera can be controlled such that it focuses at the place in three-dimensional space at which the person is looking. In an example, an eye-tracking sensor, a wearable camera, or both can be attached to, or otherwise incorporated into, electronically-functional eyewear. In an example, the focal direction and distance of a camera can be changed in real time in order to try to constantly follow the person's gaze. In an example, the focal direction and distance of a camera may only be changed when a person has looked at a particular place for at least a selected amount of time. The latter approach can yield greater stability in images recorded by the camera.

FIG. 45 shows an example of how this invention can be embodied in a system of modular smart clothing (or a modular clothing accessory) with gaze-controlled augmented reality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 45, a clothing accessory can be selected from the group consisting of “Set A.” In this figure, or clothing accessory 4501 is electronically-functional eyewear. In FIG. 45, the energy-transducing member can be selected from the group consisting of “Set B.” In this figure, energy-transducing member 4502 is a modular eye-tracking sensor which is used to control the visual display of a virtual object in proximity to a physical object. In FIG. 45, attachment mechanism 4503 can be selected from the group consisting of “Set C.”

In an example, a modular eye-tracking sensor can track the focal direction and focal distance of a person's gaze in order to determine the place in three-dimensional space at which the person is looking. In an example, a virtual object can be visually displayed in the person's field of vision in proximity to this place in three-dimensional space. In an example, this virtual object can be based on identification of a physical object at this place in three-dimensional space. In an example, the virtual object can be textual and/or graphic information about the physical object.

In an example, this system can identify a physical object at which a person is looking and can display information about this object. In an example, this information can comprise product information such as features, price, alternative colors, alternative sizes, and availability. In an example, this information can comprise physical attributes of the physical object such as estimated distance, size, weight, molecular composition, ingredients, and/or calories. In an example, this information can comprise instructions or directions related to actions which the person should perform relative to the physical object. In an example, virtually-displayed textual or graphical information can be visually superimposed over a physical object in the person's field of vision. In an example, virtually-displayed textual or graphical information can be visually constrained to the surface of the physical object.

In an example, a virtual object can be physically projected onto the surface of a physical object using a light projection system, such that people other than the person wearing the eye-tracking sensor can also see the virtual object. In an example, a virtual object can be projected onto a physical object using a coherent light projector. In an example, an eye-tracking sensor, a virtual object display, and/or a coherent light projector can be incorporated into electronically-functional eyewear. In an example, this invention can comprise a wearable and modular system for image-based augmented reality. In an example, this augmented reality is only visible to the person wearing the system. In an example, this augmented reality can also be visible to other people nearby due to a coherent light projector.

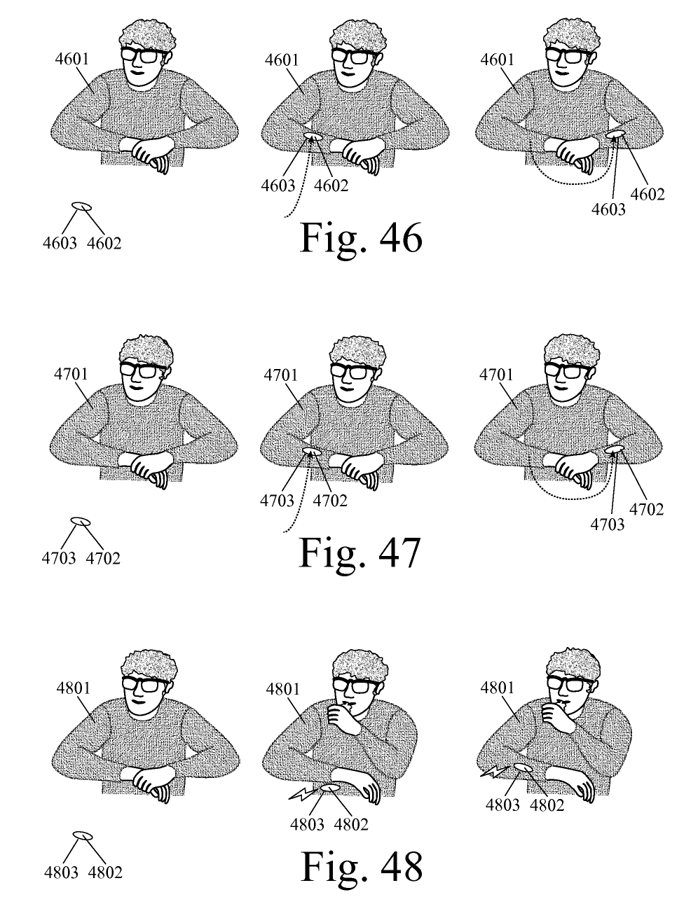

FIG. 46 shows an example of how this invention can be embodied in a system of modular smart clothing (or a modular clothing accessory) for monitoring glucose comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 46, clothing can be selected from the group consisting of “Set A.” In this figure, article of clothing 4601 is a shirt. In FIG. 46, the energy-transducing member can be selected from the group consisting of “Set B.” In this figure, energy-transducing member 4602 is a modular chemical sensor whose data is used to measure the glucose level of the person's body fluid and/or tissue. In FIG. 46, attachment mechanism 4603 can be selected from the group consisting of “Set C.”

In an example, a modular chemical sensor can comprise a non-invasive or minimally-invasive glucose monitor. In an example, a modular chemical sensor can be in continuous, intermittent, or periodic fluid, gaseous, optical, sonic, and/or electromagnetic contact with body fluid and/or tissue so as to monitor the glucose level of that body fluid and/or tissue. In an example, a modular chemical sensor can automatically extract microsamples of body fluid and/or tissue on a periodic basis in order to monitor the glucose level of that body fluid and/or tissue. In an example, a modular chemical sensor can be selected from the group consisting of: chemiresistor, chromatography sensor, light-spectrum-analyzing sensor, optoelectronic sensor, photochemical sensor, spectral analysis sensor, spectrometry sensor, artificial olfactory sensor, biochemical sensor, and microfluidic sensor.

In an example, a modular chemical sensor can continually monitor the glucose level of body fluid and/or tissue using a first method which has a first level of invasiveness and a first level of accuracy. In an example, a modular chemical sensor can automatically measure the glucose level of body fluid and/or tissue using a second method which has a second level of invasiveness and a second level of accuracy, when the first method indicates a probable significant change in glucose level. In an example, the second level of invasiveness is greater than the first level of invasiveness and the second level of accuracy is greater than the first level of accuracy. In an example, the first method can comprise analysis of electromagnetic, light, or sound energy which is transmitted through, or reflected from, body fluid and/or tissue. In an example the second method can comprise extracting and analyzing a microsample of body fluid and/or tissue.

FIG. 47 shows an example of how this invention can be embodied in a system of modular smart clothing (or a modular clothing accessory) for monitoring ambient air composition comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 47, clothing can be selected from the group consisting of “Set A.” In this figure, article of clothing 4701 is a shirt. In FIG. 47, the energy-transducing member can be selected from the group consisting of “Set B.” In this figure, energy-transducing member 4702 is a modular gas composition sensor whose data is used to analyze the composition of ambient air. In FIG. 47, attachment mechanism 4703 can be selected from the group consisting of “Set C.”

In an example, a modular gas composition sensor can measure the level or concentration of oxygen, carbon dioxide, carbon monoxide, nitrogen, moisture, selected pollutants, selected toxins, selected allergens, selected microbes, and/or radioactive particles in ambient air. In an example, this system can also comprise one or more modular sensors which measure ambient air pressure, humidity, and/or temperature. In an example, information concerning the composition of ambient air can be conveyed to the person wearing the shirt via a visual, sound-based, or tactile interface. In an example, a modular gas composition sensor can be selected from the group consisting of: artificial olfactory sensor, biochemical sensor, chemiresistor, chromatography sensor, light-spectrum-analyzing sensor, optoelectronic sensor, photochemical sensor, spectral analysis sensor, spectroscopy sensor, and spectrometry sensor.

FIG. 48 shows an example of how this invention can be embodied in a system of modular smart clothing (or a modular clothing accessory) for monitoring food consumption comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 48, clothing can be selected from the group consisting of “Set A.” In this figure, article of clothing 4801 is a shirt. In FIG. 48, the energy-transducing member can be selected from the group consisting of “Set B.” In this figure, energy-transducing member 4802 is a modular electromagnetic energy sensor whose data is used to detect, monitor, and/or measure a person's consumption of different types of food, ingredients, and/or nutrients. In FIG. 48, attachment mechanism 4803 can be selected from the group consisting of “Set C.”

In an example, a modular electromagnetic energy sensor can be combined with a modular electromagnetic energy emitter. In an example, a modular electromagnetic energy sensor can measure changes in electromagnetic energy from an energy emitter which is transmitted through body fluid and/or tissue in order to detect, monitor, and/or measure a person's consumption of different types and amounts of food, ingredients, and/or nutrients. In an example, a modular electromagnetic energy sensor can measure the voltage, conductivity, resistance, or impedance of electromagnetic energy which is transmitted from an electromagnetic energy emitter through a selected area of body fluid and/or tissue.

In an example, the consumption of different types and quantities of food changes the chemical composition of body fluid and/or tissue. These changes in chemical composition cause changes in electromagnetic energy transmission through the body fluid and/or tissue. These changes in electromagnetic energy transmission can then be measured by a modular electromagnetic energy sensor in order to detect, monitor, and/or measure a person's consumption of food, ingredients, and/or nutrients. In an example, a person's gastrointestinal tract and associated nerves naturally emit electromagnetic signals when a person consumes food. In an example, a modular electromagnetic energy sensor can measure these naturally-occurring electromagnetic signals. Data from this sensor can be used to monitor and/or measure the person's food consumption.

In an example, a modular electromagnetic energy sensor can detect, monitor, and/or measure a person's consumption of one or more selected types of food, ingredients, or nutrients. In an example, these one or more selected types of food, ingredients, or nutrients can be selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds; high-carbohydrate food, high-sugar food, high-fat food, fried food, high-cholesterol food, high-protein food, high-fiber food, and high-sodium food.

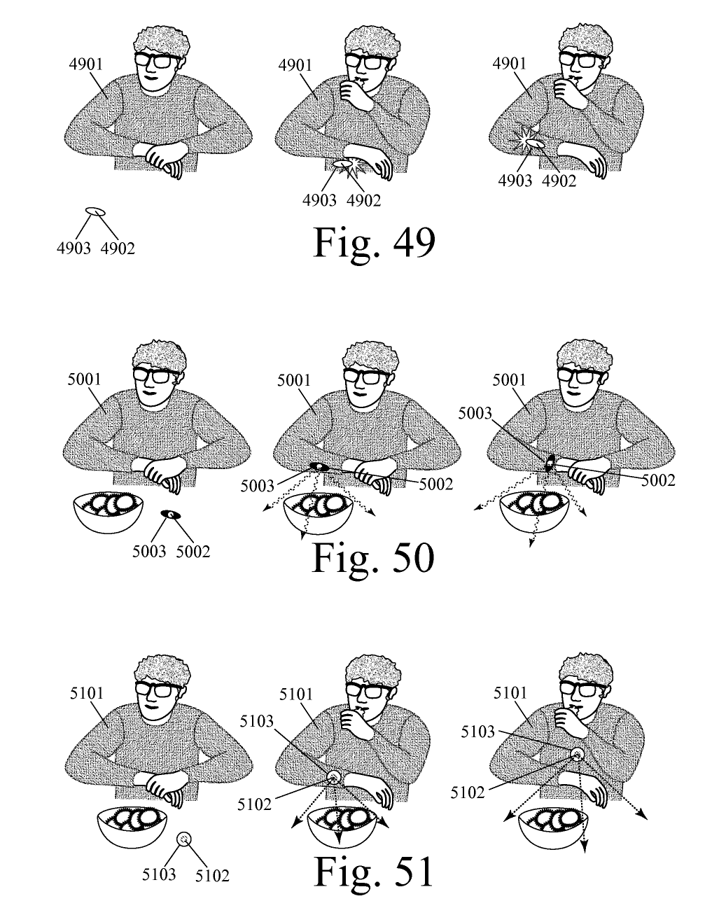

FIG. 49 shows an example of how this invention can be embodied in a system of modular smart clothing (or a modular clothing accessory) for monitoring food consumption comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 49, clothing can be selected from the group consisting of “Set A.” In this figure, article of clothing 4901 is a shirt. In FIG. 49, the energy-transducing member can be selected from the group consisting of “Set B.” In this figure, energy-transducing member 4902 is a modular light energy sensor whose data is used to detect and/or measure the person's consumption of food, ingredients, and/or nutrients. In FIG. 49, attachment mechanism 4903 can be selected from the group consisting of “Set C.”

In an example, a modular light energy sensor can be used in combination with a modular light energy emitter. In an example, a modular light energy sensor can measure changes in light energy which is transmitted through, or reflected from, a selected portion of body fluid and/or tissue. In an example, data from this light energy sensor can be used to analyze changes in the intensity, color, spectrum, polarity, phase, or coherence of light energy that is transmitted through, or reflected from, a selected portion of body fluid and/or tissue. In an example, this light energy can be visible light, infrared light, or ultraviolet light. In an example, this light energy can be coherent light from a laser.

In an example, a modular light energy sensor can be a spectroscopy sensor. In an example, consumption of different kinds of food causes different spectral shifts in light energy transmitted through body fluid and/or tissue. In an example, these different spectral shifts can be detected and used to monitor and/or measure food consumption. In an example, a modular light energy sensor can be selected from the group consisting of: light-spectrum-analyzing sensor, spectroscopy sensor, chromatography sensor, and optoelectronic sensor.

In an example, a person's consumption of different types and amounts of food, ingredients, and/or nutrients causes changes in the chemical composition of body fluid and/or tissue. These changes in the chemical composition of body fluid and/or tissue, in turn, cause changes in the intensity, color, spectrum, polarity, phase, or coherence of light energy transmitted through, or reflected from, body fluid and/or tissue. These changes in light energy transmission can then be measured by a modular light energy sensor to detect, monitor, and/or measure the person's consumption of different types and amounts of food, ingredients, and/or ingredients.

In an example, a modular light energy sensor can detect, monitor, and/or measure a person's consumption of one or more selected types of food, ingredients, or nutrients. In an example, these one or more selected types of food, ingredients, or nutrients can be selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds; high-carbohydrate food, high-sugar food, high-fat food, fried food, high-cholesterol food, high-protein food, high-fiber food, and high-sodium food.

FIG. 50 shows an example of how this invention can be embodied in a system of modular smart clothing (or a modular clothing accessory) for analyzing food composition comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 50, clothing can be selected from the group consisting of “Set A.” In this figure, article of clothing 5001 is a shirt. In FIG. 50, the energy-transducing member can be selected from the group consisting of “Set B.” In this figure, energy-transducing member 5002 is a modular light energy sensor whose data is used to measure the nutritional composition and/or quantity of nearby food. In FIG. 50, attachment mechanism 5003 can be selected from the group consisting of “Set C.”

In an example, a modular light energy sensor can be used in combination with a modular light energy emitter. In an example, a modular light energy sensor can collect data concerning light energy that is transmitted through, or reflected from, nearby food. In an example, data from this modular light sensor can be used to analyze the intensity, color, spectrum, polarization, coherence, and/or phase of light energy that is transmitted through, or reflected from, nearby food. In an example, this light energy can be visible light, infrared light, or ultraviolet light. In an example, this light energy can be coherent light from a laser. In an example, a modular light energy sensor can be selected from the group consisting of: light-spectrum-analyzing sensor, spectroscopy sensor, chromatography sensor, and optoelectronic sensor.

In an example, a person can initiate analysis of the composition of nearby food by activating a modular light energy sensor. In an example, a light sensor can be used in combination with a motion sensor. In an example, a person can initiate analysis of the composition of nearby food by moving their hand or arm in proximity to the food. In an example, a person can initiate analysis of nearby food by passing their hand or arm over the food. In an example, a light sensor can be used in combination with a gaze-tracking sensor. In an example, a person can initiate analysis of nearby food by directing their gaze toward the food. In an example, an initiating action causes a light emitter to emit light toward food and the modular light sensor detects light which is reflected from, or passes through, the food. In an example, this light can comprise a coherent beam of light from a laser.

In an example, a modular light energy sensor can detect and/or measure the relative or absolute levels of one or more selected types of ingredients or nutrients in nearby food. In an example, these one or more selected types of ingredients or nutrients can be selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds.

In an example, data from a modular light energy sensor can provide information concerning the nutritional composition of nearby food, but may not provide information concerning the amount of food or the quantity of nutrients in nearby food. In an alternative example, data from a modular light energy sensor can also provide information concerning the amount of food and nutrients in nearby food using three-dimensional and/or volumetric analysis of the food. In an example, a modular light energy sensor can sequentially or simultaneously collect data concerning nearby food from different angles and can then combine data from different angles to estimate the three-dimensional volume of the food. In an example, a plurality of modular light energy sensors attached to an article of clothing at different locations can collect optical data concerning food from different angles in order to enable three-dimensional volumetric analysis of food quantity.

FIG. 51 shows an example of how this invention can be embodied in a system of modular smart clothing (or a modular clothing accessory) for monitoring food consumption comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 51, clothing (or an accessory) can be selected from the group consisting of “Set A.” In this figure, article of clothing 5101 is a shirt. In another example, this component can be electronically-functional eyewear. In FIG. 51, the energy-transducing member can be selected from the group consisting of “Set B.” In this figure, energy-transducing member 5102 is a modular wearable imaging device whose images are analyzed to detect and/or measure a person's food consumption. In FIG. 51, attachment mechanism 5103 can be selected from the group consisting of “Set C.”

In an example, a modular wearable imaging device can be a wearable camera. In an example, a wearable imaging device can record video images or still images. In an example, a modular wearable imaging device can record video images continually. In an example, a modular wearable imaging device can take still pictures periodically. In an example, a modular wearable imaging device can be triggered to record video images or to take still pictures when one or more wearable sensors indicate that a person is probably eating food. In an example, a modular wearable imaging device can record video images or take still pictures when data from a motion sensor, electromagnetic energy sensor, optical sensor, sound sensor, or biochemical sensor indicates that a person is probably eating food.

In an example, a modular wearable imaging device can continually record video images, but these images can be automatically erased after a selected time interval unless analysis of these images indicates nearby food and/or eating behavior by the person wearing the device. In an example, recorded images of food and/or eating behavior can be retained for further analysis in order to measure the types and quantities of food that a person consumes. In an example, food can include liquid beverages as well as solid food. In an example, types and quantities of food consumed can be translated into types and quantities of ingredients and nutrients consumed using a database which links types of food to types of ingredients and nutrients.

In an example, a modular wearable imaging device can track the location of a person's hands and focus on nearby space in order to detect interaction between the person's hands and food. In an example, a modular wearable imaging device can track the location of a person's face and focus on nearby space in order to detect interaction between the person's mouth and hands and/or interaction between the person's mouth and food. Images of nearby food, images of hand-food interaction, and images of food-mouth interaction can collectively enable more accurate measurement of food consumption than any one of these image types alone. There are a couple reasons for this. A person may not eat all nearby food, so images of nearby food alone may overestimate food consumption. Also, food may be more difficult to identify when bite-size portions of food are held in a person's hand or conveyed via a food utensil. Accordingly, having images of nearby food, hand-food interaction, and food-mouth interaction can enable more accurate measurement of the types and quantities of food that person actually consumes.

In an example, images of food recorded by a modular wearable imagine device can be analyzed to identify types and quantities of food consumed. In an example, the types and quantities of food can be identified by one or more means selected from the group consisting of: computer-readable food product codes; food packaging labels, text, patterns, and logos; pattern recognition; food shape, color, and texture; juxtaposition with other foods; locational and/or time-of-day context; spectral analysis; sequential or simultaneous food images from different angles; and three-dimensional volumetric analysis.

In an example, a modular imaging device can record sequential images of nearby food, interactions between this food and the person's hands, and/or interactions between this food and the person's mouth. In an example, a modular imaging device can record sequential images of food from different angles. In an example, one or more modular imaging device can record simultaneous images of food from different angles. In an example, images of food recorded from different angles can be merged to estimate the three-dimensional volume of food.

In an example, a modular imaging device can use sequential images of food to determine how much food is actually consumed by a person. In an example, changes in the three-dimensional volume of food during (or before versus after) an eating event can be used to estimate actual food consumption. In an example, information concerning the number of hand motions and/or utensil-size portions during an eating event can also be used to estimate actual food consumption. In an example, identification of the types and quantities of food consumed can be an interactive process between a computer and a person. In an example, a computer can automatically collect a first set of data concerning food consumption and the person can be prompted to enter a second set of data to refine this measurement of food consumption.

In an example, images from a modular imaging device can be used to measure consumption of one or more selected types of food, ingredients, or nutrients. In an example, identification of types and quantities of food can be based on analysis of images recorded by a modular imaging device. In an example, types and quantities of ingredients or nutrients can be estimated using a database which links types of food with types of ingredients and nutrients. In an example, types of food, ingredients, or nutrients can be selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds; high-carbohydrate food, high-sugar food, high-fat food, fried food, high-cholesterol food, high-protein food, high-fiber food, and high-sodium food.

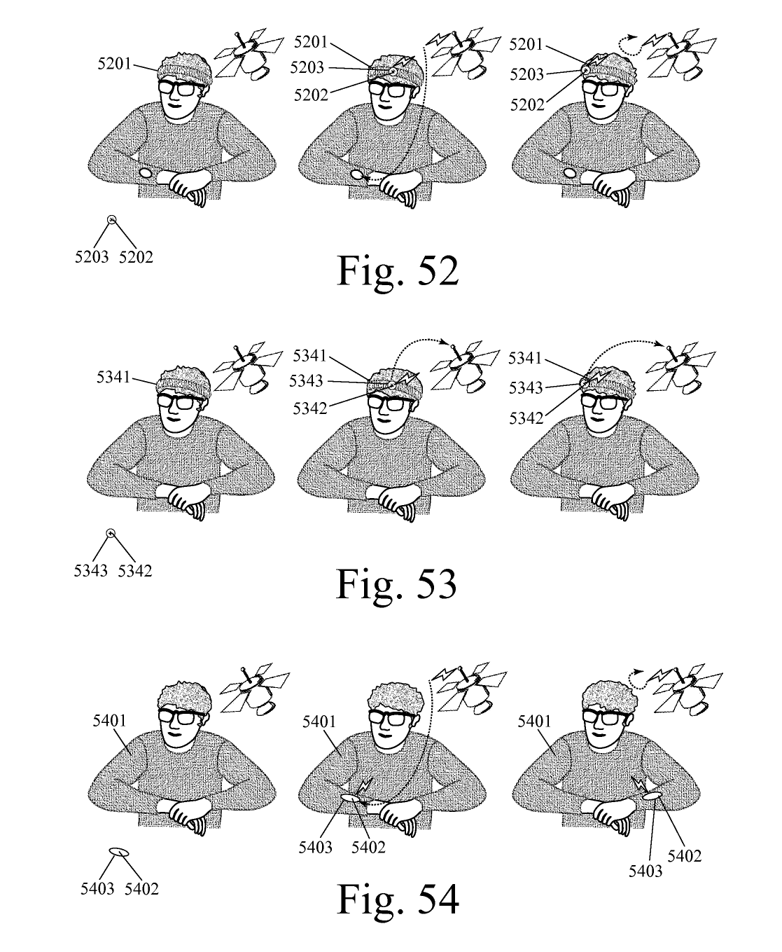

FIG. 52 shows an example of how this invention can be embodied in a system of modular smart clothing (or a modular clothing accessory) for monitoring brain activity comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 52, clothing can be selected from the group consisting of “Set A.” In this figure, article of clothing 5201 is a headband. In another example, this component can be electronically-functional eyewear. In FIG. 52, the energy-transducing member can be selected from the group consisting of “Set B.” In this figure, energy-transducing member 5202 is a modular electromagnetic brain activity sensor whose data is used to modify the filtration of incoming electronic communications. In FIG. 52, attachment mechanism 5203 can be selected from the group consisting of “Set C.”

In an example, a modular electromagnetic brain activity sensor can be an EEG sensor. In an example, a modular electromagnetic brain activity sensor can measure changes in the voltage, conductivity, resistance, or impedance of electromagnetic energy transmitted through a portion of a person's head. In an example, data from this sensor can be analyzed using Fourier transformation in order to identify repeating energy patterns in clinical frequency bands—such as the Delta, Theta, Alpha, Beta, and Gamma bands. In an example, the relative and/or combinatorial power levels of energy in clinical frequency bands can be analyzed. In an example, data from multiple electromagnetic brain activity sensors can be collectively analyzed and the combined results can be used to modify the notification filter for incoming electronic communications.

In an example, a person can removably attach a plurality of modular electromagnetic sensors to different places on an article of clothing or clothing accessory in order to create a customized device to optimally measure their electromagnetic brain activity. In an example, multiple modular electromagnetic energy sensors can be configured to be a located at sites selected from the group consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2.

In an example, data from a modular electromagnetic brain activity sensor can be used to change the criteria by which incoming electronic communications are filtered. In an example, data from a modular electromagnetic brain activity sensor can be used to modify the criteria required in order for a person to receive immediate notification of an incoming electronic communication. The selection of the types of incoming electronic communications which trigger immediate notification of the person wearing the shirt can be modified based on selected patterns of brain activity based on data from the modular electromagnetic brain activity sensor.

In an example, when a person's electromagnetic brain activity data indicates that the person is intensely focused on a task, then a notification system can automatically impose more selective criteria which must be met by an electronic communication in order for the person to be immediately notified of the electronic communication. In an example, when a person's electromagnetic brain activity data indicates that the person is sleeping, then a notification system can automatically impose more selective criteria which must be met by an electronic communication in order for the person to be immediately notified of the electronic communication.

In an example, a person can control the filtering and/or notification of incoming electronic communications by modifying their brainwaves. In an example, if a person joins an important meeting or is on a date (and wish to reduce incoming communication notifications in a non-obvious manner), then they can increase filtering and/or reduce notification of incoming communications by self-modifying their brainwaves. Alternatively, if a person is at an event which is dragging on and interruption would be welcome, then the person can decrease filtering and/or increase notification of incoming communications by self-modifying their brainwaves. Such self-modification of brainwaves can require training, such as with biofeedback, but is possible.

FIG. 53 shows an example of how this invention can be embodied in a system of modular smart clothing (or a modular clothing accessory) for brainwave-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 53, clothing can be selected from the group consisting of “Set A.” In this figure, article of clothing 5301 is a headband. In another example, this component can be electronically-functional eyewear. In FIG. 53, the energy-transducing member can be selected from the group consisting of “Set B.” In this figure, energy-transducing member 5302 is a modular electromagnetic brain activity sensor whose data is used to initiate an outgoing electronic communication. In FIG. 53, attachment mechanism 5303 can be selected from the group consisting of “Set C.”

In an example, a modular electromagnetic brain activity sensor can be a modular EEG sensor. In an example, a modular electromagnetic brain activity sensor can measure changes in the voltage, conductivity, resistance, or impedance of electromagnetic energy transmitted through a portion of a person's head. In an example, data from a modular electromagnetic brain activity sensor can be analyzed using Fourier transformation in order to identify repeating energy patterns in clinical frequency bands—such as the Delta, Theta, Alpha, Beta, and Gamma bands. In an example, the relative and/or combinatorial power levels of energy in these clinical frequency bands can be analyzed. In an example, data from multiple electromagnetic brain activity sensors can be collectively analyzed.

In an example, a person can removably attach a plurality of modular electromagnetic energy sensors to different places on a headband or electronically-functional eyewear in order to create a customized device to optimally measure their electromagnetic brain activity. In an example, multiple modular electromagnetic energy sensors can be configured to be a located at sites selected from the group consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2.

In an example, a system can automatically initiate a selected type of outgoing electronic communication (to a selected recipient) when data from a modular electromagnetic brain activity sensor detects a selected pattern of electromagnetic brain activity. In an example, this pattern of electromagnetic brain activity can be selected from a group of patterns indicating: a high level of distress or anxiety; poor brain oxygenation; a seizure; or another type of adverse health event or condition. In an example, this pattern of electromagnetic brain activity can indicate consumption of an intoxicating substance. In an example, such a pattern can trigger an outgoing electronic communication to a supportive friend or family member who can respond to provide support at a difficult or dangerous time. In another example, such a pattern can trigger an outgoing electronic communication to a health care provider. In an example, an initiated outgoing electronic communication can be in the form of a text message, phone call, email, or streaming video.

FIG. 54 shows an example of how this invention can be embodied in a system of modular smart clothing (or a modular clothing accessory) for motion-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 54, clothing can be selected from the group consisting of “Set A.” In this figure, article of clothing 5401 is a shirt. In FIG. 54, the energy-transducing member can be selected from the group consisting of “Set B.” In this figure, energy-transducing member 5402 is a modular electromagnetic muscle activity sensor whose data is used to modify the filtration of incoming electronic communications. In FIG. 54, attachment mechanism 5403 can be selected from the group consisting of “Set C.”

In an example, a modular electromagnetic muscle activity sensor can be an EMG sensor. In an example, a modular electromagnetic muscle activity sensor can be combined with a modular electromagnetic energy emitter. In an example, a modular electromagnetic muscle activity sensor can measure changes in the voltage, conductivity, resistance, or impedance of electromagnetic energy transmitted from an electromagnetic energy emitter through muscle tissue. In an example, a modular electromagnetic muscle activity sensor can measure electromagnetic signals which are naturally generated by muscle tissue and/or associated efferent nerves when muscles are activated.

In an example, the filtering and/or notification functions for incoming electronic communications can be modified based on data from a modular electromagnetic muscle activity sensor. In an example, communication filtering and/or notification can be modified based on a person's overall level of body motion. In an example, when data from a modular electromagnetic energy sensor indicates that the person is very active (e.g. probably exercising), then the system can impose more selective criteria which must be met by an electronic communication in order for the person to be immediately notified of that electronic communication. In an example, when data from a modular electromagnetic energy sensor indicates that the person is very inactive (e.g. probably sleeping), then the system can impose more selective criteria which must be met by an electronic communication in order for the person to be immediately notified of that electronic communication.

In an example, filtering and/or notification functions for incoming electronic communications can be modified based on identification of a particular type or configuration of body motion. In an example, when a person moves their arms or hand into a particular configuration or gesture, then this is identified by the electromagnetic muscle activity sensor and modifies the filtering and/or notification of incoming electronic messages. In an example, when movements of a person's arms indicate that they are probably driving, then this can increase the filtration and/or reduce the notification of incoming electronic communications to automatically improve driving safety. More generally, this system can comprise a physiologically-aware communication notification system wherein the filtration of incoming electronic communications is modified based on a person's body motion, configuration, posture, and/or gestures.

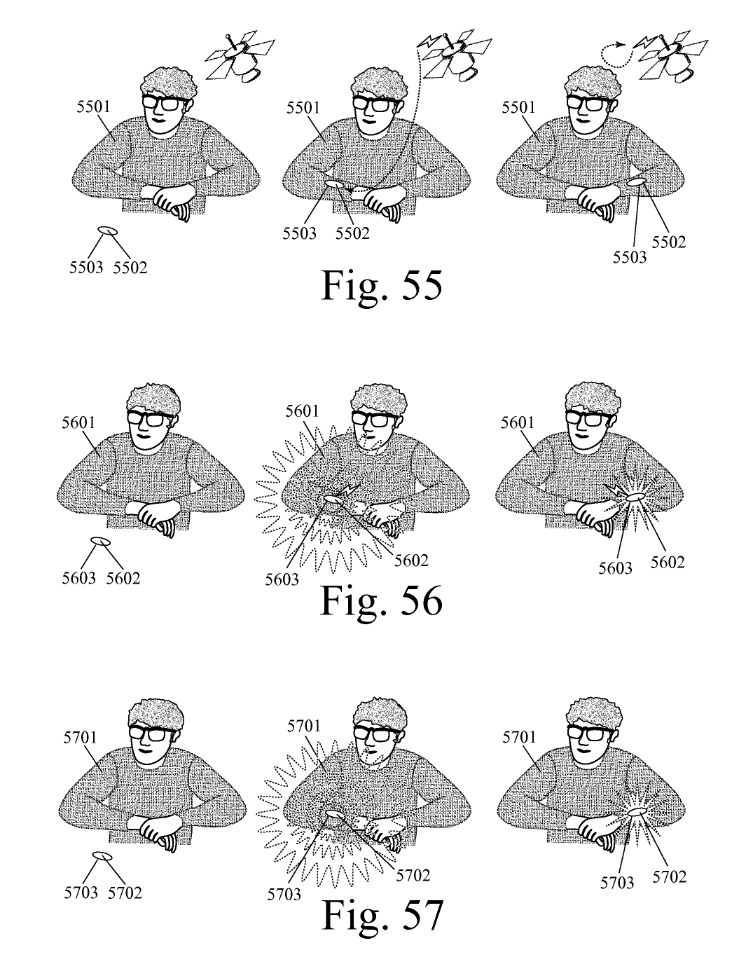

FIG. 55 shows an example of how this invention can be embodied in a system of modular smart clothing (or a modular clothing accessory) for motion-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 55, clothing can be selected from the group consisting of “Set A.” In this figure, article of clothing 5501 is a shirt. In FIG. 55, the energy-transducing member can be selected from the group consisting of “Set B.” In this figure, energy-transducing member 5502 is a modular motion sensor whose data is used to modify the filtration and/or notification functions for incoming electronic communications. In FIG. 55, attachment mechanism 5503 can be selected from the group consisting of “Set C.”

In an example, a modular motion sensor can be an accelerometer, gyroscope, or inclinometer. In an example, electronic communications can include phone calls, text messages, emails, and streaming video. In an example, the filtration and/or notification functions for incoming electronic communications can be automatically modified based on data from a modular motion sensor. In an example, the filtration and/or notification functions for incoming communications can be modified based on a person's overall activity level as measured by the motion sensor. In an example, when a person is very active (probably doing something strenuous), then a system can increase the filtration and/or decrease immediate notification of incoming communications. In an example, when a person is very inactive (probably asleep), then a system can increase the filtration and/or decrease immediate notification of incoming communications.

In an example, the filtration and/or notification functions for incoming electronic messages can be modified based on detection of a specific pattern of body motion. For example, when a person taps their finger a first number of times and/or makes a first hand gesture, then this can increase the criteria required for immediate notification of a communication and reduce notifications. For example, when a person taps their finger a second number of times and/or makes a second hand gesture, then this can decrease the criteria required for immediate notification of a communication and increase notifications.

FIG. 56 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 56, clothing can be selected from the group consisting of “Set A.” In this figure, article of clothing 5601 is a shirt. In FIG. 56, the energy-transducing member can be selected from the group consisting of “Set B.” In this figure, energy-transducing member 5602 is a modular electromagnetic muscle activity sensor whose data is used to modify the mode and/or energy level of a computer-human interface. In FIG. 56, attachment mechanism 5603 can be selected from the group consisting of “Set C.”

In an example, a modular electromagnetic muscle activity sensor can be an EMG sensor. In an example, a modular electromagnetic muscle activity sensor can measure changes in the transmission of electromagnetic energy through muscle tissue and/or associated efferent nerves which occur as muscles are activated. In an example, a modular electromagnetic muscle activity sensor can measure changes in electromagnetic energy which is naturally emitted from muscle tissue and/or associated efferent nerves as muscles are activated. In an example, the mode and/or energy level of a computer-human interface can be modified based on data from a modular electromagnetic muscle activity sensor. In an example, this interface can be an interface for communication from a computer to a human. In an example, this interface can be an interface for communication from a human to a computer. In an example, this interface can be based on light, sound, or touch.

In an example, when data from a modular electromagnetic muscle activity sensor indicates that a person is very active, then this system can change the mode of user interface from a touch-based or light-based interface to a sound-based interface that is less likely to be confounded by active motion. In an example, when data from a modular electromagnetic muscle activity sensor indicates that a person is very active, then this system can increase the energy level of computer-to-human communication. For example, the system can increase the volume of sound-based communication, increase the brightness of light-based communication, and/or increase the strength of tactile-based communication.

In an example, a person can change the mode of user interface by making a specific hand gesture which is detected by a modular electromagnetic muscle activity sensor. In an example, a person can increase or decrease the energy level of user interface by making a first hand gesture or a second hand gesture, respectively, which is detected by a modular electromagnetic muscle activity sensor. More generally, this system can be an example of a physiologically-responsive computer-human interface.

FIG. 57 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 57, clothing can be selected from the group consisting of “Set A.” In this figure, article of clothing 5701 is a shirt. In FIG. 57, the energy-transducing member can be selected from the group consisting of “Set B.” In this figure, energy-transducing member 5702 is a modular motion sensor whose data is used to modify the mode and/or energy level of a computer-human interface. In FIG. 57, attachment mechanism 5703 can be selected from the group consisting of “Set C.”

In an example, a modular motion sensor can be an accelerometer, gyroscope, or inclinometer. In an example, the mode and/or energy level of a computer-human interface can be modified based on data from a modular motion sensor. In an example, this interface can be an interface for communication from a computer to a human. In an example, this interface can be an interface for communication from a human to a computer. In an example, this interface can be based on light, sound, or touch.

In an example, when data from a modular motion sensor indicates that a person is very active, then this system can change the mode of user interface from a touch-based or light-based interface to a sound-based interface that is less likely to be confounded by active motion. In an example, when data from a modular motion sensor indicates that a person is very active, then this system can increase the energy level of computer-to-human communication. For example, the system can increase the volume of sound-based communication, increase the brightness of light-based communication, and/or increase the strength of tactile-based communication.

In an example, a person can change the mode of user interface by making a specific hand gesture which is detected by a modular motion sensor. In an example, a person can increase or decrease the energy level of user interface by making a first hand gesture or a second hand gesture, respectively, which is detected by a modular motion sensor. More generally, this system can be an example of a physiologically-responsive computer-human interface.

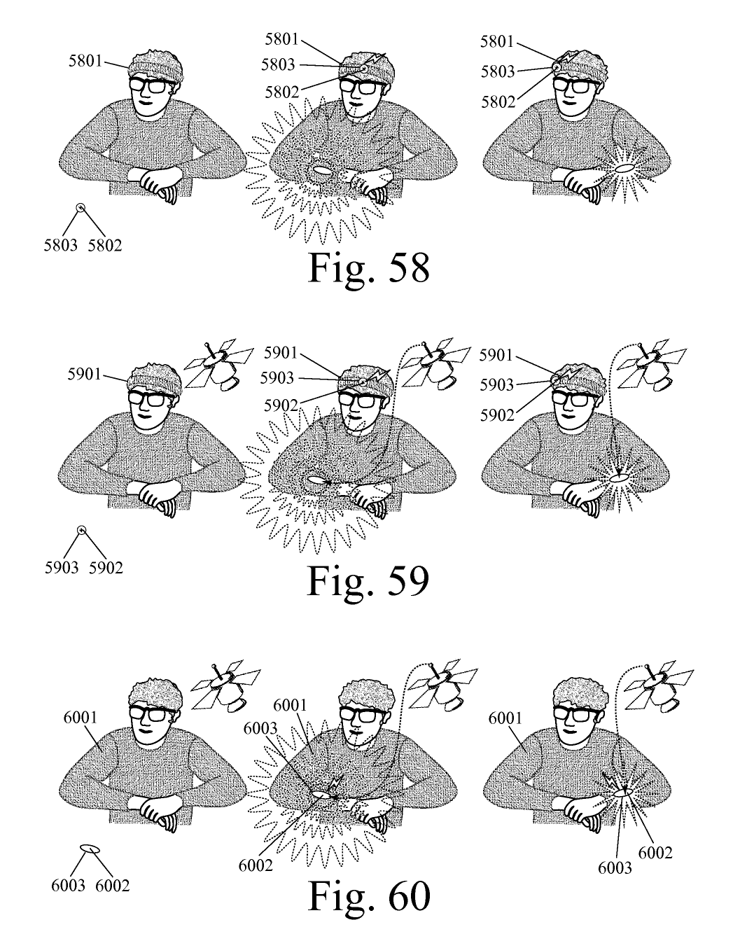

FIG. 58 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 58, clothing (or an accessory) can be selected from the group consisting of “Set A.” In this figure, article of clothing 5801 is a headband. In another example, this component can be electronically-functional eyewear. In FIG. 58, the energy-transducing member can be selected from the group consisting of “Set B.” In this figure, energy-transducing member 5802 is a modular electromagnetic brain activity sensor whose data is used to modify the mode and/or energy level of a computer-human interface. In FIG. 58, attachment mechanism 5803 can be selected from the group consisting of “Set C.”

In an example, a modular electromagnetic brain activity sensor can be an EEG sensor. In an example, a modular electromagnetic brain activity sensor can measure changes in the voltage, conductivity, resistance, capacitance and/or impedance of electromagnetic energy that is transmitted through a portion of a person's head. In an example, a modular electromagnetic brain activity sensor can measure electromagnetic signals which are naturally emitted from a person's brain.

In an example, a person can removably attach a plurality of modular electromagnetic energy sensors to different places on a headband or electronically-functional eyewear in order to create a customized device to optimally measure their electromagnetic brain activity. In an example, multiple modular electromagnetic energy sensors can be configured to be a located at sites selected from the group consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2.

In an example, a computer-human interface can be a computer-to-human interface. In an example, an interface can have a light-based, sound-based, or touch-based mode. In an example, an interface can have a low, moderate, or high energy level. For example, a low energy level visual interface can be a dim image and a high energy level visual interface can be a bright image. In an example, the mode and/or energy level of a person's interface can be changed based on analysis of data from a modular electromagnetic brain activity sensor. For example, a first interface mode and/or energy level can be used when a person's brain activity indicates intense concentration. For example, a second interface mode and/or energy level can be used when a person's brain activity indicates a state of relaxation.

In an example, a person can intentionally change the mode and/or energy level of a computer-human user interface by self-adjusting their brainwave patterns. In an example, a person can intentionally change the relative power of brainwave activity in different clinical frequency bands in order to change the mode and/or energy level of a computer-human user interface. In an example, a person can create a customized EEG monitor by removably attaching a plurality of modular electromagnetic brain activity sensors to a headband, electronically-functional eyewear, ear buds, or other type of head-worn device.

FIG. 59 shows an example of how this invention can be embodied in a system of modular smart clothing (or a modular clothing accessory) for brainwave-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 59, clothing (or an accessory) can be selected from the group consisting of “Set A.” In this figure, article of clothing 5901 is a headband. In another example, this component can be electronically-functional eyewear. In FIG. 59, the energy-transducing member can be selected from the group consisting of “Set B.” In this figure, energy-transducing member 5902 is a modular electromagnetic brain activity sensor whose data is used to modify the mode, energy level, timing, and/or filtration of notifications concerning incoming electronic communications. In FIG. 59, attachment mechanism 5903 can be selected from the group consisting of “Set C.”

In an example, a modular electromagnetic brain activity sensor can be an EEG sensor. In an example, a modular electromagnetic brain activity sensor can measure changes in the voltage, conductivity, resistance, capacitance and/or impedance of electromagnetic energy transmitted through a portion of a person's head. In an example, a modular electromagnetic brain activity sensor can measure electromagnetic signals which are naturally emitted from the brain. In an example, a notification mode can be visual, auditory, or tactile. In an example, a notification energy level can be low, moderate, or high. In an example, the mode and/or energy level of incoming electronic communication notifications to a person can be modified based on the person's electromagnetic brain activity as measured by a modular electromagnetic brain activity sensor. In an example, notifications may be conveyed in a visual mode when a person's brain activity indicates that the person is probably sleeping.

In an example, a person can removably attach a plurality of modular electromagnetic energy sensors to different places on a headband or electronically-functional eyewear in order to create a customized device to optimally measure their electromagnetic brain activity. In an example, multiple modular electromagnetic energy sensors can be configured to be a located at sites selected from the group consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2.

FIG. 60 shows an example of how this invention can be embodied in a system of modular smart clothing (or a modular clothing accessory) muscle-activity-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 60, clothing (or an accessory) can be selected from the group consisting of “Set A.” In this figure, article of clothing 6001 is a shirt. In FIG. 60, the energy-transducing member can be selected from the group consisting of “Set B.” In this figure, energy-transducing member 6002 is a modular electromagnetic muscle activity sensor whose data is used to modify the mode, energy level, timing, and/or filtration of notifications concerning incoming electronic communications. In FIG. 60, attachment mechanism 6003 can be selected from the group consisting of “Set C.”

In an example, a modular electromagnetic muscle activity sensor can be an EMG sensor. In an example, a modular electromagnetic muscle activity sensor can measure the voltage, conductivity, resistance, capacitance and/or impedance of electromagnetic energy transmitted through muscle tissue and/or associated efferent nerves when muscles are activated. In an example, a modular electromagnetic muscle activity sensor can measure electromagnetic energy which is naturally emitted from muscle tissue and/or associated efferent nerves when muscles are activated.

In an example, a notification mode can be visual, tactile, or auditory. In an example, the energy level of a notification can be low, moderate, or high. In an example, the mode and/or energy level of communication notifications to a person can be modified based on the person's muscle activity as measured by a modular sensor. In an example, notifications may be conveyed in a visual mode when a person's muscle activity indicates that they are probably sleeping. In an example, notifications may be conveyed in a sound-based mode when a person's muscle activity indicates that they are probably running

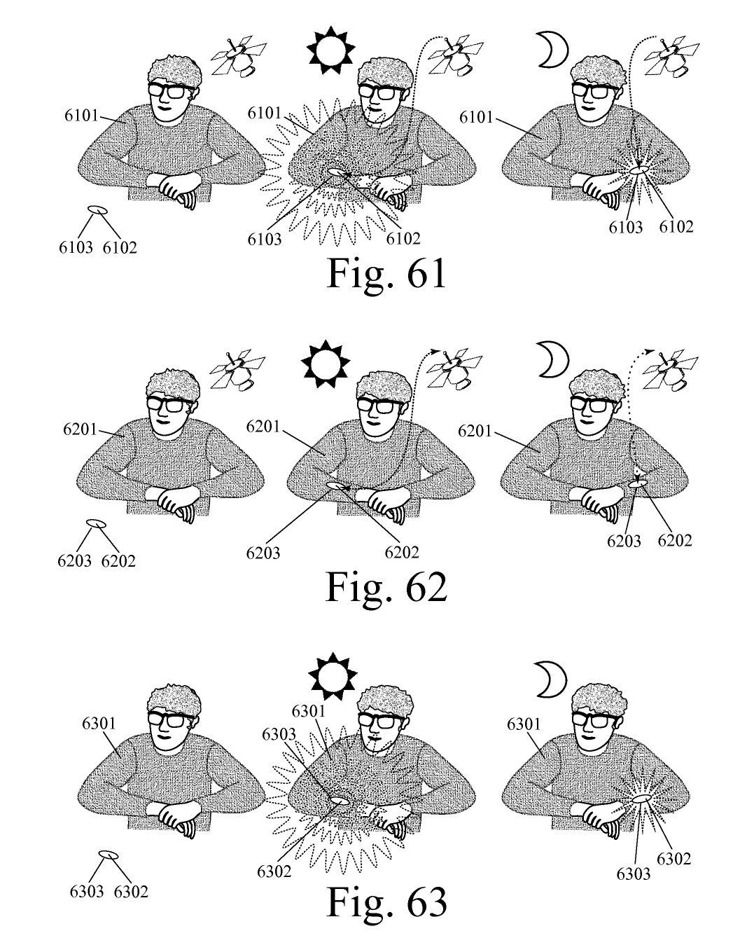

FIG. 61 shows an example of how this invention can be embodied in a system of modular smart clothing (or a modular clothing accessory) for light-modified communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 61, clothing can be selected from the group consisting of “Set A.” In this figure, article of clothing 6101 is a shirt. In FIG. 61, the energy-transducing member can be selected from the group consisting of “Set B.” In this figure, energy-transducing member 6102 is a modular ambient light sensor whose data is used to modify the mode and/or energy level of incoming electronic communication notifications. In FIG. 61, attachment mechanism 6103 can be selected from the group consisting of “Set C.”

In an example, a modular ambient light sensor can be selected from the group consisting of: an optoelectronic sensor, a photoelectric sensor, a light polarity sensor, and a light intensity sensor. In an example, data from a modular ambient light sensor can be used to modify the mode and/or energy level of incoming communication notifications which a person receives in real time. In an example, a communication notification mode can be a light-based mode, a sound-based mode, or a tactile-based mode. In an example, a communication notification energy level can be a low, moderate, or high energy level.

In an example, if a modular ambient light sensor indicates that a person is in a very bright environment, then a system can provide sound-based or tactile-based electronic communication notifications (instead of light-based communication notifications). If a modular ambient light sensor indicates that a person is in a bright environment, then a system can provide a bright light-based electronic communication notifications (instead of dim light-based communication notifications). If a modular ambient light sensor indicates that a person is in a dim environment, then a system can provide light-based electronic communication notifications (instead of sound-based or tactile-based communication notifications). If a modular ambient light sensor indicates that a person is in a dim environment, then a system can provide dim light-based electronic communication notifications (to save energy) instead of bright light-based communication notifications. More generally, this system can comprise an environmentally-aware communication notification system with many advantages for the user.

FIG. 62 shows an example of how this invention can be embodied in a system of modular smart clothing (or a modular clothing accessory) for environmentally-aware communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 62, clothing can be selected from the group consisting of “Set A.” In this figure, article of clothing 6201 is a shirt. In FIG. 62, the energy-transducing member can be selected from the group consisting of “Set B.” In this figure, energy-transducing member 6202 is a modular ambient light sensor or a modular ambient sound sensor whose data is used to select an automatic response message which is given in response to incoming electronic communications. In FIG. 62, attachment mechanism 6203 can be selected from the group consisting of “Set C.”

In an example, a modular ambient light sensor can be selected from the group consisting of: an optoelectronic sensor, a photoelectric sensor, a light polarity sensor, and a light intensity sensor. In an example, a modular ambient sound sensor can be a microphone. In an example, if a person is in an environment with a first level of ambient light, then the system can send a first type of automatic message in response to incoming electronic communications. If the person is in an environment with a second level of ambient light, then the system can send a second type of automatic message in response to incoming electronic communications. In an example, if a person is in an environment with a first level of ambient sound, then the system can send a first type of automatic message in response to incoming electronic communications. If the person is in an environment with a second level of ambient sound, then the system can send a second type of automatic message in response to incoming electronic communications. In an example, if a person is in a dark, quiet environment, then the system may assume that the person is sleeping and can send a message saying the person cannot respond immediately but will respond later. More generally, this system can comprise an environmentally-aware communication management system.

FIG. 63 shows an example of how this invention can be embodied in a system of modular smart clothing (or a modular clothing accessory) for light-modified interaction comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 63, clothing can be selected from the group consisting of “Set A.” In this figure, article of clothing 6301 is a shirt. In FIG. 63, the energy-transducing member can be selected from the group consisting of “Set B.” In this figure, energy-transducing member 6302 is a modular ambient light sensor whose data is used to modify the mode and/or energy level of a user interface. In FIG. 63, attachment mechanism 6303 can be selected from the group consisting of “Set C.”

In an example, an example, a modular ambient light sensor can be selected from the group consisting of: an optoelectronic sensor, a photoelectric sensor, a light polarity sensor, and a light intensity sensor. In an example, a user interface can be an interface for communication from a computer to a human. In an example, a user interface can be an interface for communication from a human to a computer. In an example, a user interface mode can be based on light, sound, or touch. In an example, a user interface energy level can be low, moderate, or high. In an example, data from a modular ambient light sensor can be used to change the mode and/or energy level of a user interface. Expressed more generally, this system can comprise an environmentally-aware user interface. In an example, a high level of ambient light can trigger a change from a light-based interface to a sound-based or touch-based interface. In an example, a high level of ambient light can trigger a change for a dim light-based interface to a bright light-based user interface.

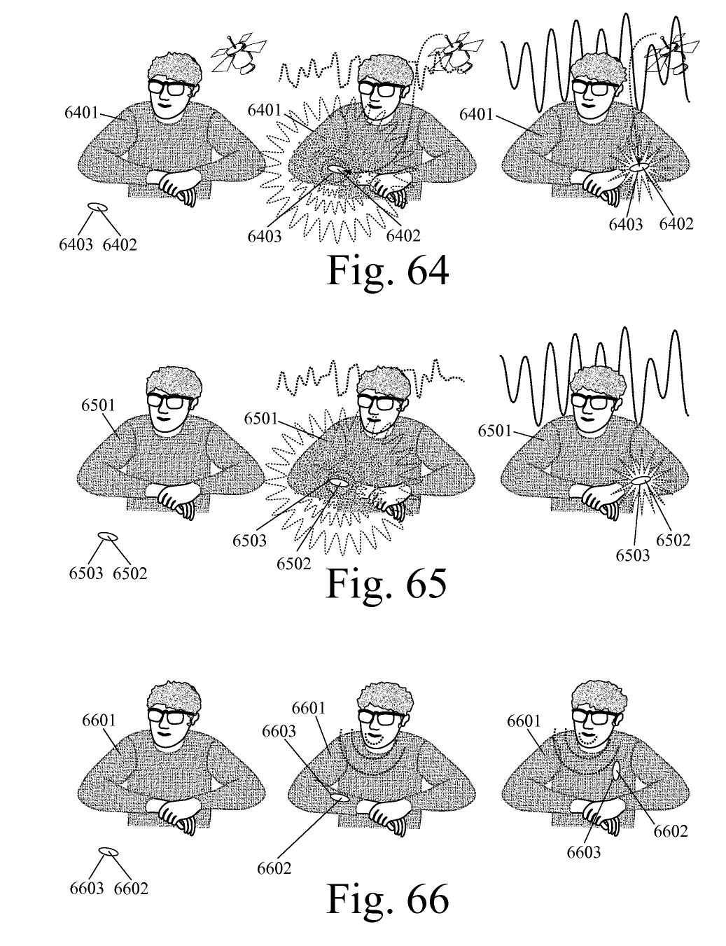

FIG. 64 shows an example of how this invention can be embodied in a system of modular smart clothing (or a modular clothing accessory) for environmentally-aware communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 64, clothing can be selected from the group consisting of “Set A.” In this figure, article of clothing 6401 is a shirt. In FIG. 64, the energy-transducing member can be selected from the group consisting of “Set B.” In this figure, energy-transducing member 6402 is a modular ambient sound sensor whose data is used to modify the mode, energy-level, and/or timing of incoming electronic communication notifications. In FIG. 64, attachment mechanism 6403 can be selected from the group consisting of “Set C.”

In an example, a modular ambient sound sensor can be a microphone. In an example, a person can be notified of incoming electronic communications in a visual, sound-based, or tactile mode. In an example, a person can be notified of incoming electronic communications with low energy level, moderate energy level, or high energy level signal. In an example, a low energy level signal can be a quiet tone, song, or other sound and a high energy level signal can be a loud tone, song, or other sound. In an example, the mode and/or energy level of notifications for incoming electronic communications can be automatically modified based on data from a modular ambient sound sensor.

In an example, an ambient sound level can be measured in decibels. In an example, an overall ambient sound level can be determined by averaging sound levels recorded by a modular sound sensor during a selected interval of time. In an example, an overall ambient sound level can be determined by the minimum sound level recorded by a modular sound sensor during a selected interval of time. In an example, the mode, energy-level, and/or timing of notifications for incoming electronic communications can be modified by the recognition of selected ambient sound patterns. In an example, when ambient sound levels and/or patterns indicate that a person is in a meeting, at a performance, or in another environment in which notification sounds would be disturbing, then the system can automatically provide notifications in a visual or tactile mode. In an example, when ambient sound levels and/or patterns indicate that a person is in a meeting, at a performance, or in another environment in which notification sounds would be disturbing, then the system can automatically provide very quiet notifications. More generally, this system can comprise an environmentally-aware communication notification system.

FIG. 65 shows an example of how this invention can be embodied in a system of modular smart clothing (or a modular clothing accessory) for sound-modified interaction comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 65, clothing can be selected from the group consisting of “Set A.” In this figure, article of clothing 6501 is a shirt. In FIG. 65, the energy-transducing member can be selected from the group consisting of “Set B.” In this figure, energy-transducing member 6502 is a modular ambient sound sensor whose data is used to modify the mode and/or energy level of a user interface. In FIG. 65, attachment mechanism 6503 can be selected from the group consisting of “Set C.”

In an example, a modular ambient sound sensor can be a microphone. In an example, a user interface can be a human-to-computer interface. In an example, a user interface can be a computer-to-human interface. In an example, a user interface can have a visual mode, sound-based mode, and/or tactile mode. In an example, a user interface can have a low energy level, moderate energy level, or high energy level. In an example, a low energy visual interface is dim, but a high energy visual interface is bright. In an example, a low energy sound-based interface is quiet, but a high energy sound-based interface is loud. In an example, a low energy tactile interface vibrates gently, but a high energy tactile interface vibrates vigorously. In an example, the mode and/or energy level of a user interface can be modified based on data from a modular ambient sound sensor. More generally, this system can comprise an environmentally-aware user interface.

In an example, the energy level of sound-based communication from a computer to a person can be automatically increased in response to a high ambient sound level environment. For example, if a person is in a loud night club, then a sound-based interface can be loud. In an example, the energy level of a sound-based communication from a computer to a person can be automatically decreased in response to a low ambient sound level environment. For example, if a person is in a library or subdued meeting, then a sound-based interface can be quiet.

In an example, the mode of communication from a computer to a person can be automatically changed in response to ambient sound level. For example, if a person is in a loud night club, then a computer can automatically communicate with the person in a tactile or visual mode (rather than a sound-based mode) because otherwise the person might not hear the communication. For example, if a person is in a quiet meeting or library, then a computer can automatically communicate with the person in a tactile or visual mode (rather than a sound-based mode) because otherwise the sound might disturb people in the meeting or library.

In an example, an overall ambient sound level can be measured based on the average sound level (e.g. in decibels) during a (rolling) time interval of a selected length. In an example, an overall ambient sound level can be measured based on the minimum sound level (e.g. in decibels) during a (rolling) time interval of a selected length. In an example, an ambient soundscape can be analyzed by sonic pattern recognition to determine environmental context based on sounds. In an example, specific sounds can be unique to specific environmental contexts and a user interface can be modified in accordance with these specific environmental contexts. For example, if movie attendance is associated with a specific sound pattern, then the user interface of a wearable (or mobile) device can be automatically muted when movie attendance is detected based on recognition of that specific sound pattern.

FIG. 66 shows an example of how this invention can be embodied in a system of modular smart clothing (or a modular clothing accessory) for speech recognition comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 66, clothing can be selected from the group consisting of “Set A.” In this figure, article of clothing 6601 is a shirt. In FIG. 66, the energy-transducing member can be selected from the group consisting of “Set B.” In this figure, energy-transducing member 6602 is a modular wearable speech-recognition unit. In FIG. 66, attachment mechanism 6603 can be selected from the group consisting of “Set C.”

In an example, a modular wearable speech-recognition unit can further comprise a microphone and a sound signal processor. In an example, a modular wearable speech-recognition unit can be used in combination with a gesture-recognition unit. In an example, speech-recognition and gesture-recognition data can be analyzed together to provide more accurate information concerning communication content than is possible from separate analysis of either speech or gestures alone. In an example, analysis of words and body language together can provide more accurate information concerning a person's communication than separate analysis of either words or body language alone.

In an example, data from a modular wearable speech-recognition unit can be used to control the operation of a wearable device. In an example, data from a modular wearable speech-recognition unit can be used to modify the characteristics of an article of clothing. In an example, these characteristics can be selected from the group consisting of: color; porosity; fit (e.g. expansion or contraction); and attachment mechanism activation. In an example, a person can change the color, porosity, fit, or attachment of an article of clothing by means of voice commands.

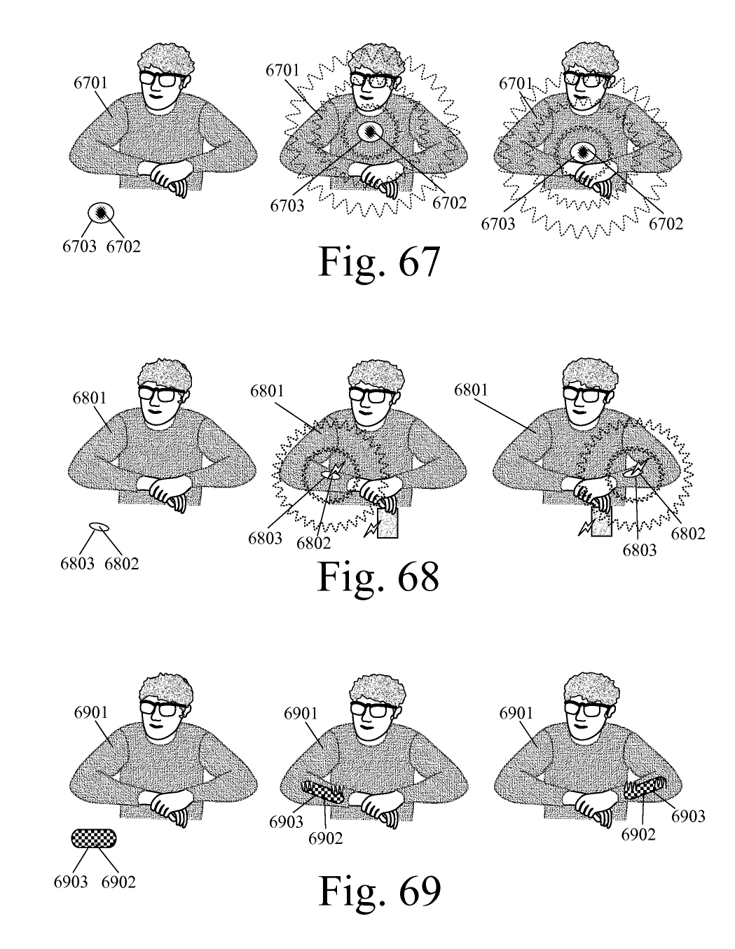

FIG. 67 shows an example of how this invention can be embodied in a system of modular smart clothing (or a modular clothing accessory) for sound masking or cancellation comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 67, clothing can be selected from the group consisting of “Set A.” In this figure, article of clothing 6701 is a shirt. In FIG. 67, the energy-transducing member can be selected from the group consisting of “Set B.” In this figure, energy-transducing member 6702 is a modular sound-emitting member which masks or cancels ambient sound in a three-dimensional region which encompasses the person's ears. In FIG. 67, attachment mechanism 6703 can be selected from the group consisting of “Set C.”

In an example, a modular sound-emitting member comprises one or more speakers. In an example, a modular sound-emitting member emits sounds which mask a wide range of different types of ambient sound. In an example, a modular sound-emitting member can emit white noise or pink noise. In an example, a modular sound-emitting member can emit sounds whose median frequency and/or frequency range is targeted to specifically mask a particular type of ambient sound. In an example, a modular sound-emitting member can be used in combination with a microphone whose data is used to identify the median frequency and/or frequency range which will optimally mask a particular type of ambient sound.

In an example, a modular sound-emitting member can emit sounds which are designed to cancel out the sound waves of ambient sounds, wherein this sonic cancellation occurs in a spatial region which encompasses a person's ears. In an example, a sound-emitting member can create sound waves which have the inverse waveform of ambient sound waves so that the created sound waves and the ambient sound waves cancel each other out in the vicinity of the person's ears.

One of the challenges in cancelling ambient sounds is that the spatial relationship between a person's ears and a sound-cancelling device can change as a person moves. A wearable sound-cancelling system can overcome this problem because the sound-cancelling device can move with the person. In an example, the spatial relationship between a wearable sound-cancelling device and a person's ears can be kept relatively constant. This can enable more accurate targeting of a region of maximum sound cancellation which encompasses the person's ears. One of the problems with sound-cancelling headphones is that the microphones which detect ambient sound are very close to the person's ears and provide little lead time for creating sound-cancelling waves before the ambient sound waves reach the person's ears. A wearable sound-cancelling system with microphones which are located further from a person's ears can provide more lead time for creating sound-cancelling waves before ambient sound waves reach the person's ears. In an example, having microphones on a person's shirt (in a relatively constant spatial relationship with the person's ears) and having speakers near a person's ears can create a system with more lead time to create sound-cancelling waves.

FIG. 68 shows an example of how this invention can be embodied in a system of modular smart clothing (or a modular clothing accessory) for sound-based communication comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 68, clothing can be selected from the group consisting of “Set A.” In this figure, article of clothing 6801 is a shirt. In FIG. 68, the energy-transducing member can be selected from the group consisting of “Set B.” In this figure, energy-transducing member 6802 is modular wearable sound-emitting member which emits sounds based on wireless communication with a separate mobile communication device. In FIG. 68, attachment mechanism 6803 can be selected from the group consisting of “Set C.”

In an example, a modular wearable sound-emitting member can be in wireless communication with a cell phone or other separate mobile electronic communication device. In an example, a modular wearable sound-emitting member can emit sound when a phone call or other incoming electronic communication is received by a mobile electronic communication device. In an example, a modular wearable sound-emitting member can emit sound when the distance between it and a mobile electronic communication device exceeds a selected distance. In an example, the frequency, volume, or waveform of a sound emitted by a modular wearable sound-emitting member can depend on the proximity, orientation, and/or motion of a separate mobile electronic device with which the sound-emitting member is in wireless communication. In an example, a sound-emitting member can emit a specific sound when a cell phone or other separate mobile electronic device is moving away from the person at greater than a specified speed. This can help to provide early warning of potential separation of the person and the phone (or other device) before a distance-based warning would be triggered.

FIG. 69 shows an example of how this invention can be embodied in a system of modular smart clothing (or a modular clothing accessory) for tactile notification comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 69, clothing can be selected from the group consisting of “Set A.” In this figure, article of clothing 6901 is a shirt. In FIG. 69, the energy-transducing member can be selected from the group consisting of “Set B.” In this figure, energy-transducing member 6902 is modular tactile-sensation-creating member. In FIG. 69, attachment mechanism 6903 can be selected from the group consisting of “Set C.”

In an example, a modular tactile-sensation-creating member can create a tactile sensation for a person by a means selected from the group consisting of: vibrating in a direction which is substantially parallel to the surface of a person's body; vibrating in a direction which is substantially perpendicular to the surface of a person's body; rotating around an axis which is substantially perpendicular to the surface of a person's body; moving back and forth along a linear path which is substantially parallel to the surface of a person's body; constricting or expanding around a body member such as a finger, wrist, arm, torso, leg, or ankle; activating protrusion of a subset of potentially-protruding elements in an array or matrix of such elements.

In an example, the pattern, frequency, and/or strength of tactile sensations can communicate information from a computer to a human. In an example, selective protrusion of the individual tactile members in a matrix or array of such tactile members which are in contact with a person's skin can form a pattern of tactile sensation which conveys information. In an example, a specific pattern of activated protruding elements in contact with a person's skin (selected from an array or matrix of potentially-protruding elements) can convey a specific message. In an example, an wearable array or matrix of potentially-protruding elements can transduce an optical text message into a tactile brail message that can be detected by a person wearing the system.

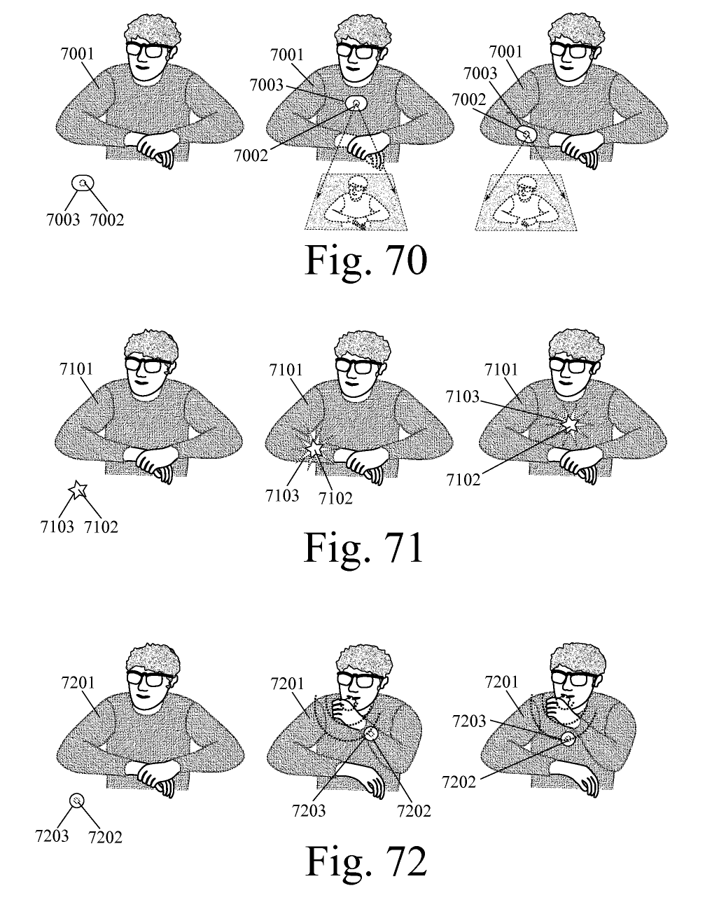

FIG. 70 shows an example of how this invention can be embodied in a system of modular smart clothing (or a modular clothing accessory) for tactile interaction comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 70, clothing can be selected from the group consisting of “Set A.” In this figure, article of clothing 7001 is a shirt. In FIG. 70, the energy-transducing member can be selected from the group consisting of “Set B.” In this figure, energy-transducing member 7002 is a modular wearable image projector. In FIG. 70, attachment mechanism 7003 can be selected from the group consisting of “Set C.”

In an example, a modular wearable image projector can project an image from a person onto an environmental surface by emitting coherent light. In an example, a modular wearable image projector can be used in combination with a wearable motion sensor and/or gesture detector. In an example, the direction of image projection can be controlled by a person's body motion, configuration, and/or gestures. In an example, when a person points in a particular direction, this gesture is detected by a motion sensor and an image is projected in this direction. In an example, especially if a projector which does not project coherent light, then both the direction and focal distance of image projection can be controlled by a person's body motion, configuration, and/or gestures. In an example, a modular wearable image projector can be used in combination with a wearable eye-tracking sensor. In an example, the focal direction and/or focal distance of image projection can be controlled by the focal direction and/or focal distance of a person's gaze as measured by an eye-tracking sensor.

FIG. 71 shows an example of how this invention can be embodied in a system of modular smart clothing (or a modular clothing accessory) with light display functionality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 71, the article of clothing is selected from the group consisting of “Set A.” In this figure, article of clothing 7101 is a shirt. In FIG. 71, the energy-transducing member can be selected from the group consisting of “Set B.” In this figure, energy-transducing member 7102 is a modular light-emitting member that can be removably attached by a person to alternative locations on an article of clothing. In FIG. 71, an attachment mechanism 7103 can be selected from the group consisting of “Set C.” In an example, attachment mechanism 7103 can be a snap, clip, magnet, hook and eye mechanism, plug, and/or electromagnetic connector.

In an example, a modular light-emitting member can be a Light Emitting Diode (LED). In an example, a modular light-emitting member can be removably attached by the person wearing an article of clothing to one of a selected group of alternative locations on the article of clothing by a snap, clip, magnet, hook-and-eye mechanism, electronic plug, or wire connector. In an example, a modular light-emitting member can be removably attached by the person virtually anywhere on an article of clothing by a snap, clip, magnet, hook-and-eye mechanism, electronic plug, or wire connector.

In an example, a plurality of modular light-emitting members can be removably attached by a person to different locations on one or more articles of clothing to creating a customized set of smart clothing for displaying images for entertainment, fashion, motion capture, sports, medical, and/or communication purposes. In an example, each of these light-emitting members can have an independent power source. In an example, each of these light-emitting members can draw power from connection with, or induce power from proximity to, electroconductive fibers in an article of clothing.

FIG. 72 shows an example of how this invention can be embodied in a system of modular smart clothing (or a modular clothing accessory) for monitoring food consumption comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 72, clothing can be selected from the group consisting of “Set A.” In this figure, clothing accessory 7201 is a shirt. In FIG. 72, the energy-transducing member can be selected from the group consisting of “Set B.” In this figure, energy-transducing member 7202 is a modular sonic energy sensor whose data is used to detect and/or measure food consumption. In FIG. 72, attachment mechanism 7203 can be selected from the group consisting of “Set C.”

In an example, a modular sonic energy sensor can be a microphone. In an example, a modular sonic energy sensor can detect and/or record chewing and/or swallowing sounds associated with food consumption. In an example, when a modular sonic energy sensor detects sounds which indicate that a person is probably eating, then this system can prompt the person to provide additional information concerning the types and quantities of food that the person is eating.

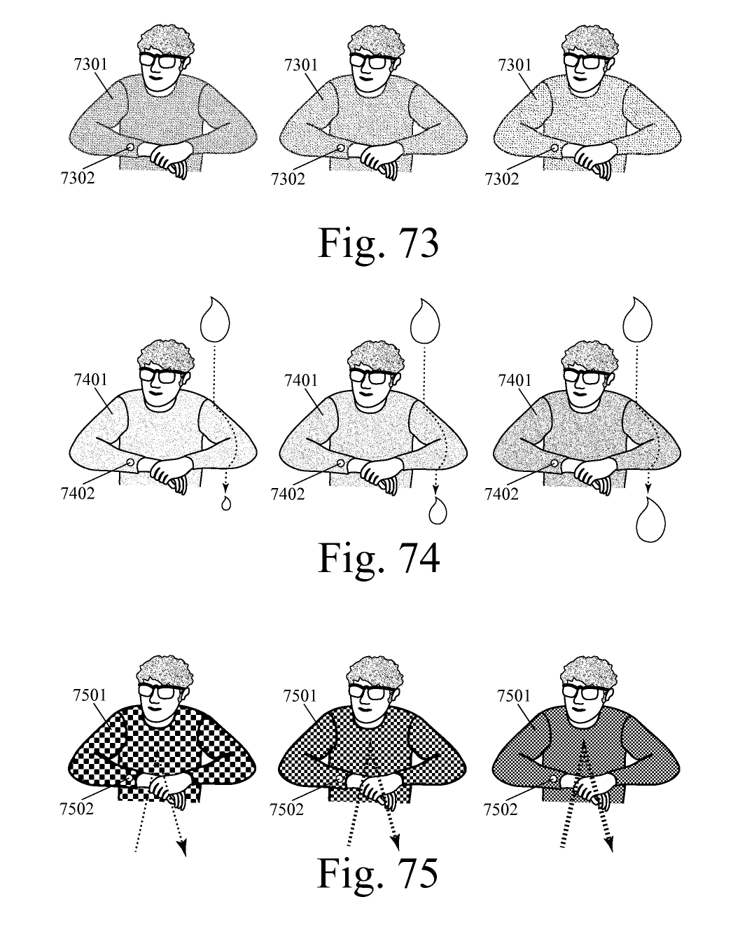

FIG. 73 shows an example of how this invention can be embodied in a system of smart clothing with adjustable porosity comprising: an article of clothing worn by a person; and a plurality of energy-transducing members including 7302 which change the porosity of the article of clothing. In FIG. 73, the clothing can be selected from the group consisting of “Set A.” In this figure, article of clothing 7301 is a shirt. The left side of this figure shows this system in a first configuration with a low level of porosity. The middle portion of this figure shows this system with a second configuration with a moderate level of porosity. The right side of this figure shows this system in a third configuration with a high level of porosity.

In an example, a plurality of actuators can be woven, or otherwise integrated, into an article of clothing. In an example, a plurality of actuators can be woven, or otherwise integrated, into the fabric of an article of clothing and their activation can change the porosity of the clothing. In an example, these actuators can be microscale actuators. In an example, these actuators can be Micro Electrical Mechanical System (MEMS) actuators. In an example, these actuators can be piezoelectric actuators. In an example, these actuators can be danconnor (DC) motors. In an example, an article of clothing can have a first configuration with a first level of fabric porosity to gas and/or liquid. In an example, an article of clothing can have a second configuration with a second level of fabric porosity to gas and/or liquid. In an example, activation of a plurality of actuators in the clothing can change the clothing from the first configuration to the second configuration.

In an example, a person can initiate activation of a plurality of fabric-integrated actuators in order to adjust the porosity of an article of clothing. In an example, a plurality of fabric-integrated actuators can be automatically activated in order to adjust the porosity of an article of clothing based on data from one of more wearable sensors. In an example, a wearable sensor can be selected from the group consisting of: moisture sensor, thermal energy sensor, blood pressure sensor, electromagnetic energy sensor, and motion sensor. In an example, when a sensor indicates that a person is sweaty or hot, then this system can activate a plurality of fabric-integrated micro-actuators in order to increase the porosity of an article of clothing worn by the person.

FIG. 74 shows an example of how this invention can be embodied in a system of smart clothing with adjustable water resistance comprising: an article of clothing worn by a person; and a plurality of energy-transducing members including 7402 which change the water resistance of the article of clothing. In FIG. 74, the clothing can be selected from the group consisting of “Set A.” In this figure, article of clothing 7401 is a shirt. The left side of this figure shows this system in a first configuration with a low level of water resistance. The middle portion of this figure shows this system with a second configuration with a moderate level of water resistance. The right side of this figure shows this system in a third configuration with a high level of water resistance.

In an example, a plurality of actuators can be woven, or otherwise integrated, into an article of clothing. In an example, a plurality of actuators can be woven, or otherwise integrated, into the fabric of an article of clothing and their activation can change the water resistance of the clothing. In an example, these actuators can be microscale actuators. In an example, these actuators can be Micro Electrical Mechanical Systems (MEMS) actuators. In an example, these actuators can be piezoelectric actuators. In an example, an article of clothing can have a first configuration with a first level of water resistance. In an example, an article of clothing can have a second configuration with a second level of water resistance. In an example, activation of a plurality of actuators in the clothing can change the clothing from the first configuration to the second configuration.

In an example, a person can initiate activation of a plurality of fabric-integrated actuators in order to increase the water resistance of an article of clothing if the person is caught in the rain or some other wet environment. In an example, a plurality of actuators can be used in combination with one or more moisture sensors. In an example, when a moisture sensor on the outside of an article of clothing detects moisture, then a plurality of fabric-integrated actuators can be automatically activated in order to increase the water resistance of the clothing. In an example, when a moisture sensor on the inside of an article of clothing detects moisture, then a plurality of fabric-integrated actuators can be automatically activated in order to decrease the water resistance of the clothing.

FIG. 75 shows an example of how this invention can be embodied in a system of smart clothing with adjustable puncture resistance comprising: an article of clothing worn by a person; and a plurality of energy-transducing members including 7502 which change the puncture resistance of the article of clothing. In FIG. 75, the clothing can be selected from the group consisting of “Set A.” In this figure, article of clothing 7501 is a shirt. The left side of this figure shows this system in a first configuration with a low level of puncture resistance. The middle portion of this figure shows this system with a second configuration with a moderate level of puncture resistance. The right side of this figure shows this system in a third configuration with a high level of puncture resistance.

In an example, a plurality of actuators can be woven, or otherwise integrated, into an article of clothing. In an example, a plurality of actuators can be woven, or otherwise integrated, into the fabric of an article of clothing and their activation can change the puncture resistance of the clothing. In an example, these actuators can be microscale actuators. In an example, these actuators can be Micro Electrical Mechanical Systems (MEMS) actuators. In an example, these actuators can be piezoelectric actuators. In an example, an article of clothing can have a first configuration with a first level of puncture resistance. In an example, an article of clothing can have a second configuration with a second level of puncture resistance. In an example, activation of a plurality of actuators in the clothing can change the clothing from the first configuration to the second configuration.

In an example, a person can activate a plurality of actuators which cause metal fibers (or other metal members) in clothing to link, lock, or join together. In an example, when the metal fibers (or other metal members) link, lock, or join together, they increase the puncture resistance of the clothing. In an example, when the metal fibers (or other metal members) link, lock, or join together, the cause the clothing to become bullet proof.

In an example, an article of clothing can include a plurality of metal fibers, strands, and/or longitudinal members. In an example, this article of clothing can have a first configuration in which the metal fibers, strands, and/or longitudinal members are not linked, locked, or joined and can have a second configuration in which these metal fibers, strands, and/or longitudinal members are linked, locked, or joined. In an example, this article of clothing can further comprise a plurality of actuators whose activation changes the article of clothing from the first configuration to the second configuration. In an example, the second configuration is more resistant to puncture than the first configuration. In an example, the article of clothing can have the puncture resistance level of a bullet proof vest in the second configuration.

In an example, such an article of clothing can further comprise a sound sensor or pressure sensor. In an example, a plurality of actuators can be activated by data from a sound sensor or pressure sensor in order to automatically cause metal fibers (or other metal members) in clothing to link together. In an example, this smart clothing can be flexible and breathable in a first configuration when there is no danger of puncturing and can become inflexible and puncture resistant when there is danger of puncturing.

In an example, a sound sensor can detect the sound pattern of a firearm. In an example, when a sound sensor detects the sound pattern of a firearm, it can activate a plurality of actuators which transform an article of clothing for a first (less puncture resistant) configuration to a second (more puncture resistant) configuration. In an example, one or more sound sensors can also detect the direction from which this sound pattern is coming In an example, the portion of an article of clothing facing the direction from which this sound pattern is coming can be selectively activated to increase the puncture resistance of this portion.

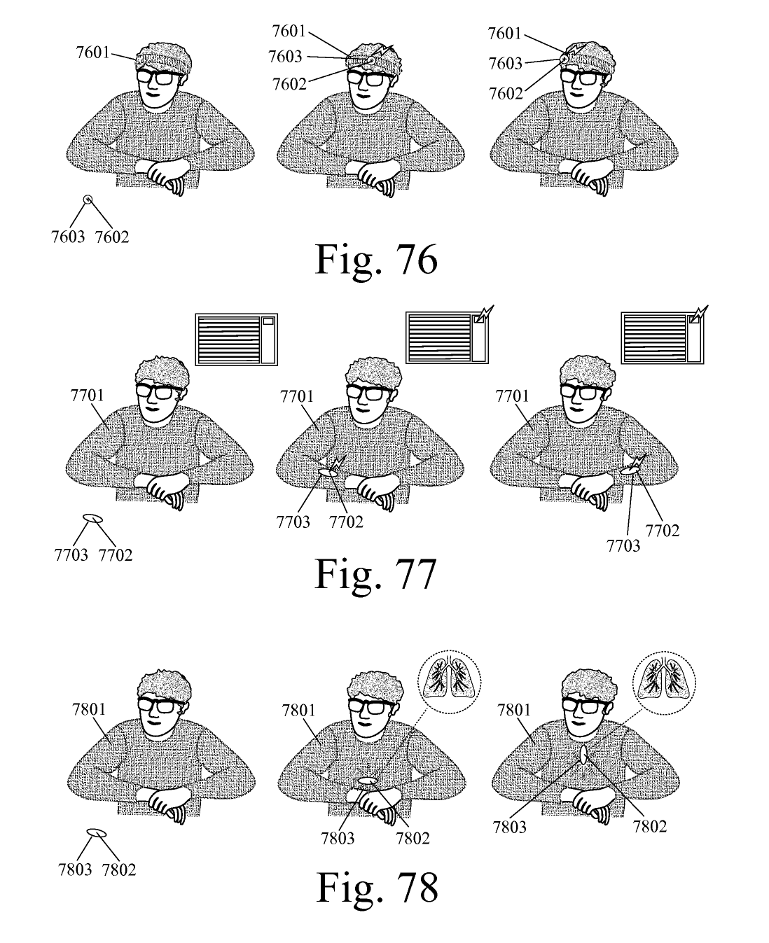

FIG. 76 shows an example of how this invention can be embodied in a system of modular smart clothing (or a modular clothing accessory) with bioidentification functionality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 76, clothing (or an accessory) can be selected from the group consisting of “Set A.” In this figure, article of clothing 7601 is a shirt. In FIG. 76, the energy-transducing member can be selected from the group consisting of “Set B.” In this figure, energy-transducing member 7602 is modular bioidentification member. In FIG. 76, attachment mechanism 7603 can be selected from the group consisting of “Set C.”

In an example, a bioidentification member can be an electromagnetic energy sensor whose data is used to identify patterns of electrical energy emitted from one or more of a person's organs which are unique to that person. In an example, the organ can be the person's brain, heart, or lungs. In an example, the electromagnetic energy sensor can be an EEG sensor, ECG sensor, or pulmonary function sensor. In an example, a bioidentification member can be a wearable retinal scanner which is incorporated into electronically-functional eyewear. In an example, a bioidentification member can be an optical scanner which is worn on a person's finger or hand, wherein this scanner can identify the unique features of a person's finger contours or palm lines.

In an example, a bioidentification member can comprise a voice recognition component and a vibration sensing component. In an example, simultaneous identification of a person's voice and identification of vibration patterns on their throat or chest while they speak can combine to identify the person more reliably and/or accurately than either voice identification or vibration identification alone. In an example, a person can removably attach a plurality of biometric sensors to an article of clothing in order to create a customized set of smart clothing for bioidentification purposes.

In an example, a bioidentification member can comprise a wearable EEG monitor which measures the electromagnetic activity of person's brain in response to selected content which is displayed on a wearable display. In an example, a person can have a uniquely-identifiable pattern of brain activity in response to a selected image or other content displayed on a wearable display. In an example, the combination of display of this content and measure of this brain activity pattern can be used to identify the wearer of a device.

FIG. 77 shows an example of how this invention can be embodied in a system of modular smart clothing (or a modular clothing accessory) for home device control comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 77, clothing (or an accessory) can be selected from the group consisting of “Set A.” In this figure, article of clothing (or clothing accessory) 7701 is a shirt. In FIG. 77, the energy-transducing member can be selected from the group consisting of “Set B.” In this figure, energy-transducing member 7702 is a wearable home control module. In FIG. 77, attachment mechanism 7703 can be selected from the group consisting of “Set C.”

In an example, a wearable home control module can remotely control the operation of a home environmental control system. In an example, a wearable home control module can remotely control the operation of a Heating Ventilation and Air Conditioning (HVAC) system. In an example, a wearable home control module can remotely control the operation of one or more home appliances and/or devices selected from the group consisting of: air conditioner, ceiling light, coffee maker, dehumidifier, dish washer, door lock, door opener, dryer, fan, freezer, furnace, heat pump, home entertainment center, home robot, hot tub, humidifier, microwave, music player, oven, swimming pool, refrigerator, security camera, electronic guard chicken, sprinkler system, stand-alone lights, television, wall light, washing machine, water heater, water purifier, water softener, window lock, window opener, and wireless network.

In an example, a person can manually control one or more home appliances and/or devices through a wearable home control module. In an example, a wearable home control modular can control one or more home appliances and/or devices based on data from one or more wearable sensors. In an example, these one or more wearable sensors can be selected from the group consisting of: thermal energy sensor; electromagnetic energy sensor; moisture sensor or humidity sensor; light energy sensor; motion sensor; sound sensor; and biochemical sensor. In an example, a thermal energy sensor can be a thermistor, thermometer, or thermopile. In an example, a wearable sensor can be selected from the group consisting of: wearable EEG sensor; wearable ECG sensor; and wearable EMG sensor.

In an example, when data from a wearable thermal energy sensor indicates that a person is too hot, then this can trigger activation of a home air conditioning system (or window unit) to lower the ambient temperature in the home. In an example, when data from a wearable moisture sensor indicates that a person is sweaty, then this can trigger activation of a home air conditioning system (or window unit) to lower the ambient temperature in the home. In an example, a wearable home control module can control the environment of a home as a whole in response to data from a wearable sensor. In an example, a wearable home control modular can selectively control the environment of a particular room in which a person is located in response to data from a wearable sensor on that person.

In an example, the combination of a wearable home control module, wearable sensors, and a home environmental control system can help to maintain a comfortable environment for a person while saving energy on home environment modification. In an example, a system which integrates data from wearable sensors and a home environmental control system can selectively modify (e.g. heat or cool) only the room wherein a person is currently located. In an example, a system which integrates data from wearable sensors and a home environmental control system can selectively modify (e.g. heat or cool) only a room wherein a person is located whose wearable sensors indicate that the person is too hot or cold. In an example, a home environmental control system need not modify the environment in a room as long as there in no person in that room and/or as long as no person in that room is too hot or too cold based on wearable sensors. This can conserve energy used for HVAC.

FIG. 78 shows an example of how this invention can be embodied in a system of modular smart clothing (or a modular clothing accessory) for measuring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 78, clothing can be selected from the group consisting of “Set A.” In this figure, article of clothing 7801 is a shirt. In FIG. 78, the energy-transducing member can be selected from the group consisting of “Set B.” In this figure, energy-transducing member 7802 is a modular light energy sensor whose data is used to measure a person's pulmonary and/or respiratory functioning. In FIG. 78, attachment mechanism 7803 can be selected from the group consisting of “Set C.”

In an example, a modular light energy sensor can be used in combination with a modular light energy emitter. In an example, this light can be visible, infrared, and/or ultraviolet. In an example, this light can be coherent. In an example, a modular light energy sensor can measure changes in light energy transmitted from a light energy emitter through light energy pathways in an article of clothing. In an example, movement of a person's chest and/or torso during breathing changes the shapes of light energy pathways in an article of clothing worn on the chest or torso. In an example, these changes in pathway shapes change the intensity, color, spectrum, phase, and/or polarization of light energy transmitted through these pathways.

In an example, a modular light energy sensor measures these changes in light intensity, color, spectrum, phase, and/or polarization and data from this sensor is used to monitor and/or measure the person's pulmonary and/or respiratory functioning. In an example, data from a modular light energy sensor can be used to measure parameters of a person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

In an example, light energy pathways through an article of clothing can be selected from the group consisting of: optical fiber, light-conducting fibers, variable-translucence fiber, and metamaterial pathway. In an example, a modular light energy sensor can be selected from the group consisting of: optical sensor, optoelectronic sensor, photoelectric sensor, light intensity sensor, light-spectrum-analyzing sensor, spectral analysis sensor, spectrometry sensor, spectrophotometer sensor, spectroscopic sensor, spectroscopy sensor, infrared light sensor, laser sensor, ultraviolet light sensor, fluorescence sensor, and variable-translucence sensor.

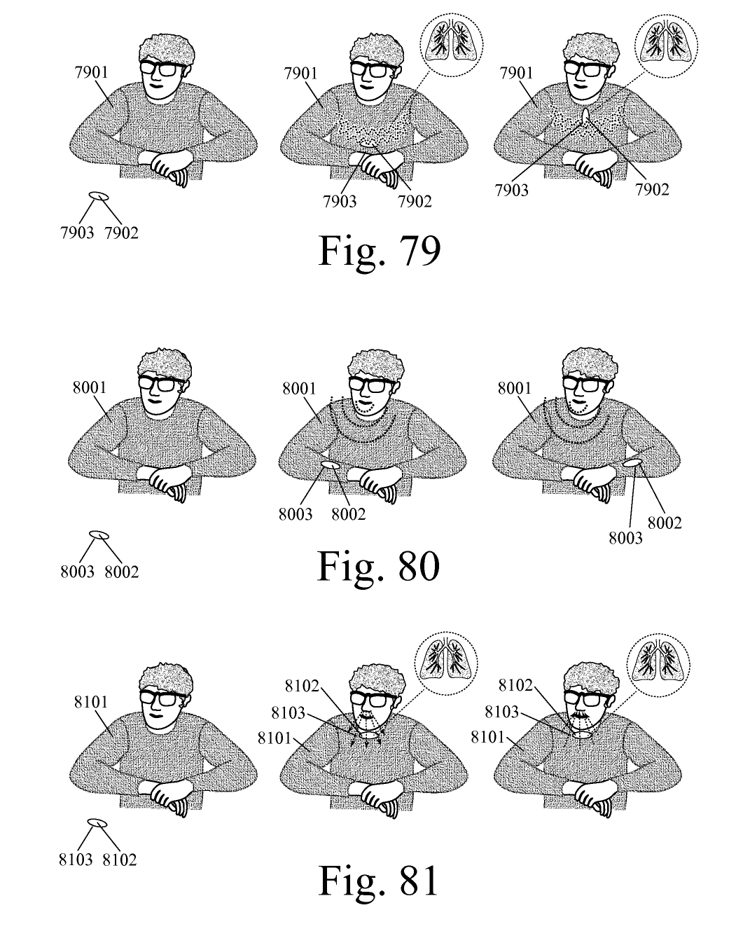

FIG. 79 shows an example of how this invention can be embodied in a system of modular smart clothing (or a modular clothing accessory) for measuring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 79, clothing can be selected from the group consisting of “Set A.” In this figure, article of clothing 7901 is a shirt. In FIG. 79, the energy-transducing member can be selected from the group consisting of “Set B.” In this figure, energy-transducing member 7902 is a modular wearable sonic energy sensor whose data is used to measure a person's pulmonary and/or respiratory functioning. In FIG. 79, attachment mechanism 7903 can be selected from the group consisting of “Set C.”

In an example, a modular wearable sonic energy sensor can be a microphone. In an example a modular wearable sonic energy sensor can monitor and/or record sounds associated with a person's breathing. In an example, data from a wearable sonic energy sensor can be used to measure the frequency, rate, volume, and/or consistency of a person's breathing. In an example, data from a wearable sonic energy sensor can detect respiratory congestion based on analysis of breathing sounds.

In an example, a modular wearable sonic energy sensor can be used in combination with a modular wearable sonic energy emitter. In an example, a wearable sonic energy emitter can emit audible sound energy which is transmitted through, or reflected from, lung tissue and then measured by a wearable sonic energy sensor. In an example, a wearable sonic energy emitter can emit ultrasonic sound energy which is transmitted through, or reflected from, lung tissue and then measured by a wearable sonic energy sensor. In an example, analysis of changes in the magnitude, frequency, and/or waveform of sonic energy which is transmitted through, or reflected from, lung tissue can be used to measure the frequency, rate, volume, clarity, and/or consistency of a person's respiration.

In an example, data from a modular wearable sonic energy sensor can be used to measure parameters of a person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

FIG. 80 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 80, clothing can be selected from the group consisting of “Set A.” In this figure, article of clothing 8001 is a shirt. In FIG. 80, the energy-transducing member can be selected from the group consisting of “Set B.” In this figure, energy-transducing member 8002 is modular sound sensor. In FIG. 80, attachment mechanism 8003 can be selected from the group consisting of “Set C.”

In an example, a modular sound sensor can be selected from the group consisting of: microphone, electronic stethoscope, ambient noise sensor, audiometer, and ultrasound monitor. In an example, this sound sensor can be used in combination with a sound emitting member. In an example, this modular sound sensor can comprise part of a user interface. In an example, this modular sensor can collect real-time diagnostic physiological data.

FIG. 81 shows an example of how this invention can be embodied in a system of modular smart clothing (or a modular clothing accessory) for measuring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle and right side shows the second configuration.

In FIG. 81, clothing can be selected from the group consisting of “Set A.” In this figure, article of clothing 8101 is a shirt. In FIG. 81, the energy-transducing member can be selected from the group consisting of “Set B.” In this figure, energy-transducing member 8102 is a modular wearable air pressure sensor and/or air flow sensor whose data is used to measure a person's pulmonary and/or respiratory functioning. In FIG. 81, attachment mechanism 8103 can be selected from the group consisting of “Set C.”

In an example, a modular wearable air pressure sensor and/or air flow sensor can be worn in proximity to a person's nose, sinuses, and/or mouth. In an example, a modular wearable air pressure and/or air flow sensor can measure the pressure and/or air speed of air movement into a person's body during inhalation. In an example, a modular air pressure and/or air flow sensor can measure the pressure and/or air speed of air movement out of a person's body during exhalation. In an example, a modular wearable air pressure sensor and/or air flow sensor can be a stand-alone device. In an example, a modular wearable air pressure sensor and/or air flow sensor can be integrated into a respiratory mask which covers a person's nose and/or mouth.

In an example, data from a modular wearable air pressure sensor and/or air flow sensor can be used to measure parameters of the person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

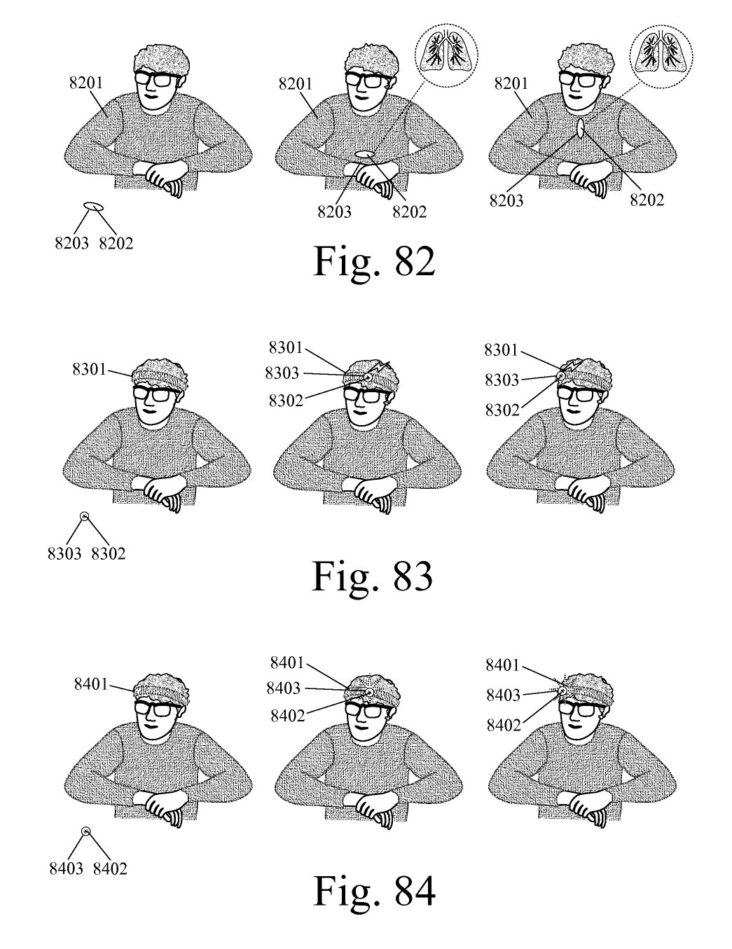

FIG. 82 shows an example of how this invention can be embodied in a system of modular smart clothing (or a modular clothing accessory) for measuring pulmonary function comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 82, clothing can be selected from the group consisting of “Set A.” In this figure, article of clothing 8201 is a shirt. In FIG. 82, the energy-transducing member can be selected from the group consisting of “Set B.” In this figure, energy-transducing member 8202 is a modular wearable pressure sensor whose data is used to measure a person's pulmonary and/or respiratory functioning. In FIG. 82, attachment mechanism 8203 can be selected from the group consisting of “Set C.”

In an example, a modular wearable pressure sensor can be in direct contact with a person's chest and/or torso to measure motion of the surface of the person's body which is associated with the person's respiration. In an example, a modular wearable pressure sensor can be in fluid and/or gaseous communication with one or more liquid and/or gas filled channels in an article of clothing which a person wears on their chest and/or torso. In an example, one or more liquid, gas, or gel filled tubes or channels can span all (or a portion) of the lateral circumference of a person's chest and/or torso. In an example, one or more modular pressure sensors can measure changes in the pressure levels in these tubes or channels. In an example, movement of a person's diaphragm, lungs, and/or chest during respiration cause changes in pressure in a modular wearable pressure sensor.

In an example, data from a modular wearable pressure sensor can be used to measure parameters of the person's pulmonary and/or respiratory functioning selected from the group consisting of: diffusing capacity, expiratory reserve volume, forced expiratory time, functional residual capacity, inspiratory capacity, inspiratory reserve volume, lung capacity, peak expiratory flow, residual volume, respiration frequency, respiration rate, respiration volume, respiratory congestion level, respiratory consistency, and tidal volume.

FIG. 83 shows an example of how this invention can be embodied in a system of modular smart clothing (or a modular clothing accessory) for measuring brain activity comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 83, clothing can be selected from the group consisting of “Set A.” In this figure, article of clothing 8301 is a headband. In another example, this article of clothing can be an upper-body garment with a hood—such as a “hoodie”—which may enable the CEO of a major social network to access his homepage by just thinking about it. In FIG. 83, the energy-transducing member can be selected from the group consisting of “Set B.” In this figure, energy-transducing member 8302 is a modular electromagnetic brain activity sensor. In FIG. 83, attachment mechanism 8303 can be selected from the group consisting of “Set C.”

In an example, a modular electromagnetic brain activity sensor can be an electrode. In an example, a modular electromagnetic brain activity sensor can be an ElectroEncephaloGram (EEG) sensor. In an example, a modular electromagnetic brain activity sensor can measure naturally-occurring electromagnetic brain activity signals which are emitted from the brain. In an example, a modular electromagnetic brain activity sensor can be used in combination with an electromagnetic energy emitter. In an example, a modular electromagnetic brain activity sensor can measure changes in the voltage, conductivity, resistance, capacitance and/or impedance of electromagnetic energy transmitted from an electromagnetic energy emitter through a portion of a person's head. In an example, a modular electromagnetic brain activity sensor can be in direct contact with the surface of a person's head. In an example, a modular electromagnetic brain activity can be a dry electrode. In an example, a modular electromagnetic brain activity sensor can measure electromagnetic energy which is induced in a portion of a headband (by electromagnetic induction).

In an example, data from a single modular electromagnetic brain activity sensor can be called a “channel.” In an example, data from a plurality of modular electromagnetic brain activity sensors can be called a “montage.” In an example, one or more electromagnetic brain activity sensors can be removably attached by the person who wears the headband to one or more locations on a headband. In an example, the headband can be elastic and/or stretchable.

In an example, these one or more locations can be configured, when the headband is worn, to be selected from the group of electrode sites consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, one or more reference locations can be selected from sites A1 and A2. In an example, a person can removably attach a plurality of modular electromagnetic brain activity sensors to different locations on a headband in order to create a customized wearable brain activity monitor which optimally measures their electromagnetic brain activity.

FIG. 84 shows an example of how this invention can be embodied in a system of modular smart clothing (or a modular clothing accessory) for measuring brain activity comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 84, clothing can be selected from the group consisting of “Set A.” In this figure, article of clothing 8401 is a headband. In an alternative example, this article of clothing can be an upper-body garment with a hood—such as a “hoodie.” In FIG. 84, the energy-transducing member can be selected from the group consisting of “Set B.” In this figure, energy-transducing member 8402 is a modular light energy sensor whose data is used to measure a person's brain activity. In FIG. 84, attachment mechanism 8403 can be selected from the group consisting of “Set C.”

In an example, a modular light energy sensor can be used in combined with a modular light energy emitter. In an example, a modular light energy sensor can measure changes in the intensity, color, spectrum, phase, and/or coherence of light energy transmitted from a light energy emitter and reflected from, or passing through, a portion of a person's head. In an example, this light energy can be visible, infrared, and/or ultraviolet. In an example, this light energy can be coherent. In an example, a modular light energy sensor can measure blood flow in a person's brain. In an example, a modular light energy sensor can be a HemoEncephaloGraphy (HEG) sensor. In an example, a modular light energy sensor can measure the oxygen level in a person's brain. In an example, a modular light energy sensor can be a cerebral oximetry sensor.

In an example, a modular light energy sensor can be selected from the group consisting of: light-spectrum-analyzing sensor, spectral analysis sensor, spectrometry sensor, spectrophotometer sensor, spectroscopic sensor, spectroscopy sensor, mass spectrometry sensor, white light spectroscopy sensor, near-infrared spectroscopy sensor, infrared spectroscopy sensor, ultraviolet spectroscopy sensor, infrared light sensor, laser sensor, ultraviolet light sensor, fluorescence sensor, chemiluminescence sensor, color sensor, chromatography sensor, analytical chromatography sensor, gas chromatography sensor, optoelectronic sensor, photoelectric sensor, light polarity sensor, and light intensity sensor.

In an example, a plurality of modular light energy emitters and light energy sensors can be removably attached by a person to multiple locations on a head-worn article of clothing (such as a headband). In an example, a headband can be elastic and/or stretchable. In an example, these one or more locations can be configured to be selected from the group of sensor locations consisting of: FP1, FPz, FP2, AF7, AF5, AF3, AFz, AF4, AF6, AF8, F7, F5, F3, F1, Fz, F2, F4, F6, F8, FT7, FC5, FC3, FC1, FCz, FC2, FC4, FC6, FT8, T3/T7, C3, C4, C1, Cz, C2, C5, C6, T4/T8, TP7, CP5, CP3, CP1, CPz, CP2, CP4, CP6, TP8, T5/P7, P5, P3, P1, Pz, P2, P4, P6, T6/P8, PO7, PO5, PO3, POz, PO4, PO6, PO8, O1, Oz, and O2. In an example, a person can removably attach a plurality of modular light energy emitters and light energy sensors to different locations on a head-worn article of clothing (such as a headband) in order to create a customized wearable brain activity monitor.

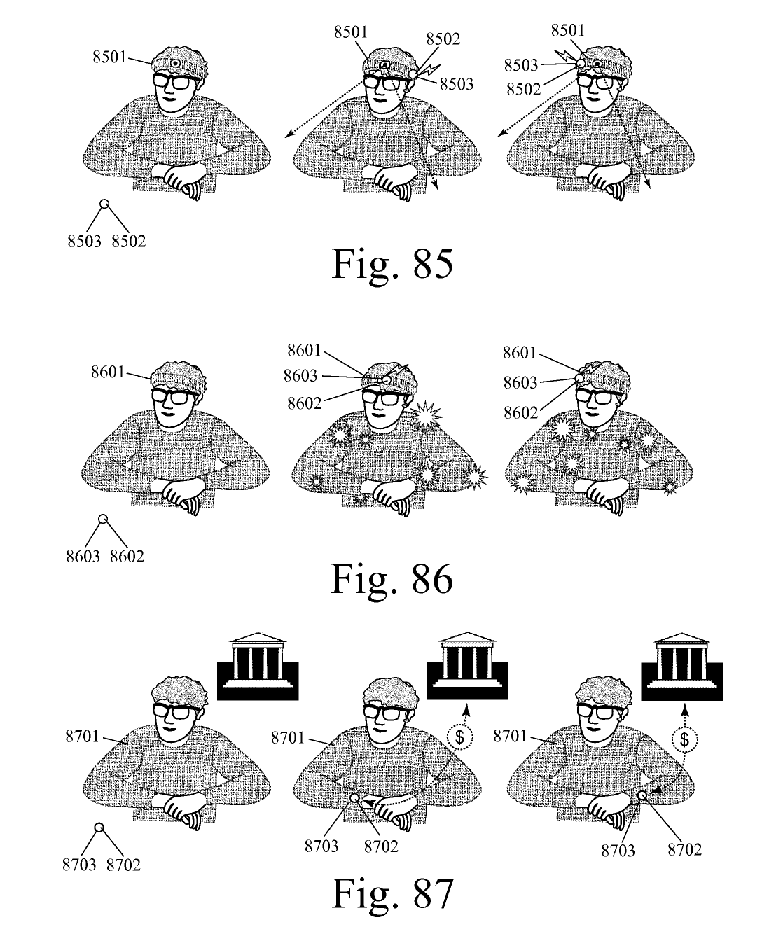

FIG. 85 shows an example of how this invention can be embodied in a system of modular smart clothing (or a modular clothing accessory) controlling a wearable imaging device comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 85, clothing can be selected from the group consisting of “Set A.” In this figure, article of clothing 8501 is a headband. In another example, an article of clothing can be an upper-body garment with a hood. In FIG. 85, the energy-transducing member can be selected from the group consisting of “Set B.” In this figure, energy-transducing member 8502 is a modular electromagnetic brain activity sensor whose data is used to control a wearable imaging device. In FIG. 85, attachment mechanism 8503 can be selected from the group consisting of “Set C.”

In a modular electromagnetic brain activity sensor can be an EEG sensor. In an example, a modular electromagnetic brain activity sensor can be used in combination with an electromagnetic energy emitter. In an example, a modular electromagnetic brain activity sensor can measure changes in the voltage, conductivity, resistance, capacitance and/or impedance of electromagnetic energy transmitted from an electromagnetic energy emitter through a person of a person's head. In an example, these changes in electromagnetic energy can be analyzed used Fourier transformation methods to decompose them into signals in different frequency bands.

In an example, the relative and/or combinatorial power of electromagnetic energy in different frequency bands can be used to control the operation of a wearable imaging device. In an example, a wearable imaging device can be activated to record images by a selected pattern of electromagnetic brain activity detected by a modular electromagnetic brain activity sensor. In an example, the activation, focal direction, and/or focal distance of a wearable imaging device can be changed based on changes a person's electromagnetic brain activity as measured by a modular electromagnetic brain activity sensor. In an example, the portion of the light spectrum which is imaged by a wearable imaging device can be changed based on changes in a person's electromagnetic activity.

In an example, images from a wearable imaging device can be displayed in real time to a person wearing the device. In an example, images from a wearable imaging device can be displayed to a person via electronically-functional eyewear in real time. In an example, a wearable imaging device can capture images of a person's environment from a perspective which is otherwise outside the person's natural field of vision. In an example, a wearable imaging device can record and display images of a person's environment which are behind their back. In an example, a person can activate recording and/or displaying such rear-facing images by self-modifying their electromagnetic brain activity. In an example, images of a person's environment which are outside their natural field of vision can be recorded and displayed when a person increases or decreases the relative power of electromagnetic signals in a selected frequency band. In an example, this embodiment of this invention can enable a person to effectively have “eyes in the back of their head.”

FIG. 86 shows an example of how this invention can be embodied in a system of modular smart clothing (or a modular clothing accessory) with light display functionality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 86, clothing can be selected from the group consisting of “Set A.” In this figure, article of clothing 8601 is a headband. In another example, this component can be a “hoodie” or a hat. In FIG. 86, the energy-transducing member can be selected from the group consisting of “Set B.” In this figure, energy-transducing member 8602 is a modular electromagnetic brain activity sensor whose data is used to change the activations, intensities, and/or colors of a plurality of wearable light-emitting members. In FIG. 86, attachment mechanism 8603 can be selected from the group consisting of “Set C.”

In an example, a modular electromagnetic brain activity sensor can be an EEG sensor. In an example, a modular electromagnetic brain activity sensor can be used in combination with a modular electromagnetic energy emitter. In an example, a modular electromagnetic brain activity sensor can measure changes in the voltage, conductivity, resistance, capacitance and/or impedance of electromagnetic energy transmitted from an electromagnetic energy sensor through a portion of a person's head. In an example, changes in this electromagnetic energy transmission can be used to control changes in the activations, intensities, and/or colors of a plurality of light-emitting members which are worn by the person. In an example, different patterns of electromagnetic brain activity can cause different light display patterns.

In an example, a person can removably attach one or more electromagnetic brain activity sensors to a headband, hoodie, or hat in order to create a customized wearable EEG monitor for optimal, mobile measurement of their electromagnetic brain activity. In an example, the person can also removably attach a plurality of light-emitting members to the headband, hoodie, or hat in order to create a customized light display array for activation by their electromagnetic brain activity. In an example, these light-emitting members can be LEDs. In an example, creating different light patterns based on different brain activity patterns can serve entertainment, performance art, sports, medical, security, and/or communication purposes.

FIG. 87 shows an example of how this invention can be embodied in a system of modular smart clothing (or a modular clothing accessory) comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 87, clothing can be selected from the group consisting of “Set A.” In this figure, article of clothing 8701 is a shirt. In FIG. 87, the energy-transducing member can be selected from the group consisting of “Set B.” In this figure, energy-transducing member 8702 is a modular wearable financial transaction member. In FIG. 87, attachment mechanism 8703 can be selected from the group consisting of “Set C.”

In an example, a modular wearable financial transaction member can be a motion sensor which is linked to a financial account, wherein a selected motion triggers a financial transaction. In an example, a selected motion relative to a physical product can trigger a purchase of that product. In an example, a selected motion relative to a virtual product and/or product code can trigger a purchase of that product. In an example, a modular wearable financial transaction member can be an electromagnetic energy sensor or energy emitter, wherein positioning this sensor or emitter in a selected location and/or configuration with respect to a physical product can trigger a purchase of that product. In an example, positioning this sensor or emitter in a selected location and/or configuration with respect to a virtual product and/or product code can trigger a purchase of that product. In an example, this system can be an astro teller—providing a banking interface during space missions.

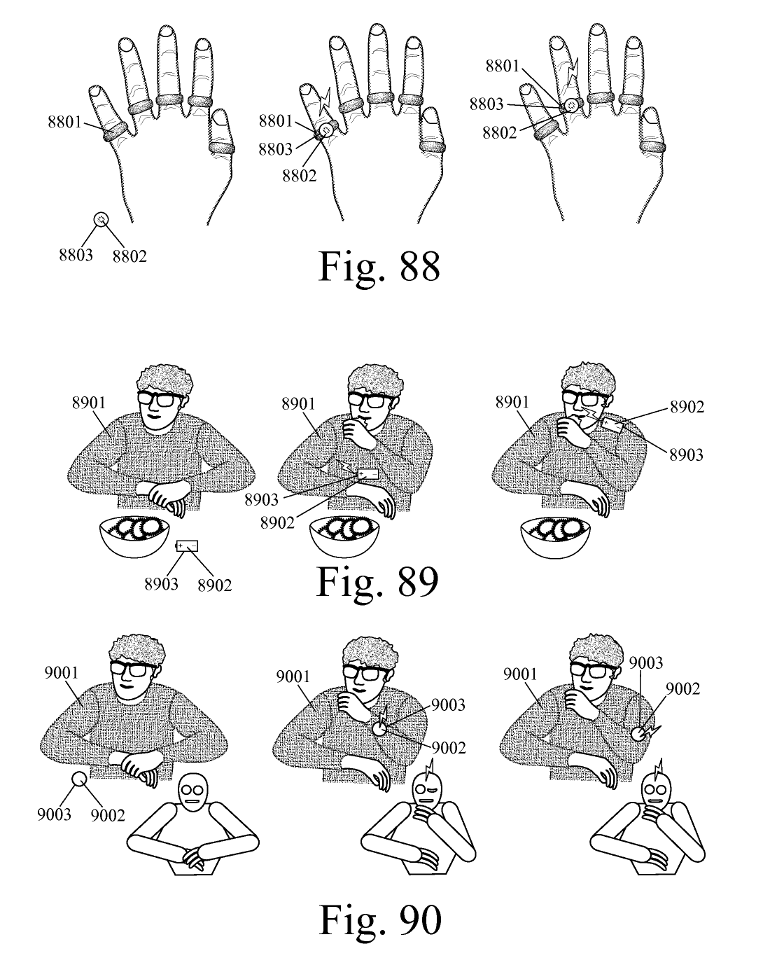

FIG. 88 shows an example of how this invention can be embodied in a system of modular smart clothing (or a modular clothing accessory) with gesture recognition functionality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 88, a clothing accessory can be selected from the group consisting of “Set A.” In this figure, a clothing accessory 8801 is a modular finger ring. In FIG. 88, the energy-transducing member can be selected from the group consisting of “Set B.” In this figure, energy-transducing member 8802 is a modular electromagnetic energy sensor which measures natural electromagnetic energy which is emitted by muscles and associated efferent nerves. In FIG. 88, attachment mechanism 8803 can be selected from the group consisting of “Set C.”

In an example, a person can wear one or more finger rings, wherein each ring has an electromagnetic energy sensor which measures electromagnetic energy which is emitted from finger and/or hand muscles (and associated efferent nerves) when muscles are activated. In an example, an electromagnetic energy sensor can be an EMG sensor. In an example, data from these one or more finger rings can be used to recognize finger and/or hand gestures. In an example, one or more finger rings can be modular. In an example, electromagnetic energy sensors can be modular. In an example, finger and/or hand gestures recognized by data from electromagnetic energy sensors on a plurality of finger rings can function as a gesture-based human-to-computer interface.

In an example, a person can wear a plurality of finger rings with EMG sensors on each finger in order to identify hand gestures that are comprised of a plurality of fingers. In an example, a person can wear a plurality of finger rings with more than one EMG sensor on the same finger in order to indentify gestures that involve the bending of multiple joints on the same finger. In an example, a person can wear a plurality of finger rings on different fingers, with multiple rings on each finger, in order to measuring complex multi-finger, multi-joint gestures. In an example, a gesture-recognizing system of multiple finger rings with EMG sensors can comprise two rings on each finger and one ring on the thumb.

FIG. 89 shows an example of how this invention can be embodied in a system of modular smart clothing (or a modular clothing accessory) with external electromagnetic stimulation triggered by food consumption: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 89, clothing can be selected from the group consisting of “Set A.” In this figure, article of clothing 8901 is a shirt. In FIG. 89, the energy-transducing member can be selected from the group consisting of “Set B.” In this figure, energy-transducing member 8902 is a modular external electromagnetic energy emitter which is triggered by food consumption. In FIG. 89, attachment mechanism 8903 can be selected from the group consisting of “Set C.”

In an example, a modular external electromagnetic energy emitter can be incorporated into an article of clothing. In an example, this modular external electromagnetic energy emitter can be configured to be in proximity to a portion of a person's gastrointestinal tract and/or associated nerves which innervate the gastrointestinal tract. In an example, when a person consumes food, then this is automatically detected by a wearable sensor. In an example, food consumption triggers the transmission of electromagnetic energy into the surface of the person's body. In an example, transmission of electromagnetic energy is at a level which is not painful, but does affect food consumption. In an example, a system of smart clothing with an electromagnetic energy emitter which transmits electromagnetic energy into the surface a person's body when the person consumes food can reduce the person's consumption and/or absorption of food.

In an example, a modular external electromagnetic energy emitter can transmit electromagnetic energy into a person's body near the stomach when they eat. In an example, a modular external electromagnetic energy emitter can transmit electromagnetic energy into a person's body near the intestine when they eat. In an example, a modular external electromagnetic energy emitter can transmit electromagnetic energy into a person's body near the tongue when they eat. In an example, application of a specific pattern of electromagnetic energy to a selected location on the surface of a person's body when they eat can change the person's taste or absorption of food. In an example, application of a specific pattern of electromagnetic energy to a selected location on the surface of a person's body when they eat can change the person's huger or satiety level. In an example, a person can removably attach a plurality of external electromagnetic energy emitters (which are triggered by food consumption) to different selected locations on one or more articles of clothing in order to create a customized set of smart clothing which discourages over-eating via a selected pattern of external electromagnetic stimulation.

FIG. 90 shows an example of how this invention can be embodied in a system of modular smart clothing (or a modular clothing accessory) with telerobotics functionality comprising: an article of clothing (or clothing accessory) worn by a person; an energy-transducing member; and an attachment mechanism. This system has a first configuration wherein the energy-transducing member is not attached to the clothing (or accessory) and a second configuration wherein the energy-transducing member is removably attached by the person to the clothing (or accessory) via the attachment mechanism. This system can also have a third configuration wherein the energy-transducing member can be alternatively attached by the person to a different location on the clothing (or accessory). The left side of this figure shows the first configuration, the middle shows the second configuration, and the right side shows the third configuration.

In FIG. 90, clothing can be selected from the group consisting of “Set A.” In this figure, article of clothing 9001 is a shirt. In FIG. 90, the energy-transducing member can be selected from the group consisting of “Set B.” In this figure, energy-transducing member 9002 is a modular motion sensor whose data is used to remotely control the motion of a robot. In FIG. 90, attachment mechanism 9003 can be selected from the group consisting of “Set C.”

In an example, a modular motion sensor can be an accelerometer, gyroscope, or inclinometer. In an example a modular motion sensor can be a pressure sensor which is in fluid or gaseous communication with a fluid or gas filled tube which spans a body joint. In an example, data concerning a person's body motion, configuration, posture, and/or gestures is used to control the motion, configuration, posture, and/or gestures of a robot. In an example, the robot is an android and/or humanoid robot. In an example, a person can removably attach a plurality of motion sensors to one or more articles of clothing in order to create a customized a set of smart clothing which is used to remotely control the operation of robot. In an example, the number and attachment positions of a plurality of motion sensors which are attached to clothing can be selected based on the particular type of robot which is to be controlled by body motion, configuration, posture, and/or gestures. In an example, the motions of a remote robot can imitate the motions of a person wearing this smart clothing in real time. In an example, the motions of a remote robot can imitate the motions of a person wearing this smart clothing at a later time.

We now conclude this description with some summary examples and variations. In an example, this invention can be embodied in a touch-based and/or gesture-based human-to-computer textile interface comprising: (a) an article of clothing or clothing accessory; and (b) an array or mesh of electromagnetic sensors, wherein these electromagnetic sensors are woven or otherwise integrated into the fabric of the article of clothing or clothing accessory, and wherein these electromagnetic sensors transduce human touch and/or gestures into computer inputs. In an example, an electromagnetic sensor can comprise an electroconductive fiber, thread, or yarn. In an example, an electromagnetic sensor can collect data concerning the voltage, conductivity, resistance, capacitance and/or impedance of electromagnetic energy that is transmitted through a portion of an article of clothing. In an example, a touch-based and/or gesture-based human-to-computer textile interface can detect the touch of a human finger on its surface. In an example, a touch-based and/or gesture-based human-to-computer textile interface can detect movement of a human finger in proximity to its surface.

In an example, a modular touch-based and/or gesture-based human-to-computer textile interface can comprise an array or mesh of electromagnetic sensors which are woven or otherwise integrated into the fabric of an article of clothing to transduce human movement into computer inputs. In an example, a modular electromagnetic energy sensor can collect data concerning the voltage, conductivity, resistance, capacitance and/or impedance of electromagnetic energy from an electromagnetic energy emitter that is transmitted through a portion of an article of clothing. In an example, electromagnetic energy can be transmitted through one or more energy pathways in the clothing. In an example, an energy pathway can further comprise electroconductive fibers, threads, or other members which are woven or otherwise integrated into an article of clothing. In an example, a modular touch-based and/or gesture-based human-to-computer textile interface can detect the touch of a human finger on its surface via an array of electromagnetic energy sensors. In an example, a modular touch-based and/or gesture-based human-to-computer textile interface can detect the movement of a human finger on its surface or in proximity to its surface via an array of light energy emitters and sensors.

In an example, the fabric can comprise an array of electroconductive fibers, threads, or yarns which are woven using a plain weave, rib weave, basket weave, twill weave, satin weave, leno weave, or mock leno weave. In an example, an electronically-functional textile, fabric, garment, or wearable accessory can comprise one or more of the following: array of electroconductive members woven using a plain weave, rib weave, basket weave, twill weave, satin weave, leno weave, mock leno weave; array of fiber optic members woven using a plain weave, rib weave, basket weave, twill weave, satin weave, leno weave, mock leno weave; array of light-emitting fibers, threads, or yarns; array of sound-conducting members woven using a plain weave, rib weave, basket weave, twill weave, satin weave, leno weave, mock leno weave, leno and conan weave; array or mesh of electroconductive fibers; bendable fibers, threads, or yarns; bendable layer, trace, or substrate; elastic fibers, threads, or yarns; elastic layer, trace, or substrate; electroconductive fibers, threads, or yarns; electronically-functional bandage; electronically-functional tattoo; integrated array of electroconductive members; integrated array of fiber optic members; integrated array of sound-conducting members; interlaced electricity-conducting fibers, threads, or yarns; interlaced light-conducting fibers, threads, or yarns; interlaced sound-conducting fibers, threads, or yarns; light-emitting fibers, threads, or yarns; nonconductive fibers, threads, or yarns; nonconductive layer, substrate, or material; plaited fibers, threads, or yarns; sinusoidal fibers, threads, or yarns; stretchable fibers, threads, or yarns; stretchable layer, trace, or substrate; textile-based light display matrix; variable-resistance electroconductive fiber, thread, or yarn; variable-translucence fiber, thread, or yarn; water-resistant fibers, threads, or yarns; a layer or coating of metallic nanoparticles; a graphene layer; and water-resistant layer, trace, or substrate.

In an example, this invention can be embodied in a touch-based and/or gesture-based human-to-computer textile interface comprising: (a) an article of clothing or clothing accessory; (b) a first electromagnetic energy pathway which is woven or otherwise integrated into the fabric of the article of clothing or clothing accessory; and (c) a second electromagnetic energy pathway which is woven or otherwise integrated into the fabric of the article of clothing or clothing accessory, wherein changes in the flows of energy through the first and second electromagnetic energy pathways are used to transduce human touch and/or gestures into computer inputs. In an example, an electromagnetic energy pathway can comprise an electroconductive fiber, thread, or yarn. In an example, material used for coating or impregnating an electromagnetic energy pathway can be selected from the group consisting of: aluminum or aluminum alloy; carbon nanotubes, graphene, or other carbon-based material; magnesium; ceramic particles; copper or copper alloy; gold; nickel; polyaniline; silver; and steel. In an example, a change in the flow of electromagnetic energy is measured by one or more parameters selected from the group consisting of: voltage, conductivity, resistance, capacitance, and impedance. In an example, the longitudinal axis of a first electromagnetic energy pathway and the longitudinal axis of a second electromagnetic energy pathway can be substantially perpendicular. In an example, the longitudinal axis of a first electromagnetic energy pathway and the longitudinal axis of a second electromagnetic energy pathway can be substantially parallel. In an example, the longitudinal axis of a first energy electromagnetic pathway and the longitudinal axis of a second electromagnetic energy pathway can be separated by a substantially-constant number of radial degrees of the cross-sectional perimeter of a body member.

In an example, an electromagnetic energy pathway can be comprised of electroconductive fibers, yarns, threads, strands, substrates, layers, or textiles. In an example, changes in the flows of electromagnetic energy through electromagnetic energy pathways can be measured by one or more parameters selected from the group consisting of: voltage, resistance, impedance, amperage, current, phase, and electromagnetic wave pattern. In an example, conductive material or particles used for coating or impregnation can be selected from the group consisting of: aluminum or aluminum alloy; carbon nanotubes, graphene, or other carbon-based material; magnesium; ceramic particles; copper or copper alloy; gold; nickel; polyaniline; silver; and steel. In an example, a first energy pathway can have a longitudinal axis and a second energy pathway can have a longitudinal axis, wherein the relationship between these two longitudinal axes can be selected from the group consisting of: substantially parallel; separated by a substantially constant distance; separated by a substantially constant percentage of the cross-sectional perimeter of the portion of the person's body; separated by a substantially constant number of radial degrees of the cross-sectional perimeter of the portion of the person's body; substantially perpendicular; following vectors whose intersection forms an acute angle; straight or arcuate radial vectors with a common point of origin; concentric and/or nested; rainbow arc configuration; and differing in length.

In an example, the geometric relationship between a first electromagnetic energy pathway and a second electromagnetic energy pathway can be selected from the group consisting of: substantially perpendicular; intersecting at a right angle; intersecting at an acute angle; defining square-shaped spaces (when projected onto a 2D plane) as they intersect; defining rhomboid-shaped spaces (when projected onto a 2D plane) as they intersect; defining trapezoid-shaped spaces (when projected onto a 2D plane) as they intersect; plaited together; woven together; braided together; combining to form a 3D mesh or grid; overlapping; and tangential. In an example, one or more aspects of the geometric relationship between a first energy pathway and a second energy pathway can be selected from the group consisting of: substantially perpendicular; intersecting at a right angle; intersecting at an acute angle; defining square-shaped spaces (when projected onto a 2D plane) as they intersect; defining rhomboid-shaped spaces (when projected onto a 2D plane) as they intersect; defining trapezoid-shaped spaces (when projected onto a 2D plane) as they intersect; plaited together; woven together; braided together; combining to form a 3D mesh or grid; overlapping; and tangential. In an example, fabric can comprise an array of electroconductive fibers, threads, or yarns which are woven using a plain weave, rib weave, basket weave, twill weave, satin weave, leno weave, or mock leno weave.

In an example, a touch-based and/or gesture-based human-to-computer textile interface can comprise: (a) an article of clothing or clothing accessory; (b) a first electromagnetic energy pathway which is woven or otherwise integrated into the fabric of the article of clothing or clothing accessory; and (c) a second electromagnetic energy pathway which is woven or otherwise integrated into the fabric of the article of clothing or clothing accessory, wherein changes in the flows of energy through the first and second electromagnetic energy pathways are used to transduce touch and/or gestures into computer inputs, and wherein the longitudinal axis of the first electromagnetic energy pathway and the longitudinal axis of the second electromagnetic energy pathway are substantially perpendicular.

In an example, a flexible energy pathway can be incorporated into an article of clothing or clothing accessory by weaving or knitting. In an example, a flexible energy pathway can be woven or knit into fabric which is used to make an article of clothing or clothing accessory. In an example, a flexible energy pathway can be woven or knit into the fabric of an article of clothing or clothing accessory in a configuration which is substantially perpendicular to non-energy-conducting fibers, threads, or yarns in the fabric. In an example, a flexible energy pathway can be sinusoidal. In an example, a sinusoidal flexible energy pathway can have a longitudinal axis which is substantially perpendicular to non-energy-conducting fibers, threads, or yarns in the fabric of an article or accessory. In an example, the wave frequency and/or amplitude of a sinusoidal first flexible energy pathway can be different than the wave frequency and/or amplitude of a sinusoidal second flexible energy pathway.

In an example, an article of clothing or clothing accessory can be selected from the group consisting of: shirt, T-shirt, blouse, sweatshirt, sweater, neck tie, collar, cuff, jacket, vest, other upper-body garment, pants, shorts, jeans, slacks, sweatpants, briefs, skirt, other lower-body garment, underwear, underpants, panties, pantyhose, jockstrap, undershirt, bra, brassier, girdle, bathrobe, pajamas, hat, cap, skullcap, headband, hoodie, poncho, other garment with hood, sock, shoe, sneaker, sandal, other footwear, suit, coat, dress, jump suit, one-piece garment, union suit, swimsuit, bikini, other full-body garment, glove, wrist band, wrist watch, smart watch, bracelet, bangle, strap, other wrist-worn band, necklace, neck band, collar, finger tube, head band, hair band, arm bracelet, bangle, amulet, strap, or band, band, electronic tattoo, adhesive patch, belt, waist band, suspenders, chest band, elbow brace, knee brace, and shoulder brace.

In an example, a touch-based and/or gesture-based human-to-computer textile interface comprising: an article of clothing or clothing accessory; a first electromagnetic energy pathway which is woven or otherwise integrated into the fabric of the article of clothing or clothing accessory; a second electromagnetic energy pathway which is woven or otherwise integrated into the fabric of the article of clothing or clothing accessory; a third electromagnetic energy pathway which is woven or otherwise integrated into the fabric of the article of clothing or clothing accessory, wherein changes in the flows of energy through the first, second, and third electromagnetic energy pathways are used to transduce touch and/or gestures into computer inputs, wherein the longitudinal axis of the first electromagnetic energy pathway and the longitudinal axis of the second electromagnetic energy pathway are substantially perpendicular, and wherein the longitudinal axis of the second energy electromagnetic pathway and the longitudinal axis of the third electromagnetic energy pathway are separated by a substantially-constant number of radial degrees of the cross-sectional perimeter of a body member.

I claim:

1. A touch-based and/or gesture-based human-to-computer textile interface comprising:
an article of clothing or clothing accessory; and
an array or mesh of electromagnetic sensors, wherein these electromagnetic sensors are woven or otherwise integrated into the fabric of the article of clothing or clothing accessory, and wherein these electromagnetic sensors transduce human touch and/or gestures into computer inputs.

2. The interface in claim 1 wherein an electromagnetic sensor comprises an electroconductive fiber, thread, or yarn.

3. The interface in claim 1 wherein the fabric comprises an array of electroconductive fibers, threads, or yarns which are woven using a plain weave, rib weave, basket weave, twill weave, satin weave, leno weave, or mock leno weave.

4. The interface in claim 1 wherein an electromagnetic sensor collects data concerning the voltage, conductivity, resistance, capacitance and/or impedance of electromagnetic energy that is transmitted through a portion of the article of clothing.

5. The interface in claim 1 wherein the interface detects the touch of a human finger on its surface.

6. The interface in claim 1 wherein the interface detects movement of a human finger in proximity to its surface.

7. The interface in claim 1 wherein the article of clothing or clothing accessory is selected from the group consisting of: shirt, T-shirt, blouse, sweatshirt, sweater, neck tie, collar, cuff, jacket, vest, other upper-body garment, pants, shorts, jeans, slacks, sweatpants, briefs, skirt, other lower-body garment, underwear, underpants, panties, pantyhose, jockstrap, undershirt, bra, brassier, girdle, bathrobe, pajamas, hat, cap, skullcap, headband, hoodie, poncho, other garment with hood, sock, shoe, sneaker, sandal, other footwear, suit, coat, dress, jump suit, one-piece garment, union suit, swimsuit, bikini, other full-body garment, glove, wrist band, wrist watch, smart watch, bracelet, bangle, strap, other wrist-worn band, necklace, neck band, collar, finger tube, head band, hair band, arm bracelet, bangle, amulet, strap, or band, band, electronic tattoo, adhesive patch, belt, waist band, suspenders, chest band, elbow brace, knee brace, and shoulder brace.

8. A touch-based and/or gesture-based human-to-computer textile interface comprising:
an article of clothing or clothing accessory;
a first electromagnetic energy pathway which is woven or otherwise integrated into the fabric of the article of clothing or clothing accessory; and
a second electromagnetic energy pathway which is woven or otherwise integrated into the fabric of the article of clothing or clothing accessory, wherein changes in the flows of energy through the first and second electromagnetic energy pathways are used to transduce touch and/or gestures into computer inputs, and wherein the longitudinal axis of the first electromagnetic energy pathway and the longitudinal axis of the second electromagnetic energy pathway are substantially perpendicular.

9. The interface in claim 8 wherein an electromagnetic energy pathway comprises an electroconductive fiber, thread, or yarn.

10. The interface in claim 8 wherein material used for coating or impregnating an electromagnetic energy pathway is selected from the group consisting of: aluminum or aluminum alloy; carbon nanotubes, graphene, or other carbon-based material; magnesium; ceramic particles; copper or copper alloy; gold;
nickel; polyaniline; silver; and steel.

11. The interface in claim 8 wherein a change in the flow of electromagnetic energy is measured by one or more parameters selected from the group consisting of: voltage, conductivity, resistance, capacitance, and impedance.

12. The interface in claim 8 wherein the geometric relationship between the first electromagnetic energy pathway and the second electromagnetic energy pathway is selected from the group consisting of: intersecting at a right angle; defining square-shaped spaces (when projected onto a 2D plane) as they intersect; defining rhomboid-shaped spaces (when projected onto a 2D plane) as they intersect; defining trapezoid-shaped spaces (when projected onto a 2D plane) as they intersect; plaited together; woven together; braided together; combining to form a 3D mesh or grid; overlapping; and tangential.

13. The interface in claim 8 wherein the fabric comprises an array of electroconductive fibers, threads, or yarns which are woven using a plain weave, rib weave, basket weave, twill weave, satin weave, leno weave, or mock leno weave.

14. The interface in claim 8 wherein the interface detects the touch of a human finger on its surface.

15. The interface in claim 8 wherein the interface detects the movement of a human finger in proximity to its surface.

16. The interface in claim 8 wherein the article of clothing or clothing accessory is selected from the group consisting of: shirt, T-shirt, blouse, sweatshirt, sweater, neck tie, collar, cuff, jacket, vest, other upper-body garment, pants, shorts, jeans, slacks, sweatpants, briefs, skirt, other lower-body garment, underwear, underpants, panties, pantyhose, jockstrap, undershirt, bra, brassier, girdle, bathrobe, pajamas, hat, cap, skullcap, headband, hoodie, poncho, other garment with hood, sock, shoe, sneaker, sandal, other footwear, suit, coat, dress, jump suit, one-piece garment, union suit, swimsuit, bikini, other full-body garment, glove, wrist band, wrist watch, smart watch, bracelet, bangle, strap, other wrist-worn band, necklace, neck band, collar, finger tube, head band, hair band, arm bracelet, bangle, amulet, strap, or band, band, electronic tattoo, adhesive patch, belt, waist band, suspenders, chest band, elbow brace, knee brace, and shoulder brace.

17. A touch-based and/or gesture-based human-to-computer textile interface comprising:
an article of clothing or clothing accessory;
a first electromagnetic energy pathway which is woven or otherwise integrated into the fabric of the article of clothing or clothing accessory;
a second electromagnetic energy pathway which is woven or otherwise integrated into the fabric of the article of clothing or clothing accessory;
a third electromagnetic energy pathway which is woven or otherwise integrated into the fabric of the article of clothing or clothing accessory, wherein changes in the flows of energy through the first, second, and third electromagnetic energy pathways are used to transduce touch and/or gestures into computer inputs, wherein the longitudinal axis of the first electromagnetic energy pathway and the longitudinal axis of the second electromagnetic energy pathway are substantially perpendicular, and wherein the longitudinal axis of the second energy electromagnetic pathway and the longitudinal axis of the third electromagnetic energy pathway are separated by a substantially-constant number of radial degrees of the cross-sectional perimeter of a body member.

18. The interface in claim 17 wherein an electromagnetic energy pathway comprises an electroconductive fiber, thread, or yarn.

19. The interface in claim 17 wherein material used for coating or impregnating an electromagnetic energy pathway is selected from the group consisting of: aluminum or aluminum alloy; carbon nanotubes, graphene, or other carbon-based material; magnesium; ceramic particles; copper or copper alloy; gold;
nickel; polyaniline; silver; and steel.

20. The interface in claim 17 wherein a change in the flow of electromagnetic energy is measured by one or more parameters selected from the group consisting of: voltage, conductivity, resistance, capacitance, and impedance.
